(19) United States
(12) Patent Application Publication
(10) Pub. No.: US 2015/0189574 A1
(43) Pub. Date: Jul. 2, 2015

(54) METHODS FOR DORMANT CELL SIGNALING FOR ADVANCED CELLULAR NETWORK

(71) Applicant: Samsung Electronics Co., Ltd., Suwon-si (KR)

(72) Inventors: Boon Loong Ng, Plano, TX (US); Ying Li, Richardson, TX (US); Thomas David Novlan, Dallas, TX (US); Aris Papasakellariou, Houston, TX (US); Gerardus Johannes Petrus van Lieshout, Apeldoorn (NL)

(21) Appl. No.: 14/579,844

(22) Filed: Dec. 22, 2014

Related U.S. Application Data
(60) Provisional application No. 61/921,016, filed on Dec. 26, 2013.
(60) Provisional application No. 61/928,904, filed on Jan. 17, 2014.
(60) Provisional application No. 61/932,166, filed on Jan. 27, 2014.
(60) Provisional application No. 61/984,610, filed on Apr. 25, 2014.
(60) Provisional application No. 62/025,827, filed on Jul. 17, 2014.

(51) Int. Cl. H04W 48/12; H04W 52/24; H04W 24/08

(52) U.S. Cl. CPC H04W 48/12; H04W 24/08; H04W 52/245

(57) ABSTRACT

User equipment for wireless communication with at least one base station includes a transceiver operable to communicate with the at least one base station by transmitting radio frequency signals to the at least one base station and by receiving radio frequency signals from the at least one base station. The transceiver is configured to receive a discovery signal from a base station of the at least one base station, the discovery signal comprising a discovery signal identifier. The transceiver is also configured to receive a synchronization signal or reference signal, the synchronization signal or the reference signal comprising a physical cell identifier. The user equipment also includes processing circuitry configured to determine whether the discovery cell identifier matches the physical cell identifier. The processing circuitry is also configured to, responsive to the discovery cell identifier matching the physical cell identifier, identifying that the base station is active or in coverage

### CROSS-REFERENCE TO RELATED APPLICATION(S) AND CLAIM OF PRIORITY

The present application claims priority to U.S. Provisional Patent Application Ser. No. 61/921,016, filed Dec. 26, 2013, entitled “METHODS FOR DORMANT CELL SIGNALING FOR ADVANCED CELLULAR NETWORK”, U.S. Provisional Patent Application Ser. No. 61/928,904, filed Jan. 17, 2014, entitled “METHODS FOR DORMANT CELL SIGNALING FOR ADVANCED CELLULAR NETWORK”, U.S. Provisional Patent Application Ser. No. 62/025,827, filed Jul. 17, 2014, entitled “METHODS FOR DORMANT CELL SIGNALING FOR ADVANCED CELLULAR NETWORK”, U.S. Provisional Patent Application Ser. No. 61/932,166, filed Jan. 27, 2014, entitled “DOWNLINK SIGNALING FOR CELL ON/OFF ADAPTATION IN WIRELESS COMMUNICATION SYSTEMS”, and U.S. Provisional Patent Application Ser. No. 61/984,610, filed Apr. 25, 2014, entitled “METHODS FOR DISCOVERY REFERENCE SIGNAL MEASUREMENT TIMING CONFIGURATION”. The content of the above-identified patent documents are incorporated herein by reference.

### TECHNICAL FIELD

The present application relates generally to wireless communication systems and, more specifically, to the adaptation of on/off downlink transmission of a cell in wireless communication systems and discovery reference signal timing configuration.

### BACKGROUND

This disclosure relates generally to wireless communication systems and, more specifically, to the adaptation of on/off downlink transmission of a cell in wireless communication systems and cell discovery reference signal configuration methods. A communication system includes a DownLink (DL) that conveys signals from transmission points, such as Base Stations (BSs), NodeBs, or enhanced NodeBs (eNBs), to User Equipments (UEs). The communication system also includes an UpLink (UL) that conveys signals from UEs to reception points such as eNBs. A UE, also commonly referred to as a terminal or a mobile station, may be fixed or mobile and may be a cellular phone, a personal computer device, and the like. An eNB, which is generally a fixed station, may also be referred to as an access point or other equivalent terminology.

DL signals include data signals conveying information content, control signals conveying DL Control Information (DCI), and Reference Signals (RS), which are also known as pilot signals. An eNB transmits data information or DCI through respective Physical DL Shared CHannels (PDSCHs) or Physical DL Control CHannels (PDCCHs). Possible DCI formats used for downlink assignment include DCI format 1A, 1B, 1C, 1D, 2, 2A, 2B, 2C and 2D. A UE can be configured with a transmission mode which determines the downlink unicast reception method for the UE. For a given transmission mode, a UE can receive unicast downlink assignment using DCI format 1A and one of DCI format 1B, 1D, 2, 2A, 2B, 2C or 2D. An eNB transmits one or more of multiple types of RS including a UE-Common RS (CRS), a Channel State Information RS (CSI-RS), and a DeModulation RS (DMRS). A CRS is transmitted over a DL system BandWidth (BW) and can be used by UEs to demodulate data or control signals or to perform measurements. To reduce CRS overhead, an eNB may transmit a CSI-RS with a smaller density in the time and/or frequency domain than a CRS. For Interference Measurement Resources (IMRs), a Zero Power CSI-RS (ZP CSI-RS) can be used. A UE can determine CSI-RS transmission parameters through higher-layer signaling from an eNB. DMRS can be transmitted only in the BW of a respective PDSCH or PDCCH, and a UE can use the DMRS to demodulate information in a PDSCH or PDCCH.

UL signals include data signals conveying information content, control signals conveying UL Control Information (UCI), and RS. A UE transmits data information or UCI through a respective Physical UL Shared CHannel (PUSCH) or a Physical UL Control CHannel (PUCCH). If a UE simultaneously transmits data information and UCI, it may multiplex both in a PUSCH. UCI includes Hybrid Automatic Repeat reQuest ACKnowledgement (HARQ-ACK) information indicating correct or incorrect detection of data Transport Blocks (TBs) in a PDSCH, Scheduling Request (SR) information indicating whether a UE has data in its buffer, and Channel State Information (CSI) enabling an eNB to select appropriate parameters for PDSCH transmissions to a UE. HARQ-ACK information includes a positive ACKnowledgement (ACK) in response to a correct PDCCH or data TB detection, a Negative ACKnowledgement (NACK) in response to an incorrect data TB detection, and an absence of a PDCCH detection (DTX) that can be implicit (a UE does not transmit a HARQ-ACK signal) or explicit if a UE can identify missed PDCCHs in other ways (it is also possible to represent NACK and DTX with the same NACK/DTX state). UL RS includes DMRS and Sounding RS (SRS). DMRS can be transmitted only in a BW of a respective PUSCH or PUCCH, and an eNB can use a DMRS to demodulate information in a PUSCH or PUCCH. SRS can be transmitted by a UE in order to provide an eNB with a UL CSI. SRS transmissions from a UE can be periodic (P-SRS) at predetermined Transmission Time Intervals (TTIs) with transmission parameters configured to the UE by higher-layer signaling, such as Radio Resource Control (RRC) signaling. SRS transmissions from a UE can also be aperiodic (A-SRS) as triggered by a DCI format conveyed by a PDCCH scheduling PUSCH or PDSCH.

DCI can serve several purposes. A DCI format in a respective PDCCH may schedule a PDSCH or a PUSCH transmission conveying data information to or from a UE, respectively. A UE could always monitor a DCI format 1A for PDSCH scheduling and a DCI format 0 for PUSCH scheduling. These two DCI formats are designed to have the same size and can be jointly referred to as DCI format 0/1A. Another DCI format, DCI format 1C, in a respective PDCCH may schedule a PDSCH providing System Information (SI) to a group of UEs for network configuration parameters, a response to a Random Access (RA) by UEs, paging information to a group of UEs, and so on. Another DCI format, DCI format 3 or DCI format 3A (jointly referred to as DCI format 3/3A) may provide to a group of UEs Transmission Power Control (TPC) commands for transmissions of respective PUSCHs or PUCCHs.

A DCI format includes Cyclic Redundancy Check (CRC) bits in order for a UE to confirm a correct detection. A DCI format type can be identified by a Radio Network Temporary Identifier (RNTI) that scrambles the CRC bits. For a DCI format scheduling a PDSCH or a PUSCH to a single UE, the RNTI is a Cell RNTI (C-RNTI). For a DCI format scheduling a PDSCH conveying SI to a group of UEs, the RNTI is an SI-RNTI. For a DCI format scheduling a PDSCH providing a response to an RA from a group of UEs, the RNTI is an RA-RNTI. For a DCI format scheduling a PDSCH paging a group of UEs, the RNTI is a P-RNTI. For a DCI format providing TPC commands to a group of UEs, the RNTI is a TPC-RNTI. Each RNTI type can be configured to a UE through higher-layer signaling (and the C-RNTI can be unique for each UE).

### SUMMARY

User equipment for wireless communication with at least one base station includes a transceiver operable to communicate with the at least one base station by transmitting radio frequency signals to the at least one base station and by receiving radio frequency signals from the at least one base station. The transceiver is configured to receive a discovery signal from a base station of the at least one base station. The discovery signal includes a discovery signal identifier. The transceiver is also configured to receive a synchronization signal or reference signal. The synchronization signal or the reference signal includes a physical cell identifier. The user equipment also includes processing circuitry configured to determine whether the discovery cell identifier matches the physical cell identifier. The processing circuitry is also configured to, responsive to the discovery cell identifier matching the physical cell identifier, identifying that the base station is active or in coverage

A user equipment for wireless communication over a wireless network with at least one base station includes a transceiver operable to communicate with the at least one base station by transmitting radio frequency signals to the at least one base station and by receiving radio frequency signals from the at least one base station. The transceiver is configured to receive an indication of whether a base station is active or dormant via a physical downlink control channel (PDCCH) of a radio network temporary identifier (RNTI). The user equipment also includes processing circuitry configured to monitor the PDCCH for the RNTI.

A user equipment for wireless communication over a wireless network with at least one base station includes a transceiver operable to communicate with the at least one base station by transmitting radio frequency signals to the at least one base station and by receiving radio frequency signals from the at least one base station. The transceiver is configured to receive a discovery signal from a base station of the at least one base station. The discovery signal includes a discovery signal identifier. The user equipment also includes processing circuitry configured to determine an offset of the discovery signal identifier. The processing circuitry also determines whether the base station is active or dormant based on the offset.

A base station for wireless communication over a wireless network. The base station comprises a transceiver operable to communicate with the at least one user equipment by transmitting radio frequency signals to the at least one user equipment and by receiving radio frequency signals from the at least one user equipment. The transceiver is configured to transmit a discovery signal to the at least one user equipment, the discovery signal comprising a discovery signal identifier. The transceiver is also configured to transmit a synchronization signal or reference signal, the synchronization signal or the reference signal comprising a physical cell identifier. Whether the discovery cell identifier matches the physical cell identifier identifies whether the base station is active or in coverage.

A base station for communicating over a wireless network. The base station comprises a transceiver operable to communicate with the at least one user equipment by transmitting radio frequency signals to the at least one user equipment and by receiving radio frequency signals from the at least one user equipment. The transceiver is configured to transmit a physical downlink control channel (PDCCH) for a radio network temporary identifier (RNTI) indicating whether the base station is active or dormant.

A base station for communicating over a wireless network. The base station comprises a transceiver operable to communicate with the at least one user equipment by transmitting radio frequency signals to the at least one user equipment and by receiving radio frequency signals from the at least one user equipment. The transceiver is configured to transmit a discovery signal comprising a discovery signal identifier. An offset of the discovery signal identifier indicates whether the base station is active or dormant

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A illustrates an example wireless network 100 according to this disclosure;

FIG. 1B illustrates an example UE 116 according to this disclosure;

FIGS. 2A and 2B illustrate example wireless transmit and receive paths according to this disclosure;

FIG. 3A is a diagram illustrating a structure of a DL Transmission Time Interval (TTI) in accordance with an embodiment of this disclosure;

FIG. 3B illustrates the resource element mapping for possible CSI-RS resources in accordance with an embodiment of this disclosure;

FIG. 3C is a diagram illustrating a conventional encoding process for a DCI format in accordance with an embodiment of this disclosure;

FIG. 3D is a diagram illustrating a conventional decoding process for a DCI format in accordance with an embodiment of this disclosure;

FIG. 3E is a diagram illustrating a conventional processing for PHICH transmission in accordance with an embodiment of this disclosure;

FIGS. 4A-4D illustrate example small cell scenarios in accordance with an embodiment of this disclosure;

FIG. 5 illustrates coverage of discovery signal and PSS/SSS/CRS in a dense small cells deployment scenario in accordance with an embodiment of this disclosure;

FIGS. 6A-6B illustrate UE procedures to determine the state of a cell detected with a discovery signal in accordance with an embodiment of this disclosure;

FIGS. 7A-7B illustrate UE RRM procedures depending on the state of the cell configured as a SCell in accordance with an embodiment of this disclosure;

FIG. 8 illustrates a UE RRM procedure—report “OOR” for CRS RSRP/RSRQ when PSS/SSS/CRS or CRS of cell not detected in accordance with an embodiment of this disclosure;

FIGS. 9A-9B illustrate UE QCL procedures in accordance with an embodiment of this disclosure;

FIG. 10 illustrates an example of an overall UE procedure upon detection of a discovery signal in accordance with an embodiment of this disclosure;

FIGS. 11A-11C illustrate ON/OFF MAC control elements in accordance with an embodiment of this disclosure;

FIG. 12 illustrates SCell activation/deactivation on ON/OFF MAC control elements in accordance with an embodiment of this disclosure;

FIG. 13 illustrates a process showing the procedure associated with the UE group-common signaling in accordance with an embodiment of this disclosure;

FIG. 14 illustrates an example UE procedure upon detecting discovery signal and cell ON/OFF signaling in accordance with an embodiment of this disclosure;

FIGS. 15A-E illustrate an example ON/OFF procedures in accordance with an embodiment of this disclosure;

FIG. 16 illustrates a configuration for transmitting ONOFF-Adapt and an effective timing for an adapted ON/OFF configuration in accordance with an embodiment of this disclosure;

FIG. 17 illustrates a configuration for transmitting ONOFF-Adapt and an effective timing for an adapted ON/OFF configuration in accordance with an embodiment of this disclosure;

FIG. 18 illustrates a configuration for transmitting ONOFF-Adapt and an effective timing for an adapted ON/OFF configuration in accordance with an embodiment of this disclosure;

FIG. 19 illustrates an example for signaling of an adapted ON/OFF configuration in accordance with an embodiment of this disclosure;

FIG. 20 illustrates an example for signaling of an adapted ON/OFF configuration in accordance with an embodiment of this disclosure;

FIG. 21 illustrates an example for signaling of an adapted ON/OFF configuration in accordance with an embodiment of this disclosure;

FIG. 22 illustrates example UE operations to acquire ONOFF-Adapt in accordance with an embodiment of this disclosure;

FIG. 23 illustrates example UE operations according to the knowledge ON/OFF state in accordance with an embodiment of this disclosure;

FIG. 24 illustrates operations at the UE for detecting a DCI format providing an adaptation of an ON/OFF configuration in accordance with an embodiment of this disclosure;

FIG. 25 illustrates example locations in a DCI format indicating an ON/OFF reconfiguration where each location corresponds to an ONOFF-Cell in accordance with an embodiment of this disclosure;

FIG. 26 illustrates example operations for a UE to determine locations for indicators of ON/OFF reconfigurations for its ONOFF-Cells that are provided by two DCI formats in accordance with an embodiment of this disclosure;

FIG. 27 illustrates an example for a set of subframes that are configured as OFF and having an exception for transmission of L1 signaling for adaptation of a TDD UL-DL configuration in accordance with an embodiment of this disclosure;

FIG. 28 illustrates an example that a set of subframes can be configured as OFF and certain transmission of L1 signaling for TDD UL-DL adaptation in a subframe configured as OFF can be omitted in accordance with an embodiment of this disclosure;

FIG. 29 illustrates an example that a set of subframes can be configured as OFF and certain transmission of L1 signaling for TDD UL-DL adaptation in a subframe configured as OFF can be omitted, and rescheduled to other SF which is configured as ON in accordance with an embodiment of this disclosure;

FIG. 30 illustrates an example of L1 signaling informing of an ON/OFF configuration and of L1 signaling informing of a TDD UL-DL reconfiguration being transmitted in the same subframe or being provided by the same DCI format in accordance with an embodiment of this disclosure;

FIG. 31 illustrates an example for L1 signaling to inform a UE either of an ON/OFF reconfiguration or of a TDD UL-DL reconfiguration in accordance with an embodiment of this disclosure;

FIG. 32 illustrates an example UE operation for L1 signaling to inform a UE of ON/OFF reconfiguration by including a field in a DCI format that indicates a new TDD UL-DL configuration;

FIG. 33 illustrates example operations for a UE to determine subframes to monitor for paging in accordance with an embodiment of this disclosure;

FIG. 34 illustrates example operation for a UE to receive PHICH conveying adaptation of ON/OFF configuration in accordance with an embodiment of this disclosure;

FIG. 35 illustrates an example of synchronized macro cell and small cell deployment, where synchronization at frame level shown in accordance with an embodiment of this disclosure;

FIG. 36 illustrates an example of unsynchronized macro cell and small cell in accordance with an embodiment of this disclosure;

FIG. 37 illustrates an example of SFN timing offset between a MeNB and a SeNB in accordance with an embodiment of this disclosure;

FIG. 38 illustrates an example of DRS configuration gap, defined by a DRS gap length (DGL) 3810 (e.g. 6 ms) and a DRS Gap Repeition Period (DGRP) 3820 (e.g. 40 ms) in accordance with an embodiment of this disclosure;

FIG. 39 illustrates determination of the effective DRS configuration gap 3930 for a small cell (which is the first eNodeB) based on the DRS gap configuration 3910 as signaled by a macro cell (which is the second eNodeB) in accordance with an embodiment of this disclosure;

FIG. 40 illustrates an example how the DRS subframe of a small cell (the first eNodeB in this embodiment) is determined based on the DRS subframe configuration of a macro cell (the second eNodeB in this embodiment) and the SFN timing offset in accordance with an embodiment of this disclosure;

FIG. 41 illustrates another example of how the absolute start and end time of time-frequency resources of the first eNodeB (small cell) is determined based on the DRS subframe configuration of the second eNodeB (macro cell) and the SFN timing offset in accordance with an embodiment of this disclosure;

FIG. 42 illustrates a DRS measurement timing determination in accordance with an embodiment of this disclosure; and

FIG. 43 illustrates another method for DRS measurement timing determination in accordance with an embodiment of this disclosure.

### DETAILED DESCRIPTION

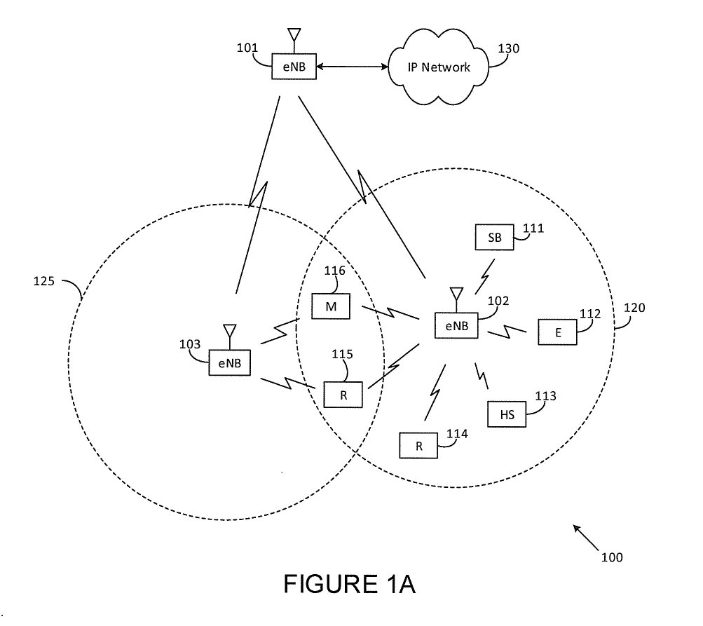

FIGS. 1 through 43, discussed below, and the various embodiments used to describe the principles of the present disclosure in this patent document are by way of illustration only and should not be construed in any way to limit the scope of the disclosure. Those skilled in the art will understand that the principles of this disclosure may be implemented in any suitably arranged device or system.

The following documents are hereby incorporated herein by reference: [REF1]: 3GPP TS 36.211 v11.2.0; [REF2]: 3GPP TS 36.212 v11.2.0; [REF3] 3GPP TS 36.213 v11.2.0; [REF4] 3GPP TS 36.214 v11.1.0; [REF5] 3GPP TS 36.300 V11.5.0; [REF6] 3GPP TS 36.133 V11.4.0; [REF7] 3GPP TS 36.321 V11.2.0; [REF8] 3GPP TS 36.331 V11.3.0; [REF9] WD-201310-006-1-US0 Methods and apparatus for discovery signals for LTE Advanced; [REF10] 3GPP TR 36.872 V12.0.0; [REF11] RP-132073 New WI proposal: Small cell enhancements—Physical layer aspects; [REF12] RP-132069 New WI proposal: Dual Connectivity for LTE; and [REF13] 61/539,419 (Provisional Appl. No.) CoMP Measurement system and method.

List of Acronyms:
ACK: Acknowledgement
ARQ: Automatic Repeat Request
BCH: Broadcast Channel
CA: Carrier Aggregation
C-RNTI: Cell RNTI
CRS: Common Reference Signal
CSI: Channel State Information
CSI-RS: Channel State Information Reference Signal
D2D: Device-to-Device
DCI: Downlink Control Information
DL: Downlink
DL-SCH: Downlink Shared Channel
DMRS: Demodulation Reference Signal
DS: Discovery Signal
EAB: Extended Access Barring
EPDCCH: Enhanced PDCCH
ETWS: Earthquake and Tsunami Warning System
FDD: Frequency Division Duplexing
HARQ: Hybrid ARQ
IE: Information Element
MCS: Modulation and Coding Scheme
MBSFN: Multimedia Broadcast multicast service Single Frequency Network
O&M: Operation and Maintenance
PCell: Primary Cell
PCH: Paging Channel
PCI: Physical Cell Identifier
PDCCH: Physical Downlink Control Channel
PDSCH: Physical Downlink Shared Channel
PMCH: Physical Multicast Channel
PRB: Physical Resource Block
PSS: Primary Synchronization Signal
PUCCH: Physical Uplink Control Channel
PUSCH: Physical Uplink Shared Channel
QoS: Quality of Service
RACH: Random Access Channel
RAR: Random Access Response
RNTI: Radio Network Temporary Identifier
RRC: Radio Resource Control
RS: Reference Signals
RSRP: Reference Signal Received Power
SCell: Secondary Cell
SCH_RP: Received (linear) average power of the resource elements that carry E-UTRA synchronization signal, measured at the UE antenna connector
SIB: System Information Block
SINR: Signal to Interference and Noise Ratio
SSS: Secondary Synchronization Signal
SR: Scheduling Request
SRS: Sounding RS
TA: Timing Advance
TAG: Timing Advance Group
TB: Transport Block
TDD: Time Division Duplexing
TPC: Transmit Power Control
TTI: Transmission Time Interval
UCI: Uplink Control Information
UE: User Equipment
UL: Uplink
UL-SCH: UL Shared Channel
Ês: Received energy per RE (power normalized to the subcarrier spacing) during the useful part of the symbol, i.e. excluding the cyclic prefix, at the UE antenna connector
lot: The received power spectral density of the total noise and interference for a certain RE (power integrated over the RE and normalized to the subcarrier spacing) as measured at the UE antenna connector

FIG. 1A illustrates an example wireless network 100 according to this disclosure. The embodiment of the wireless network 100 shown in FIG. 1A is for illustration only. Other embodiments of the wireless network 100 could be used without departing from the scope of this disclosure.

As shown in FIG. 1A, the wireless network 100 includes an eNodeB (eNB) 101, an eNB 102, and an eNB 103. The eNB 101 communicates with the eNB 102 and the eNB 103. The eNB 101 also communicates with at least one Internet Protocol (IP) network 130, such as the Internet, a proprietary IP network, or other data network.

The eNB 102 provides wireless broadband access to the network 130 for a first plurality of user equipments (UEs) within a coverage area 120 of the eNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The eNB 103 provides wireless broadband access to the network 130 for a second plurality of UEs within a coverage area 125 of the eNB 103. The second plurality of UEs includes the UE 115 and the UE 116. In some embodiments, one or more of the eNBs 101-103 may communicate with each other and with the UEs 111-116 using 5G, LTE, LTE-A, WiMAX, WiFi, or other wireless communication techniques.

Depending on the network type, other well-known terms may be used instead of “eNodeB” or “eNB,” such as “base station” or “access point.” For the sake of convenience, the terms “eNodeB” and “eNB” are used in this patent document to refer to network infrastructure components that provide wireless access to remote terminals. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to remote wireless equipment that wirelessly accesses an eNB, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with eNBs, such as the coverage areas 120 and 125, may have other shapes, including irregular shapes, depending upon the configuration of the eNBs and variations in the radio environment associated with natural and man-made obstructions.

Although FIG. 1A illustrates one example of a wireless network 100, various changes may be made to FIG. 1A. For example, the wireless network 100 could include any number of eNBs and any number of UEs in any suitable arrangement. Also, the eNB 101 could communicate directly with any number of UEs and provide those UEs with wireless broadband access to the network 130. Similarly, each eNB 102-103 could communicate directly with the network 130 and provide UEs with direct wireless broadband access to the network 130. Further, the eNB 101, 102, and/or 103 could provide access to other or additional external networks, such as external telephone networks or other types of data networks.

FIG. 1B illustrates an example UE 116 according to this disclosure. The embodiment of the UE 116 illustrated in FIG. 1B is for illustration only, and the UEs 111-115 of FIG. 1A could have the same or similar configuration. However, UEs come in a wide variety of configurations, and FIG. 1B does not limit the scope of this disclosure to any particular implementation of a UE.

As shown in FIG. 1B, the UE 116 includes an antenna 105, a radio frequency (RF) transceiver 110, transmit (TX) processing circuitry 117, a microphone 121, and receive (RX) processing circuitry 126. The UE 116 also includes a speaker 131, a main processor 140, an input/output (I/O) interface (IF) 145, a keypad 150, a display 155, and a memory 160. The memory 160 includes a basic operating system (OS) program 161 and one or more applications 162.

The RF transceiver 110 receives, from the antenna 105, an incoming RF signal transmitted by an eNB of the network 100. The RF transceiver 110 down-converts the incoming RF signal to generate an intermediate frequency (IF) or baseband signal. The IF or baseband signal is sent to the RX processing circuitry 126, which generates a processed baseband signal by filtering, decoding, and/or digitizing the baseband or IF signal. The RX processing circuitry 126 transmits the processed baseband signal to the speaker 131 (such as for voice data) or to the main processor 140 for further processing (such as for web browsing data).

The TX processing circuitry 117 receives analog or digital voice data from the microphone 121 or other outgoing baseband data (such as web data, e-mail, or interactive video game data) from the main processor 140. The TX processing circuitry 117 encodes, multiplexes, and/or digitizes the outgoing baseband data to generate a processed baseband or IF signal. The RF transceiver 110 receives the outgoing processed baseband or IF signal from the TX processing circuitry 117 and up-converts the baseband or IF signal to an RF signal that is transmitted via the antenna 105.

The main processor 140 can include one or more processors or other processing devices and execute the basic OS program 161 stored in the memory 160 in order to control the overall operation of the UE 116. For example, the main processor 140 could control the reception of forward channel signals and the transmission of reverse channel signals by the RF transceiver 110, the RX processing circuitry 126, and the TX processing circuitry 117 in accordance with well-known principles. In some embodiments, the main processor 140 includes at least one microprocessor or microcontroller.

The main processor 140 is also capable of executing other processes and programs resident in the memory 160. The main processor 140 can move data into or out of the memory 160 as used by an executing process. In some embodiments, the main processor 140 is configured to execute the applications 162 based on the OS program 161 or in response to signals received from eNBs or an operator. The main processor 140 is also coupled to the I/O interface 145, which provides the UE 116 with the ability to connect to other devices such as laptop computers and handheld computers. The I/O interface 145 is the communication path between these accessories and the main processor 140.

The main processor 140 is also coupled to the keypad 150 and the display unit 155. The operator of the UE 116 can use the keypad 150 to enter data into the UE 116. The display 155 may be a liquid crystal display or other display capable of rendering text and/or at least limited graphics, such as from web sites.

The memory 160 is coupled to the main processor 140. Part of the memory 160 could include a random access memory (RAM), and another part of the memory 160 could include a Flash memory or other read-only memory (ROM).

Although FIG. 1B illustrates one example of UE 116, various changes may be made to FIG. 1B. For example, various components in FIG. 1B could be combined, further subdivided, or omitted and additional components could be added according to particular needs. As a particular example, the main processor 140 could be divided into multiple processors, such as one or more central processing units (CPUs) and one or more graphics processing units (GPUs). Also, while FIG. 1B illustrates the UE 116 configured as a mobile telephone or smartphone, UEs could be configured to operate as other types of mobile or stationary devices.

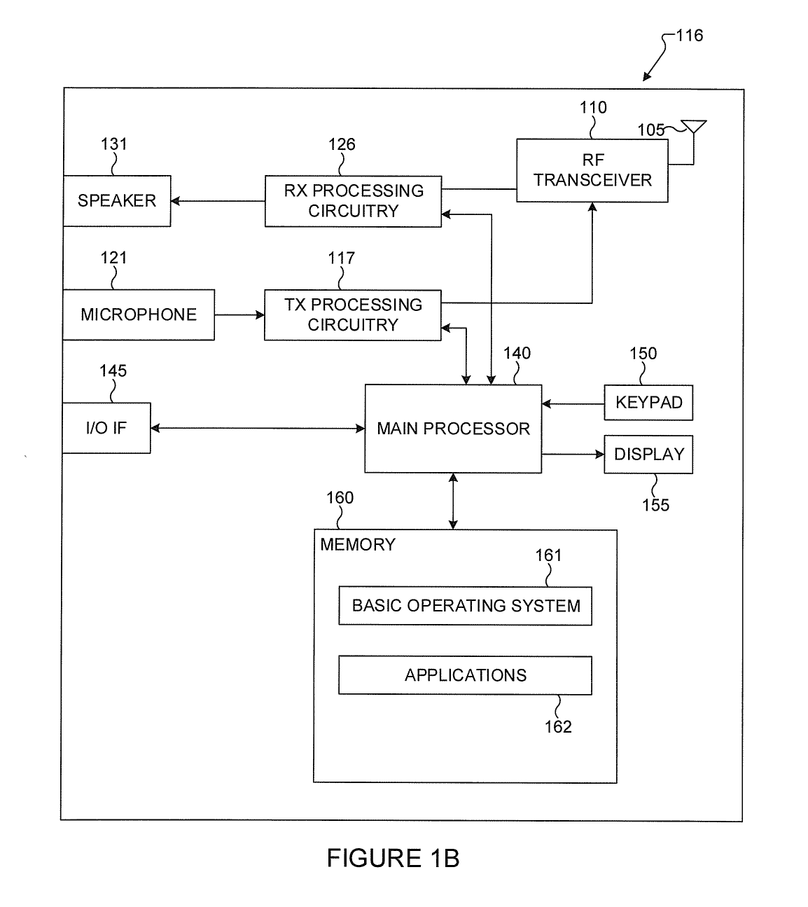

FIGS. 2A and 2B illustrate example wireless transmit and receive paths according to this disclosure. In the following description, a transmit path 200 may be described as being implemented in an eNB (such as eNB 102), while a receive path 250 may be described as being implemented in a UE (such as UE 116). However, it will be understood that the receive path 250 could be implemented in an eNB and that the transmit path 200 could be implemented in a UE.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding or a Turbo coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the eNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the eNB 102 arrives at the UE 116 after passing through the wireless channel, and reverse operations to those at the eNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the eNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to eNBs 101-103 and may implement a receive path 250 for receiving in the downlink from eNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, could be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B could be combined, further subdivided, or omitted and additional components could be added according to particular needs. Also, FIGS. 2A and 2B are meant to illustrate examples of the types of transmit and receive paths that could be used in a wireless network. Any other suitable architectures could be used to support wireless communications in a wireless network.

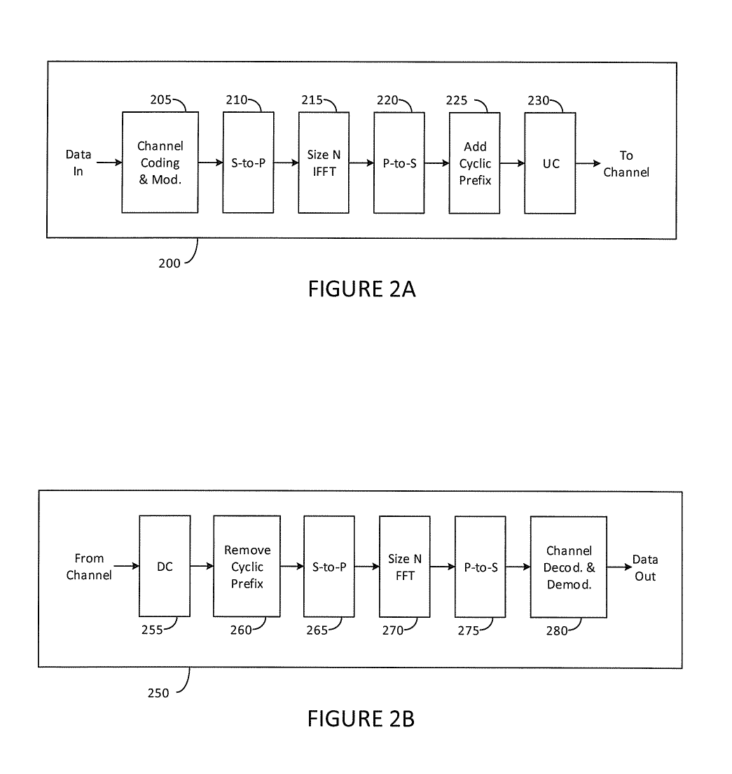

FIG. 3A is a diagram illustrating a structure of a DL Transmission Time Interval (TTI) in accordance with an embodiment of this disclosure.

Referring to FIG. 3A, DL signaling uses Orthogonal Frequency Division Multiplexing (OFDM) and a DL TTI includes N=14 OFDM symbols in the time domain and K Resource Blocks (RBs) in the frequency domain. A first type of Control CHannels (CCHs) is transmitted in a first N₁ OFDM symbols 301 (including no transmission, N₁=0). A remaining N−N₁ OFDM symbols are used primarily for transmitting PDSCHs 302 and, in some RBs of a TTI, for transmitting a second type of CCHs (ECCHs) 303.

An eNodeB also transmits Primary Synchronization Signals (PSS) and Secondary Synchronization Signals (SSS), so that a UE can synchronize with the eNodeB and perform cell identification. There are 504 unique physical-layer cell identities. The physical-layer cell identities are grouped into 168 unique physical-layer cell-identity groups, each group containing three unique identities. The grouping is such that each physical-layer cell identity is part of one and only one physical-layer cell-identity group. A physical-layer cell identity N_{ID}^{cell}=3N_{ID}⁽¹⁾+N_{ID}⁽²⁾ thus uniquely defined by a number N_{ID}⁽¹⁾ in the range of 0 to 167, representing the physical-layer cell-identity group, and a number N_{ID}⁽²⁾ in the range of 0 to 2, representing the physical-layer identity within the physical-layer cell-identity group. Detecting a PSS enables a UE to determine the physical-layer identity as well as the slot timing of the cell transmitting the PSS. Detecting a SSS enables a UE to determine the radio frame timing, the physical-layer cell identity, the cyclic prefix length as well as the cell uses FDD or TDD scheme.

FIG. 3B illustrates the resource element mapping for possible CSI-RS resources in accordance with an embodiment of this disclosure. The mapping including NZP CSI-RS and ZP CSI-RS that can be configured to a UE. A ZP CSI-RS resource is configured as a 4-port CSI-RS resource.

Referring to FIG. 3B, one or more NZP or ZP CSI-RS resources can be configured to a UE (e.g. 311, 312, 313) through higher layer signaling, e.g. RRC signaling. A parameter called the subframeConfig for CSI-RS can be configured to a UE which indicates the subframe configuration period T_{CSI-RS} and the subframe offset Δ_{CSI-RS} for the occurence of CSI reference signals are listed in Table 0. The parameter I_{CSI-RS} can be configured separately for CSI reference signals for which the UE shall assume non-zero and zero transmission power. Subframes containing CSI reference signals shall satisfy (10n_{f}+└n_{S}/2┘−Δ_{CSI-RS})mod T_{CSI-RS}=0, where n_{f} is used to denote the System Frame Number (range from 0 to 1023) nₛ is used to denote the slot number within a radio frame (range from 0 to 19).

TABLE 0
CSI reference signal subframe configuration

| | CSI-RS periodicity | CSI-RS subframe offset |
|---|---|---|
| CSI-RS-SubframeConfig | T_{CSI-RS} | Δ_{CSI-RS} |
| I_{CSI-RS} | (subframes) | (subframes) |
| 0-4 | 5 | I_{CSI-RS} |
| 5-14 | 10 | I_{CSI-RS} -5 |
| 15-34 | 20 | I_{CSI-RS} -15 |
| 35-74 | 40 | I_{CSI-RS} -35 |
| 75-154 | 80 | I_{CSI-RS} -75 |

FIG. 3C is a diagram illustrating a conventional encoding process for a DCI format in accordance with an embodiment of this disclosure.

Referring to FIG. 3C, an eNB separately codes and transmits each DCI format in a respective PDCCH. An RNTI for a UE, for which a DCI format is intended for, masks a CRC of a DCI format codeword in order to enable the UE to identify that a particular DCI format is intended for the UE. The CRC of (non-coded) DCI format bits 310 is computed using a CRC computation operation 320, and the CRC is masked using an exclusive OR (XOR) operation 330 between CRC and RNTI bits 340. The XOR operation 330 is defined as: XOR(0,0)=0, XOR(0,1)=1, XOR(1,0)=1, XOR(1,1)=0. The masked CRC bits are appended to DCI format information bits using a CRC append operation 350, and channel coding is performed using a channel coding operation 360 (such as an operation using a convolutional code). A rate matching operation 370 is applied to allocated resources, interleaving and modulation 380 operations are performed, and an output control signal 390 is transmitted. In the present example, both a CRC and an RNTI include 16 bits.

FIG. 3D is a diagram illustrating a conventional decoding process for a DCI format in accordance with an embodiment of this disclosure.

Referring to FIG. 3D, a UE receiver performs the reverse operations of an eNB transmitter to determine whether the UE has a DCI format assignment in a DL TTI. A received control signal 314 is demodulated, and the resulting bits are de-interleaved at operation 321. A rate matching applied at an eNB transmitter is restored through operation 331, and data is decoded at operation 341. DCI format information bits 361 are obtained after extracting CRC bits 351, which are de-masked 371 by applying the XOR operation with a UE RNTI 381. A UE performs a CRC test 391. If the CRC test passes, a UE determines that a DCI format corresponding to the received control signal 314 is valid and determines parameters for signal reception or signal transmission. If the CRC test does not pass, a UE disregards the presumed DCI format.

PDCCH transmissions can be either Time Division Multiplexed (TDM) or Frequency Division Multiplexed (FDM) with PDSCH transmissions (see [Ref3]). For brevity, the TDM embodiment is considered, but the exact multiplexing method is not material to the purposes of this disclosure. To avoid a PDCCH transmission to a UE blocking a PDCCH transmission to another UE, a location of each PDCCH transmission in the time-frequency domain of a DL control region is not unique and, as a consequence, each UE may need to perform multiple decoding operations to determine whether there are PDCCHs intended for it in a DL TTI. The REs carrying each PDCCH are grouped into Control Channel Elements (CCEs) in the logical domain. For a given number of DCI format bits, a number of CCEs for a respective PDCCH depends on a channel coding rate (Quadrature Phase Shift Keying (QPSK) is assumed as the modulation scheme). An eNB may use a lower channel coding rate and more CCEs for a PDCCH transmission to a UE experiencing low DL Signal-to-Interference and Noise Ratio (SINR) than to a UE experiencing a high DL SINR. The CCE aggregation levels may, for example, include 1, 2, 4, and 8 CCEs.

DCI formats conveying information to multiple UEs, such as DCI format 1C or DCI format 3/3A, are transmitted in a UE Common Search Space (UE-CSS). If enough CCEs remain after the transmission of DCI formats conveying information to multiple UEs, a UE-CSS may also convey DCI format 0/1A for scheduling respective PDSCHs or PUSCHs. DCI formats conveying scheduling information for a PDSCH reception or a PUSCH transmission to a single UE, such as DCI format 0/1A, are transmitted in a UE Dedicated Search Space (UE-DSS). For example, a UE-CSS may include 16 CCEs and support 2 DCI formats with 8 CCEs, or 4 DCI formats with 4 CCEs, or 1 DCI format with 8 CCEs and 2 DCI formats with 4 CCEs. The CCEs for a UE-CSS can be placed first in the logical domain (prior to a CCE interleaving).

As one of the DL control signaling, a Physical Hybrid-ARQ Indicator Channel (PHICH) carries the hybrid-ARQ acknowledgement to indicate to a terminal whether a transport block should be retransmitted or not, in response to uplink UL-SCH transmissions. Multiple PHICHs can exist in each cell. There can be one PHICH transmitted per received transport block and TTI—that is, when uplink spatial multiplexing is used on a component carrier, two PHICHs can be used to acknowledge the transmission, one per transport block. A structure where several PHICHs are code multiplexed onto a set of resource elements is used in LTE. The hybrid-ARQ acknowledgement (one single bit of information per transport block) can be repeated three times, followed by BPSK modulation on either the I or the Q branch and spreading with a length-four orthogonal sequence. A set of PHICHs transmitted on the same set of resource elements is called a PHICH group, where a PHICH group has eight PHICHs in the example of a normal cyclic prefix. An individual PHICH can thus be uniquely represented by a single number from which the number of the PHICH group, the number of the orthogonal sequence within the group, and the branch (I or Q) can be derived. The PHICH resource can be determined from the lowest index PRB of the UL resource allocation and from the UL DMRA cyclic shift associated with the PDCCH with DCI format 0 granting the PUSCH transmission. As a general principle, LTE transmits the PHICH on the same component carrier that was used for the scheduling grant for the corresponding uplink data transmission, with exceptions such as in the example of cross-carrier scheduling.

FIG. 3E is a diagram illustrating a conventional processing for PHICH transmission in accordance with an embodiment of this disclosure. The decoding process of PHICH is the reverse (omitted for brevity).

Referring to FIG. 3E, the hybrid-ARQ acknowledgement (one single bit of information per transport block) is repeated three times 315. BPSK modulation 325 on either the I or the Q branch and spreading with a length-four orthogonal sequence 335 occur. Multiplexing 345, scrambling 355, and resource mapping 365 also occur.

In a TDD communication system, the communication direction in some TTIs (interchangeably, subframes (SFs)) is in the DL and in some other TTIs is in the UL. Table 1 lists indicative UL-DL configurations over a period of 10 TTIs, which is also referred to as a frame period. “D” denotes a DL TTI, “U” denotes a UL TTI, and “S” denotes a special TTI that includes a DL transmission field referred to as DwPTS, a Guard Period (GP), and a UL transmission field referred to as UpPTS. Several combinations exist for the duration of each field in a special TTI, subject to the condition that the total duration is one TTI.

TABLE 1
TDD UL-DL configurations

| TDD | DL-to-UL | | | | | | | | | | |
|---|---|---|---|---|---|---|---|---|---|---|---|
| UL-DL | Switch- | | | | | | | | | | |
| Config- | point | TTI number | | | | | | | | | |
| uration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

The TDD UL-DL configurations in Table 1 provide 40% and 90% of DL TTIs per frame to be DL TTIs (and the remaining to be UL TTIs). Despite this flexibility, a semi-static TDD UL-DL configuration that can be updated every 640 msec or less frequently by System Information (SI) signaling may not match well with short-term data traffic conditions. For this reason, faster adaptation of an ON/OFF configuration is considered to improve system throughput, particularly for a low or moderate number of connected UEs. For example, when there is more DL traffic than UL traffic, the TDD UL-DL configuration may be adapted to include more DL TTIs. Signaling for faster adaptation of a TDD UL-DL configuration can be provided in several ways, including a PDCCH, Medium Access Control (MAC) signaling, and RRC signaling.

An operating constraint in an adaptation of a TDD UL-DL configuration in ways other than SI signaling is the existence of UEs that cannot be aware of such adaptation. Such UEs are referred to as conventional UEs. Since conventional UEs perform measurements in DL TTIs using a respective CRS, such DL TTIs cannot be changed to UL TTIs or to special TTIs by a faster adaptation of a TDD UL-DL configuration. However, a UL TTI can be changed to a DL TTI without impacting conventional UEs since an eNB can ensure that such UEs do not transmit any signals in such UL TTIs. In addition, a UL TTI common to all TDD UL-DL configurations could exist to enable an eNB to possibly select this UL TTI as the only UL one. This UL TTI is TTI#2. Considering the above, Table 2 indicates the flexible TTIs (denoted by ‘F’) for each TDD UL-DL configuration in Table 1.

TABLE 2
Flexible TTIs (F) for TDD UL-DL configurations

| TDD | DL-to-UL | | | | | | | | | | |
|---|---|---|---|---|---|---|---|---|---|---|---|
| UL-DL | Switch- | | | | | | | | | | |
| Config- | point | TTI number | | | | | | | | | |
| uration | periodicity | 0 | 1 | 2 | 3 | 4 | 5 | 6 | 7 | 8 | 9 |
| 0 | 5 ms | D | S | U | F | F | D | F | F | F | F |
| 1 | 5 ms | D | S | U | F | D | D | F | F | F | D |
| 2 | 5 ms | D | S | U | D | D | D | F | F | D | D |
| 3 | 10 ms | D | S | U | F | F | D | D | D | D | D |
| 4 | 10 ms | D | S | U | F | D | D | D | D | D | D |
| 5 | 10 ms | D | S | U | D | D | D | D | D | D | D |
| 6 | 5 ms | D | S | U | F | F | D | F | F | F | D |

An adaptation of a TDD UL-DL configuration can be dynamic. An adapted TDD UL-DL configuration can be signaled via L1 signaling, with a DCI format conveying the new TDD UL-DL configuration.

To extend a transmission bandwidth for a UE and support higher data rates, Carrier Aggregation (CA) can be used, where multiple component carriers (or cells) are aggregated and jointly used for transmission to the UE (DL CA) or from the UE (UL CA). In some examples, up to five component carriers can be aggregated for a UE. The number of component carriers used for DL CA can be different than the number of component carriers used for UL CA. Before CA is configured, a UE may have only one RRC connection with a network. At RRC connection establishment/re-establishment/handover one serving cell provides mobility information, and at RRC connection re-establishment/handover one serving cell provides security input. This cell is referred to as the Primary Cell (PCell). A DL carrier corresponding to the PCell is referred to as a DL Primary Component Carrier (DL PCC), and its associated UL carrier is referred to as a UL Primary Component Carrier (UL PCC). Depending on UE capabilities, DL or UL Secondary Cells (SCells) can be configured to form (together with the PCell) a set of serving cells. In the DL, a carrier corresponding to a Scell is referred to as a DL Secondary Component Carrier (DL SCC), while in the UL it is referred to as a UL Secondary Component Carrier (UL SCC).

CA can be extended from cells associated with one eNB to cells associated with multiple eNBs. Dual connectivity (DC), where a UE maintains its RRC connection to a master eNB (referred to as a master eNB or MeNB) while having a simultaneous connection to a secondary eNB (referred to as a secondary eNB or SeNB). This provides additional radio resources, which can provide advantages in terms of resource utilization efficiency and better provisioning of quality of service. The MeNB can act as a mobility anchor. A group of serving cells associated with the MeNB is referred to as a master cell group (MCG). A group of serving cells associated with the SeNB is referred to as a second cell group (SCG). In MCG, one of the cells can be a PCell. In SCG, one of the cells can be a PCell in SeNB, referred to as an SPCell.

In DC, there may be latency in a backhaul link between an MeNB and an SeNB. If the latency of the backhaul link can be practically zero, CA can be used and scheduling decisions can be made by a central entity and conveyed to each network node. Moreover, feedback from a UE can be received at any network node and conveyed to the central entity to facilitate a proper scheduling decision for the UE. However, if the latency of the backhaul link is not zero, it is often not feasible in practice to use a central scheduling entity since the latency of the backhaul link accumulates each time there is communication between a network node and the central scheduling entity, thereby introducing unacceptable delay for a UE communication. As a result, scheduling decisions can be performed at each network node. Also, feedback signaling from a UE associated with scheduling from a network node may need to be received by the same network node.

For energy efficiency, a cell can be ON or OFF. When a cell is ON, it can operate as a regular cell. When a cell is OFF, it can operate with transmission of limited or no signals. For example, a cell in the OFF state can transmit a limited signal, such as a signal that is for a UE to discover the cell. The ON/OFF of a cell can be dynamic, such as with a duration of each state in a time scale of subframes, or it can be semi-static where a duration of each state can be in a larger time scale than dynamic ON/OFF. The ON/OFF states or ON/OFF configuration of a cell can be adapted, for example, according to the traffic, interference coordination, and the like. When a cell is in the OFF state, the cell can also be referred to as a dormant cell or a cell in a dormant state. A cell in the OFF state may have its receiver on, or it may also turn off partly or fully the receiver chain. As the signals from a cell in the ON or OFF state can be different, a UE may need to know the ON/OFF state or ON/OFF configuration of a cell so that the UE can expect reception of signals transmitted in the respective cell ON/OFF state and the UE can adjust its operation according to the ON/OFF configuration, such as channel measurement and reporting, cell monitoring and discovery, and the like. Hence, a cell ON/OFF configuration and reconfiguration may need to be signaled to a UE or a group of UEs. For the CA or DC embodiment, the Pcell and the Scells configured for a UE may not have the same ON/OFF configuration or reconfiguration. When an eNB supports CA and adaptation of ON/OFF configurations or when eNBs support DC and adaptation of ON/OFF configurations, a signal indicating adapted ON/OFF configurations may include respective ON/OFF configuration indicators for multiple cells.

This disclosure provides a DL signaling mechanism for supporting adaptations of an ON/OFF configuration. This disclosure helps to ensure a desired detection reliability for a DL signaling for an adaptation of an ON/OFF configuration. This disclosure also helps to inform a UE configured with CA operation or DC operation for adaptations of ON/OFF configurations in cells the UE is also configured for operation with an adaptive ON/OFF configuration. This disclosure also provides a mechanism for supporting joint adaptation of ON/OFF configuration and adaptation of TDD UL-DL configuration.

Small cells (e.g. pico cells, femto cells, nano cells) can be densely deployed in a hotzone in order to handle the traffic in the hotzone (e.g. crowded shopping mall, stadium, and the like).

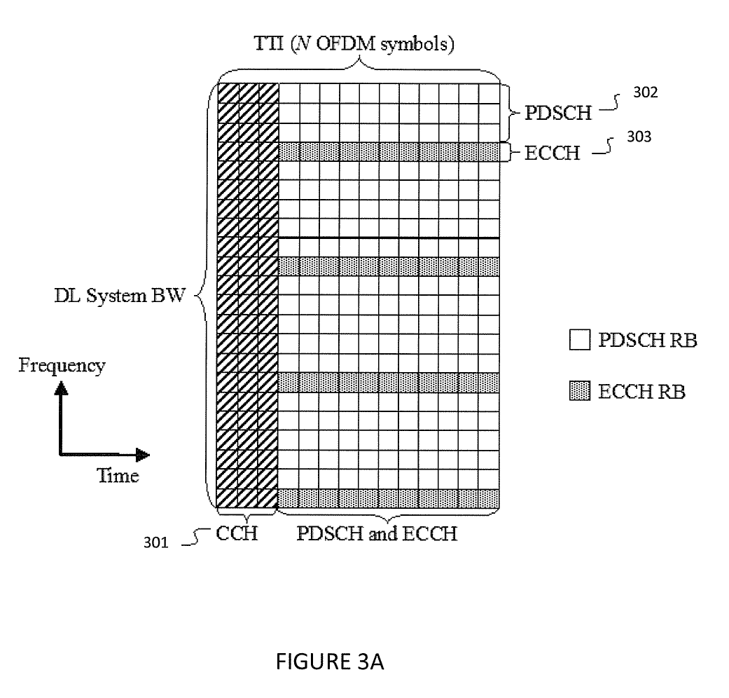

FIGS. 4A-4D illustrate example small cell scenarios in accordance with an embodiment of this disclosure. Some features to be introduced for LTE Rel-12 are related to small cell enhancements and dual connectivity [REF11][REF12]. Features related to the physical layer, spectrum efficiency, efficient operation with reduced transition time of small cell on/off in single-carrier or multi-carrier operation, with enhanced discovery of small cells, and efficient radio interface based inter-cell synchronization are being considered for some or all small cell deployment scenarios.

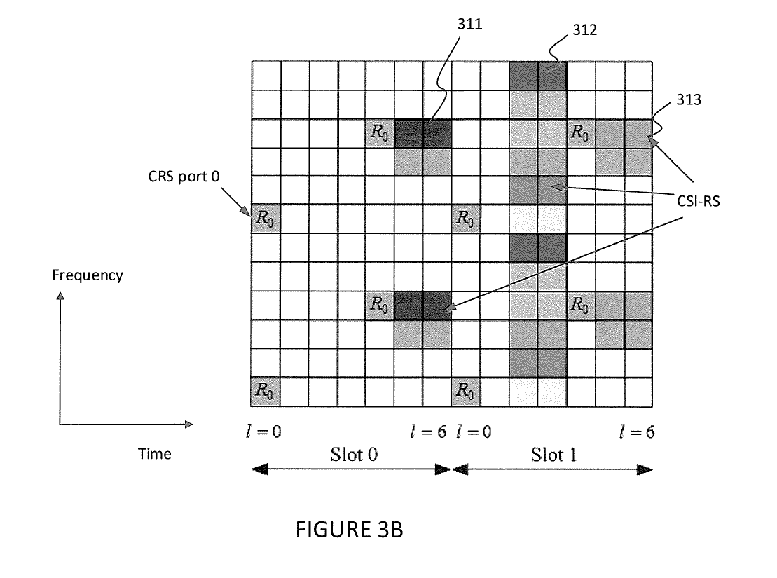

FIG. 5 illustrates coverage of discovery signal and PSS/SSS/CRS in a dense small cells deployment scenario in accordance with an embodiment of this disclosure.

To support efficient operation with reduced transition time of a small cell, on/off, existing, or enhanced/new procedures such as handover, carrier aggregation activation/deactivation, and dual connectivity are being considered. A cell that is OFF is known as a dormant cell.

A dormant cell may transmit only a discovery signal. For the purpose of dormant cell discovery/detection, the eNodeB can configure the UE to perform discovery signal detection. A discovery signal can be a physical signal that has been defined in LTE/LTE-Advanced, e.g. PSS/SSS/CRS/CSI-RS/PRS, or a new physical design, including modified version of the existing physical signals. However, a discovery signal could be designed to be more robust against inter-cell interference compared to the conventional physical signals used for cell detection in LTE, i.e. PSS and SSS. For example, muting by neighboring cells on the resource elements used for the discovery signal of a cell can be applied so that the discovery signal can be detected reliably by the UE even in dense small cells deployment scenarios. Due to the imbalance of signal detectability between the discovery signal and PSS/SSS/CRS in dense small cells deployment scenarios, the coverage of discovery signal and PSS/SSS/CRS can be different when a dormant cell is ON. A discovery signal can have a larger coverage compared to that for PSS/SSS/CRS.

Upon configuration of discovery signal detection, a UE performs cell discovery by attempting to detect discovery signals according to the configuration. The UE may assume the discovery signal time and frequency offsets are within a predefined threshold with respect to the serving cell on the same carrier frequency, e.g. the timing offset is assumed to be within ±3 μs and the frequency offset is assumed to be within ±0.1 ppm.

After a cell's discovery signal is detected by the UE based on a predefined detection criterion (e.g. RSRP of discovery signal is greater a predetermined threshold), the UE measures and reports the measurement result and the corresponding identifier of the discovery signal detected. Alternatively, another predefined condition on the discovery signal quality/strength may need to be satisfied for reporting purpose; for example, the predefined condition can be that the discovery signal's RSRP has to be above a predefined or a configured threshold (e.g. −127 dBm).

For carrier aggregation or dual connectivity, upon receiving detection/measurement reports by a UE, an eNodeB can decide to configure the corresponding cell detected by the UE as a SCell for the UE. An eNodeB (e.g. Master eNodeB, macro eNodeB or MeNB) may configure a cell as a Scell (e.g. belonging to a Secondary eNodeB, small cell eNodeB or SeNB) based on the discovery signal detection and measurement report with or without the corresponding PSS/SSS/CRS detection and measurement report to reduce latency of utilizing a cell that is just turned on. If a cell cannot be detected with PSS/SSS/CRS (or CRS) by the UE, the eNodeB can then decide to signal the release of the SCell (or SeNB) configuration. Similar latency reduction is also possible for handover procedure, i.e. an eNodeB may initiate handover on the discovery signal detection and measurement report with or without the corresponding PSS/SSS/CRS detection and measurement report.

Similar to LTE Rel-10-11, a SCell is deactivated upon configuration (with the possible exception of a Scell with PUCCH configured, which may be always activated). In one possible deployment option, a cell that is OFF is not expected to be activated, while a cell that is ON can be activated or deactivated. In another possible deployment option, a cell that is OFF is not expected to be configured as a SCell. In yet another possible deployment option, a cell that is activated can also be turned off. Which deployment option is feasible can depend on the SCell or SeNB functionality while in the OFF state, whether ON/OFF decision can be made autonomously by the SCell or SeNB, the backhaul capability (e.g. latency), and availability of other new features at eNBs and UEs.

Conditions for RRM measurements of the secondary component carrier with deactivated SCell are specified in [REF6] which is copied below.

TABLE 3
Measurements of the secondary component carrier with
deactivated Scell (from [REF6])

| | | Minimum | SCH |
|---|---|---|---|
| | | SCH_RP | Ês/Iot |
| Parameter | E-UTRA operating bands | dBm/15 kHz | dB |
| Conditions | 1, 4, 6, 10, 11, 18, 19, 21, 23, | −127 | ≧−6 |
| | 24, 33, 34, 35, 36, 37, 38, 39, 40 | | |
| | 9, 42, 43 | −126 | |
| | 28 | −125.5 | |
| | 2, 5, 7, 27, 41, [44] | −125 | |
| | 26 | −124.5^{Note 2} | |
| | 3, 8, 12, 13, 14, 17, 20, 22, 29^{Note 3} | −124 | |
| | 25 | −123.5 | |

NOTE 1:
For a UE supporting a band combination of E-UTRA carrier aggregation with one uplink carrier configuration, if there is a relaxation of receiver sensitivity ΔRIB, c as defined in TS 36.101 [REF5] due to the CA configuration, the SCH_RP measurement side condition shall be increased by the amount ΔRIB, c defined for the corresponding downlink band.
^{NOTE 2}The condition is −125 dBm/15 kHz when the carrier frequency of the assigned E-UTRA channel bandwidth is within 865-894 MHz.
^{NOTE 3}Band 29 is used only for E-UTRA carrier aggregation with other E-UTRA bands.

The present disclosure concerns methods and procedures when a cell changes its state from ON to OFF and vice versa.

The present disclosure can also be applied to LTE on unlicensed band. On an unlicensed band, since there may be other RATs operating on the same unlicensed spectrum as the LAA carrier, there is a need to enable co-existence of other RAT with LAA on an unlicensed frequency spectrum. Carrier Sense Multiple Access (CSMA) can be applied, for example before a UE or a NodeB transmits, it monitors a channel for a predetermined time period to determine whether there is an ongoing transmission in the channel. If no other transmission is sensed in the channel, the UE or the NodeB can transmit; otherwise, the UE or the NodeB postpones transmission. The UE or the eNodeB may transmit a signal for the purpose of reserving the channel/carrier before transmission of signals that contain control or data messages; such a signal can be referred to as ‘reservation signal’ or ‘preamble’. In addition, there can be a maximum channel occupancy time or transmission time after the UE or the eNodeB has gained access to the channel and transmitted. The UE or the eNodeB has to release the channel or stops transmission before the maximum channel occupancy time is reached. Therefore, an LTE cell on unlicensed band needs to be able to switch state from ON to OFF and vice versa.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

In One Embodiment a Procedure is Provided to Enable Cell ON-OFF:

The network may configure a cell that is OFF that has been detected by a UE via discovery signal (DS) as a serving cell (e.g. as a Scell for carrier aggregation or dual connectivity, or as a PCell upon handover) to the UE if the cell has a high probability to be turned on in the near future, e.g. within a few hundreds of milliseconds. Furthermore, the network may configure a cell that is ON as a serving cell to the UE if the cell has a high probability to be utilized as a data pipe for the UE. The cell concerned can be on the same or different carrier frequency as the current serving cell. It is advantageous to specify different UE procedure, e.g. RRM and synchronization procedure, depending on the ON/OFF state of the cell configured in order to facilitate such network operation.

It follows that it is advantageous to define a procedure for a UE to be able to determine the state of the cell detected via discovery signal, i.e. whether the cell is OFF or out of coverage, or is ON and in coverage. In certain embodiments, the UE can decide whether to ‘wake-up’ a dormant cell based on the knowledge of cell's ON/OFF state. In another example, a frequency with the most number of cells that are ON can be prioritized for inter-frequency mobility. To facilitate the procedures mentioned and for other procedures not elaborated further here, there is also a need for the UE to be aware of how a discovery signal is mapped to a cell. In one approach, this can be achieved by mapping an identifier of the discovery signal to a physical cell identifier (PCI). Other approaches are also possible, such as mapping of a DS time-frequency resource index to a PCI (an example is given in [REF9]).

A discovery signal transmitted by a dormant cell for cell discovery purpose can be assigned an identifier that can be used to initialize the discovery signal scrambling sequence generator. For example, if CSI-RS or its modified version (an example is given in [REF9]) is adopted as a discovery signal, the discovery signal sequence can be generated according to Section 6.10.5.1 of TS 36.211 V11.3.0, where its scrambling sequence generator is initialized by:

cᵢₙᵢₜ=2¹⁰·(7·(nₛ+1)+l+1)·(2·N_{ID}^{DS}+1)+2·N_{ID}^{DS}+N_{CP}, (EQ1)

where the definitions of the variables can be found in TS 36.211 V11.3.0 and N_{ID}^{DS} denotes the discovery signal identifier, which can take a value from 0 to 503. The identifier of the discovery signal may or may not be the same as the physical cell identifier (PCI). If they are not the same, the mapping of the discovery signal identifier to the PCI can be provided by the eNodeB through RRC signaling. Furthermore, it is also possible that a discovery signal identifier is associated with a group of cells. For example, the discovery signal may only be transmitted on one of the multiple carriers controlled by an eNodeB.

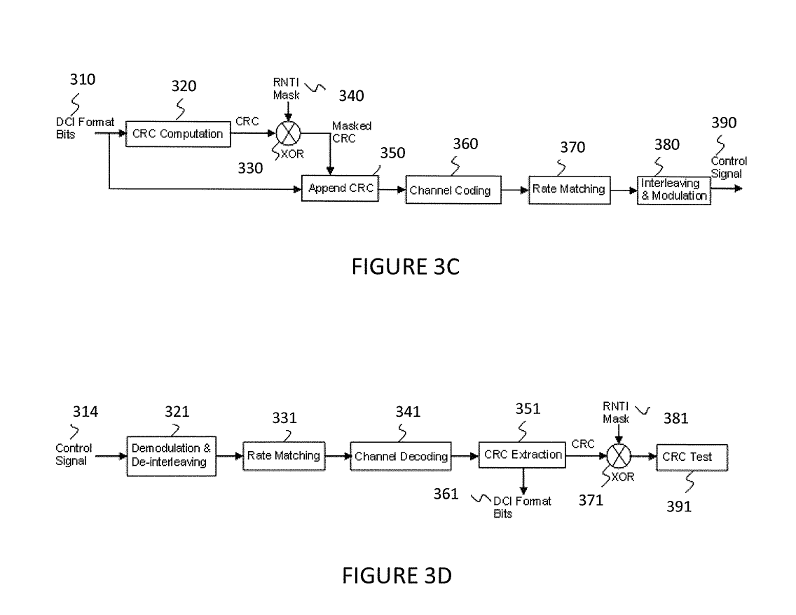

FIGS. 6A-6B illustrate UE procedures to determine the state of a cell detected with a discovery signal in accordance with an embodiment of this disclosure.

The discovery signal can also comprise of one or more of PSS, SSS and CRS (e.g. port 0) transmitted or configured with lower duty cycle (longer periodicity) than the conventional PSS, SSS and CRS. For example, the periodicity of PSS, SSS and CRS of discovery signal can be configured to be 40 ms, 80 ms or 160 ms. For the rest of the disclosure, PSS, SSS and CRS refer to the conventional PSS, SSS and CRS as defined in LTE Rel-8 to Rel-11, unless stated otherwise.

In FIG. 6A, assume only a cell that is ON is transmitting PSS/SSS/CRS, if a UE has detected a discovery signal as well as the PSS/SSS/CRS of the cell associated with the discovery signal detected (e.g. using the legacy RRM procedure as defined in [REF6]), the UE may determine that the cell is ON and is within coverage for access; otherwise the cell detected with discovery signal can be either OFF or is out of coverage for access.

In one example, if PSS, SSS and CRS (port 0) are part of the discovery signal and if a UE configured with discovery-signal-based measurements on a carrier frequency can reliably detect the presence of CRS ports 0 of a cell in subframe(s) not belonging to the discovery signal on that carrier frequency, then the UE may assume the cell is ON. Furthermore, if CRS port 1 is present for the cell, the UE may also use the detection of the present of CRS port 1 to validate that the cell is ON.

In FIG. 6B, the UE determines if a cell is ON and is within coverage for access if the UE has detected a discovery signal as well as the CRS of the cell associated with the discovery signal, i.e. PSS/SSS may not need to be detected; otherwise the cell detected with discovery signal can be either OFF or is out of coverage for access. This is because the PSS/SSS may suffer from more inter-cell interference than that for the CRS (e.g. all PSS/SSS of neighboring cells are colliding in time and frequency), resulting in poorer coverage for the PSS/SSS compared to that for the CRS. A CRS is considered detected if the RSRP measured by the UE based on the CRS is above a predefined threshold (e.g. −127 dBm/15 kHz dB).

Both the processes in FIGS. 6A and 6B may be employed by the UE.

For both the processes in FIGS. 6A and 6B, the UE reports the cell detection and measurement results to the network. If a cell's discovery signal is detected but the cell is determined to be OFF based on the procedure described, the UE repeats attempt to detect the corresponding PSS/SSS/CRS from time to time and reports the outcome to the network when there is a change to the previously reported outcome, e.g. the cell has become ON and in coverage. The PSS/SSS/CRS detection and measurement result is separate from discovery signal detection and measurement result (identifiable e.g. by different measurement identity (reference number in the measurement report) [REF8]). From the discovery signal detection/measurement report and the cell detection/measurement report, the network can also determine the state of the cells as seen by the UE.

Examples for a UE procedure to determine the state of a cell is given in FIG. 6, where in FIG. 6A PSS/SSS/CRS detection is used to determine the state of the cell while in FIG. 6B CRS detection is used to determine the state of the cell. Table 4 summarizes the state of cell interpreted by the UE depending on the detectability of its discovery signal and PSS/SSS/CRS. Table 5 summarizes the state of cell interpreted by the UE depending on the detectability of its discovery signal and CRS.

TABLE 4
State of cell depending on detectability of discovery signal
and PSS/SSS/CRS

| Discovery signal | PSS/SSS/CRS | State of Cell |
|---|---|---|
| Not detected | Not detected | Cell not detected |
| Detected | Not detected | Cell is OFF or is out of |
| | | coverage for access |
| Detected | Detected | Cell is ON and is in coverage |
| | | for access |

TABLE 5
State of cell depending on detectability of discovery signal and CRS

| Discovery signal | CRS | State of Cell |
|---|---|---|
| Not detected | Not detected | Cell not detected |
| Detected | Not detected | Cell is OFF or is out of |
| | | coverage for access |
| Detected | Detected | Cell is ON and is in coverage |
| | | for access |

One method to realize or specify this procedure to specify the conditions based on the detected signal quality of the discovery signal and the PSS/SSS or CRS. Some examples are given below.

In an example for conditions for determining a cell is ON (the first alternative): a minimum SCH_RP (e.g. −127 dBm/15 kHz) and a minimum SCH Ês/Iot (e.g. −6 dB), where SCH_RP and SCH Ês/Iot are both measured based on the PSS/SSS (and the discovery signal), need to be fulfilled.

In another example for conditions for determining a cell is ON (the second alternative): a minimum SCH_RP (e.g. −127 dBm/15 kHz) and a minimum SCH Ês/Iot (e.g. −6 dB), where SCH_RP and SCH Ês/Iot are both measured based on the discovery signal rather than the PSS/SSS, need to be fulfilled (discovery signal associated with the CRS is detected); and a minimum RSRP based on CRS (e.g. −125 dBm/15 kHz) and a minimum RSRP Ês/Iot based on CRS (e.g. −4 dB) also need to be fulfilled (CRS is detected).

In yet another example for conditions for determining a cell is ON (the first and/or the second alternative): a minimum SCH_RP (e.g. −127 dBm/15 kHz) and a minimum SCH Ês/Iot (e.g. −6 dB), where SCH_RP and SCH Ês/Iot are both measured based on the discovery signal or the PSS/SSS, need to be fulfilled (discovery signal or PSS/SSS associated with the CRS is detected); and a minimum RSRP based on CRS (e.g. −125 dBm/15 kHz) and a minimum RSRP Ês/Iot based on CRS (e.g. −4 dB) also need to be fulfilled (CRS is detected).

A UE can also determine the ON or OFF state of a cell if an indicator is signaled by the network. Hereafter, we assume the UE is able to determine the state of the cell detected with procedure as described in FIG. 6.

It is advantageous to specify or configure a different RRM procedure depending on the ON/OFF state of the cell, including cells configured as SCell. An example is as described in Table 6. It is assumed the discovery signal of the cell configured has been detected and reported by the UE. RRM reports can be used to facilitate network's decision making in turning on a dormant cell (or a group of dormant carriers controlled by an eNodeB if the discovery signal is associated with the eNodeB) or turning off an active cell. For instance, if a UE or a sufficient number of UEs report strong discovery signal quality (e.g. RSRP/RSRQ) for a cell that is OFF, the network may decide to turn on the dormant cell and associate the UE(s) to the cell. Similarly, if no UE or insufficient number of UEs report strong CRS signal (or discovery signal) quality for an active cell, the network may decide to remove association of UEs with the cell and turn off the cell. It is assumed that UE RRM measurement procedure based on the discovery signal is defined. Furthermore, it is assumed that UE RRM measurement procedure based on the CRS is also needed even though RRM measurement based on the discovery signal is available because CRS detection quality may not always be inferred from the discovery signal detection quality due to potentially different level of interference that the discovery signal and the CRS are experiencing. Providing the network with accurate CRS measurement is beneficial for supporting CRS based transmission modes (transmission mode 1 to 6) as well as for assisting handover procedure.

In one example, if PSS, SSS and CRS (port 0) are part of the discovery signal and if a UE configured with discovery-signal-based measurements on a carrier frequency can reliably detect the presence of CRS ports 0 of a cell in subframe(s) not belonging to the discovery signal on that carrier frequency, then the UE can also use the CRS port 0 detected for RSRP measurements of that cell). Furthermore, if a UE configured with discovery-signal-based measurements on a carrier frequency can reliably detect the presence of CRS port 1 of a cell on that carrier frequency, then the UE may also use CRS port 1 for RSRP measurements of that cell. In addition, the UE can also use the information about the presence of CRS port 0 not belonging to the discovery signal and CRS port 1 (also don't belong to the discovery signal) as means to determine if the cell may transmit broadcast messages (MIB, SIB(s)) and may support MBMS control signaling (SIB13, SIB15, MCCH notification, and the like).

TABLE 6
UE RRM procedure depending on the state of cell.

| State of cell | RRM procedure |
|---|---|
| OFF or | UE performs a first RRM procedure based on the discovery |
| out of | signal of the cell |
| coverage | UE attempts to detect the cell's PSS/SSS/CRS from time to |
| | time |
| | If the cell has been configured as a Scell, UE does not |
| | perform RRM procedure based on the CRS of the cell, |
| | including measurement according to SCell measurement |
| | cycle even if configured. |
| | The first RRM procedure can be a new RRM procedure |
| | based on discovery signal. |
| ON and | UE performs a second RRM procedure based on the CRS of |
| in coverage | the cell or cells associated with the detected discovery |
| | signal. |
| | Optionally, UE also performs a first RRM procedure based |
| | on the discovery signal of the cell (concurrently) |
| | The second RRM procedure can be the legacy RRM |
| | procedure based on CRS. |

One of the characteristics of RRM procedure based on the discovery signal is the relatively short measurement period with respect to the legacy RRM procedure based on the CRS to facilitate faster cell association to the cell [REF10]. In one example, the first and the second RRM procedure based on the discovery signal (if configured or defined) in Table 6 can be the same. In another example, the first and the second RRM procedure based on the discovery signal (if configured or defined) in Table 6 can be different in the used measurement period, reporting condition, and the like. The UE may perform DS measurement on cells that are OFF less frequently than on cells that are ON, e.g. assuming DS transmission periodicity is T, the UE may measure the DS of cells that are OFF once every 2·T period, and the UE may measure the DS of cells that are ON once every T period. In addition, the threshold for measurement reporting can be lower for cells that are ON compared to that for cells that are OFF.

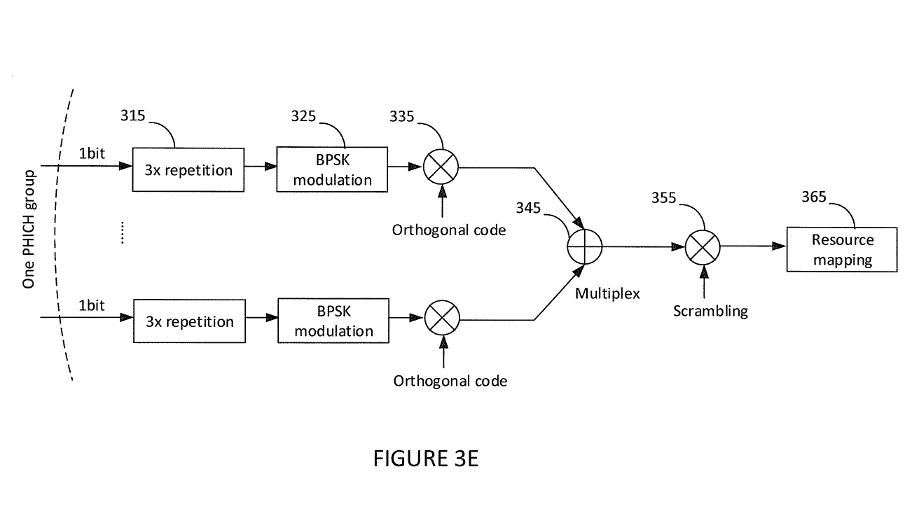

FIGS. 7A-7B illustrate UE RRM procedures depending on the state of the cell configured as a SCell in accordance with an embodiment of this disclosure. FIG. 7A illustrates a general RRM procedure and FIG. 7B illustrates an RRM procedure assuming cell ON/OFF is determined according to FIG. 6.

RRM measurement based on CRS can be configured to the UE by higher layer signaling (e.g. RRC) but may not be performed by the UE if the state of the cell does not require the procedure to be performed. For example, an RRM procedure based on CRS is not performed by the UE if a cell is determined to be OFF or out of coverage. An example UE procedure to determine the RRM procedure to perform is illustrated in FIGS. 7A-7B. One method to realize or specify this procedure to specify the conditions for UE RRM measurement based on discovery signals and CRS. For examples, the conditions for UE RRM measurement based on discovery signal can be: A minimum SCH_RP (e.g. −127 dBm/15 kHz) and a minimum SCH Ês/Iot (−6 dB), where SCH_RP and SCH Ês/Iot are both measured based on the discovery signal, need to be fulfilled. Some examples for the conditions for UE RRM measurement based on CRS are given below:

In an example for conditions for measurement based on CRS of a cell or cells associated with the detected discovery signal: a minimum SCH_RP (e.g. −127 dBm/15 kHz) and a minimum SCH Ês/Iot (e.g. −6 dB), where SCH_RP and SCH Ês/Iot are both measured based on the PSS/SSS (and the discovery signal), need to be fulfilled.

In another example for conditions for measurement based on CRS of a cell or cells associated with the detected discovery signal: a minimum SCH_RP (e.g. −127 dBm/15 kHz) and a minimum SCH Ês/Iot (e.g. −6 dB), where SCH_RP and SCH Ês/Iot are both measured based on the discovery signal rather than the PSS/SSS, need to be fulfilled (discovery signal associated with the CRS is detected); and a minimum RSRP based on CRS (e.g. −125 dBm/15 kHz) and a minimum RSRP Ês/Iot based on CRS (e.g. −4 dB) also need to be fulfilled (CRS is detected).

In yet another example for conditions for measurement based on CRS of a cell or cells associated with the detected discovery signal: a minimum SCH_RP (e.g. −127 dBm/15 kHz) and a minimum SCH Ês/Iot (e.g. −6 dB), where SCH_RP and SCH Ês/Iot are both measured based on the discovery signal or the PSS/SSS, need to be fulfilled (discovery signal or PSS/SSS associated with the CRS is detected); and a minimum RSRP based on CRS (e.g. −125 dBm/15 kHz) and a minimum RSRP Ês/Iot based on CRS (e.g. −4 dB) also need to be fulfilled (CRS is detected).

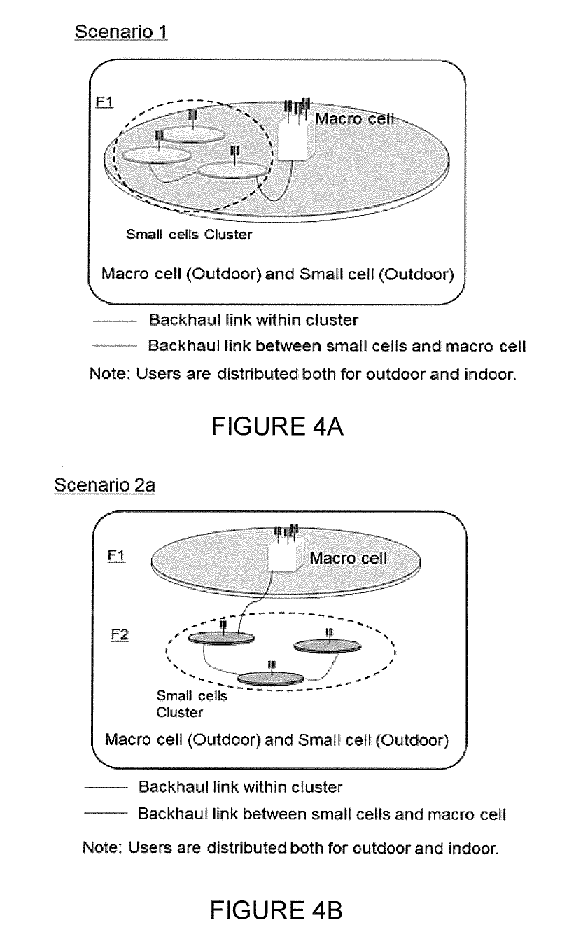

FIG. 8 illustrates a UE RRM procedure—report “OOR” for CRS RSRP/RSRQ when PSS/SSS/CRS or CRS of cell not detected in accordance with an embodiment of this disclosure.

In a method for UE RRM procedure, the UE can perform RRM measurement on the CRS associated with the discovery signal after detection of the discovery signal, regardless of whether the cell is ON or OFF. The conditions for UE RRM measurement based on CRS can be the same as that for the discovery signal, e.g. a minimum SCH_RP (e.g. −127 dBm/15 kHz) and a minimum SCH Ês/Iot (−6 dB), where SCH_RP and SCH Ês/Iot are both measured based on the discovery signal, need to be fulfilled. When UE is not able to detect the CRS, the UE shall report a special value for RSRP/RSRQ (e.g. “Out-Of-Range” or OOR) that indicates failure in CRS detection. This method enables the network to determine that the cell concerned is perceived out of range or OFF for the UE.

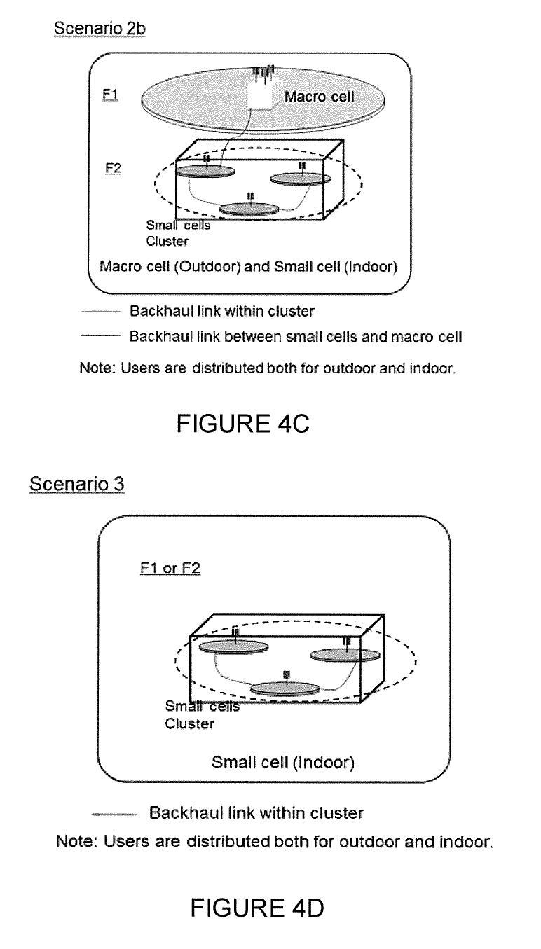

FIGS. 9A-9B illustrate UE QCL procedures in accordance with an embodiment of this disclosure. FIG. 9A illustrates a general QCL procedure and FIG. 9B illustrates a QCL procedure assuming cell ON/OFF is determined according to FIG. 6.

Apart from a RRM procedure, it is also beneficial to specify UE time and/or frequency synchronization behavior to the cell configured, depending on the state of the cell. An example is given in Table 7, where different physical signal is used for time and/or frequency synchronization depending on the state of the cell. For a cell that is ON, through a mapping of discovery signal to CRS of the cell, the UE can also use the discovery signal timing and/or frequency as the starting point or initial reference for synchronization using PSS/SSS/CRS, which can enable a faster synchronization process. In addition, through a mapping of discovery signal to PSS/SSS/CRS of the cell, quasi co-location (QCL) assumption in terms of delay spread, Doppler spread, Doppler shift, average gain, and average delay of discovery signal antenna port and PSS/SSS/CRS/DM-RS/CSI-RS antenna ports can also be established by the UE. Example UE procedures are illustrated in FIG. 9. In one alternative, PSS/SSS may not be detected but CRS is detected. In this example, UE cell synchronization and QCL procedure do not involve PSS/SSS.

TABLE 7
UE cell synchronization procedure depending on the state of cell

| State of cell | Time and frequency synchronization procedure |
|---|---|
| OFF or out of coverage | For RRM based on the discovery signal of the cell, UE performs |
| | synchronization to the cell based on the discovery signal of the |
| | cell. If PRACH or other uplink signals is transmitted to the cell, |
| | the downlink timing reference for the uplink transmission and |
| | the path-loss estimates for uplink power control is based on the |
| | discovery signal received timing and the discovery signal's |
| | RSRP, respectively. |
| | Note that the discovery signal may be assumed to be within a |
| | time offset (e.g. ±3 μs) and a frequency offset (e.g. ±0.1 ppm) |
| | with respect to another co-channel serving cell's signals. |
| ON and in coverage | For RRM and data demodulation, the UE performs |
| | synchronization to the cell based on the PSS/SSS/CRS of the |
| | cell. |
| | The corresponding discovery signal (if detected beforehand) can |
| | be used by the UE as the initial synchronization reference to |
| | achieve faster synchronization to the PSS/SSS/CRS of the cell. |
| | The corresponding discovery signal (if detected beforehand) can |
| | be assumed by the UE to be quasi co-located in terms of delay |
| | spread, Doppler spread, Doppler shift, average gain, and average |
| | delay with the PSS/SSS/CRS of the cell. |

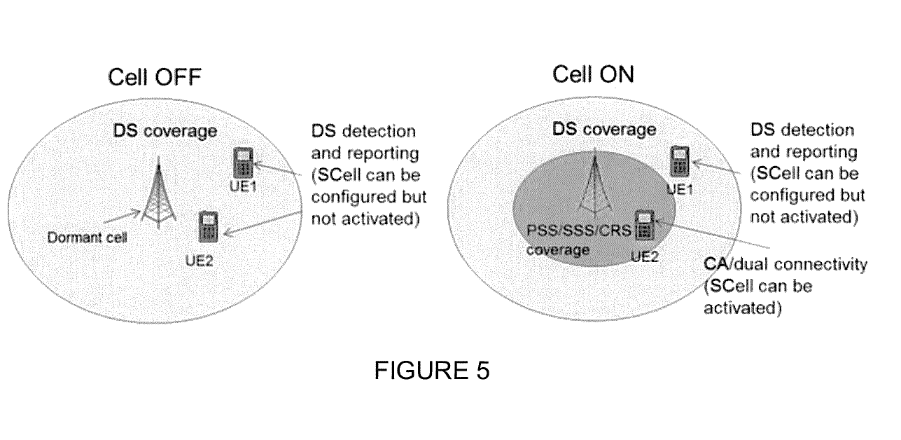

FIG. 10 illustrates an example of an overall UE procedure upon detection of a discovery signal in accordance with an embodiment of this disclosure.

In an example embodiment, assuming a cell that is capable of dormant mode has been configured as a Scell to a UE, the UE shall only consider a SCell to be ON if it is activated. If a SCell is deactivated, it is considered to be OFF or in a dormant state. The UE shall measure (for RRM purpose) and synchronize with CRS of the SCell is it is activated; on the other hand, when the SCell is deactivated, the UE shall measure (for RRM purpose) the discovery signal of the SCell. The RRM procedure and QCL procedure as described in Table 6 (and FIG. 7) and Table 7 (and FIG. 8) are applicable.

Another Embodiment Provides Explicit Cell ON/OFF Signaling:

In the previous embodiment, the UE determines the ON or OFF state of a cell through detection of its PSS/SSS/CRS. In this embodiment, we propose that the UE can be explicitly signaled by a serving eNodeB the ON/OFF state of a cell or a set of cells. Upon receiving the signaling that a cell or a set of cells is ON, the UE tries to detect the presence of the cell(s) over the air, or tries to detect the cell's(s') transition from OFF to ON over the air, or assumes the cell(s) is (are) already transmitting signals. Specifically, ‘ON’ state can mean that the cell is already transmitting or can potentially transmit within a predetermined or configured time frame. UE procedures may include AGC tuning and attempt to synchronize with the cell(s). One of the benefits of such signaling is that it allows the UE to skip detecting the PSS/SSS/CRS of the cell that has been indicated to be OFF by the network. This is beneficial to reduce UE signal processing time and power consumption; particularly if the cell is on a non-serving frequency (cell measurement involves inter-frequency measurement). Specifically, if it is known that a frequency doesn't have any cell within coverage that is ON, the UE may not spend time, RF and computational resource on detecting/measuring/synchronizing with the PSS/SSS/CRS of cells of the frequency. The ON/OFF signaling for a cell under this embodiment can be a single ON or OFF indication, or can be an indication of ON/OFF pattern over a period of time.

Furthermore, PSS/SSS/CRS detection and measurement may not be accurate especially in a dense small cell deployment scenarios due to potentially severe inter-cell interference, e.g. the RSRP of CRS may be over-estimated due to the inter-cell interference and as a result, false alarm may occur with a relatively high probability. Explicit signaling of cell ON/OFF can help to reduce cell misdetection and false alarm rate by allowing the UE to skip or ignore cells that have been explicitly signaled to be OFF. This can help to avoid triggering unnecessary RRM, synchronization procedure towards cells that are mistaken to be ON by the UE.

Another benefit of explicit ON/OFF signaling is that a change in the ON/OFF state of a cell on a frequency can be used to change the priority of the frequency or the priority cell detection and measurement by the UE. In one example, for a cell that is just indicated to be ON and the cell is currently configured as a serving cell or SCell to the UE, a procedure or rule can be specified such that the UE shall prioritize PSS/SSS/CRS detection and CRS based RRM measurement on the cell. Compared to a scheme where the UE is left to detect ON/OFF state of the cell on its own, explicit cell ON/OFF signaling can reduce the latency of UE report generation. In another example, frequency with the most number of cells that are ON can be prioritized for inter-frequency mobility.

Explicit signaling of ON/OFF state of a cell or a set of cells can be beneficial for LTE deployment on unlicensed band, where the signaling from another serving cell e.g. on a licensed carrier can trigger signal reception preparation at the UE on another carrier(s) on the licensed band, which involves e.g. transition from cell(s) DTX-to-transmission detection, AGC, synchronization using ‘preamble’ or ‘reservation signal’ or CRS/PSS/SSS or discovery signal. Upon receiving the control signal, UE attempts to detect cell(s) transition to from DTX to non-DTX (by detecting ‘preamble’, reservation signal or discovery signals on DL subfames). Self-scheduling/cross carrier-scheduling can then happen on unlicensed carrier(s). The network may not have successfully reserved the channel(s) when the control signaling is transmitted. The control signaling only informs UEs about network intention to attempt to reserve the channel(s) for scheduling. The network may only try to access or reserve the channel(s) after a predetermined amount of time since the transmission of the control signaling has lapsed. The amount of time lapsed (e.g. 1 ms or 2 ms, which can be known to the UE), before the network starts to try to access the channel, should be sufficient for the UE to receive and decode the control signaling and prepare its RF frontend to detect the corresponding cell(s) transition to from DTX to non-DTX. This reduces the overhead of reservation signals (e.g. as overhead from transmission and UE decoding time are removed), particularly important if the maximum channel occupancy is limited, e.g. 4 ms. Note that multiple carriers' transmission times by the eNodeB need not be aligned, e.g. the start times may not be aligned. The on/off signaling is only needed for one time (until the next time network changes its preferred set of carriers, which reduces the overhead of the signaling. The signaling may have a ‘valid period’, e.g. an X ms period (e.g. X=10 ms, 20 ms, 40 ms, 80 ms and the like). If ‘valid period’ is defined and has passed without new signaling received, UE doesn't need to monitor the cell(s)/carrier(s) or assumes that the cell(s)/carrier(s) are OFF and the UE can continue to monitor for the explicit signaling of ON/OFF state. The ‘valid period’ can be either predefined or configurable by the network (e.g. via RRC). In one example, the explicit signaling of ON/OFF state of a cell or a set of cells can be the same as a method as described below.

In one example method of cell ON/OFF signaling, change of ON/OFF state of a cell or cells can be informed by the serving cell to a UE via RRC signaling. The RRC signaling which can be dedicated signaling or broadcast signaling includes the ON/OFF state for a list of cells per frequency.

In one example of this method, the information regarding the ON/OFF state of a cell or cells is signaled in a System Information Block transmitted on a serving cell (which may be on a different carrier frequency). Upon acquiring the system information block, the UE applies the configuration immediately or at a later but predetermined time. When cells are frequently turned ON or OFF, it is beneficial not to indicate the general system information change when there is a change in a cell's ON/OFF status so as to avoid excessive MIB and SIB reading time. A UE tracking the state of the cells read the SIB periodically. The period of the SIB transmission can be configurable in accordance to how frequent a cell can be turned ON or OFF by the network; e.g. if a cell is turned ON/OFF once every second, the SIB (including possible repetitions) can be transmitted once every second. For a UE that has no valid configuration of the cell ON/OFF information, e.g. because it has just accessed the network, the cell ON/OFF signaling can be delivered to the UE via dedicated RRC signaling. The UE can also be informed via paging about the change. For this purpose, a new paging message can be introduced.

In another example of this method, the cell ON/OFF information can be included in UE's measurement configuration (for RSRP/RSRQ measurement and reporting, or for DS RSRP measurement and reporting), in a SIB or in a dedicated RRC message. The measurement configuration can be, for example, for configuring a UE to measure CRS, CSI-RS, or discovery signal. The measurement configuration includes the ON/OFF state for a list of cells per frequency. Alternatively, the ON/OFF state is signaled by listing the cells to be detected for cells of ON state and for blacklisting cells for cells of OFF state. When cells are frequently turned ON or OFF, it is beneficial to modify the existing measurement procedure such that a change in the ON/OFF state or a change in the cell list to be detected or the blacklisted cells does not reset the measurement for all cells on the frequency concerned. Instead, the measurements for cells where the status is unchanged do not get reset and only the measurements of the cells affected by the reconfiguration are impacted. The modified procedure can be applicable only to frequency or a set of cells that are operating ON/OFF. To enable this, the RRC signaling can indicate whether to apply the new behavior on a frequency or a set of cells configured.

In another example method of cell ON/OFF signaling, change of ON/OFF state of a cell can be informed by the serving cell to a UE via MAC signaling. It is assumed the network has configured the cell concerned as a SCell, with a SCell index.

MAC signaling of the ON/OFF state of a cell comprises of a MAC control element that is identified by a MAC PDU subheader with a new LCID as specified e.g. in Table 8.

TABLE 8
New Value of LCID for ON/OFF MAC control element for DL-SCH

| Index | LCID values |
|---|---|
| 00000 | CCCH |
| 00001-01010 | Identity of the logical channel |
| 01011-11001 | Reserved |
| 11010 | ON/OFF |
| 11011 | Activation/Deactivation |
| 11100 | UE Contention Resolution Identity |
| 11101 | Timing Advance Command |
| 11110 | DRX Command |
| 11111 | Padding |

A list of cells can be configured to be addressable by the MAC control element. The list of cells can comprise of cells on different frequencies (one cell per frequency) or can comprise of cells on the same frequency (multiple cells per frequency) or a hybrid combination.

For carrier aggregation or dual connecvity, the list of cells can correspond to only cells that have been configured as a serving cell. For cells on the same frequency, they can correspond to the different transmission point on the same frequency in a Coordinated Multi-Point (CoMP) transmission and reception scheme.

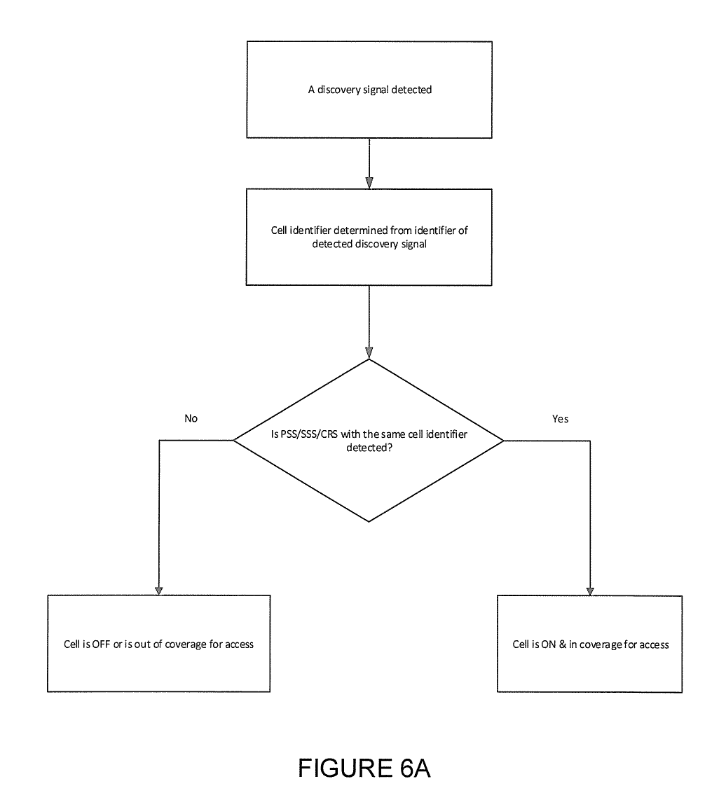

FIGS. 11A-11C illustrate ON/OFF MAC control elements in accordance with an embodiment of this disclosure.

In FIG. 11A, in one example of ON/OFF MAC control element, the ON/OFF MAC control element has a fixed size and consists of a single octet containing seven D-fields and one R-field. The ON/OFF MAC control element is defined as follows.
Dᵢ: if there is a Scell configured with SCellIndex i as specified in [REF8], this field indicates the ON/OFF status of the SCell with SCellIndex i, else the UE shall ignore the Dᵢ field. The Dᵢ field is set to “1” to indicate that the SCell with SCellIndex i is or shall be ON. The Dᵢ field is set to “0” to indicate that the SCell with SCellIndex i is or shall be OFF. In another example, Dᵢ can also include cells that are candidate for SCell addition. In yet another example, Dᵢ can correspond to a Secondary Carrier Group (SCG), where setting the Dᵢ field to “1” to indicate that the SCells belong to the SCG i can be ON;
R: Reserved bit, set to “0”.

In FIG. 11B, in another example of ON/OFF MAC control element, the ON/OFF MAC control element has a fixed size and consists of a single octet containing two F-fields, five D-fields and one R-field. The ON/OFF MAC control element is defined as follows.
Fᵢ: this field indicates the carrier frequency of the SCells indicated by the D-fields (e.g. ‘00’ indicates carrier frequency 1, ‘01’ indicates carrier frequency 2 and so on);
Dᵢ: if there is a Scell configured with SCellIndex i as specified in [REF8], this field indicates the ON/OFF status of the SCell with SCellIndex i on carrier frequency, else the UE shall ignore the Dᵢ field. The Dᵢ field is set to “1” to indicate that the SCell with SCellIndex i is or shall be ON. The Dᵢ field is set to “0” to indicate that the SCell with SCellIndex i is or shall be OFF. In another example, Dᵢ can also include cells that are candidate for SCell addition. In yet another example, Dᵢ can correspond to a Secondary Carrier Group (SCG), where setting the Dᵢ field to “1” to indicate that the SCells belong to the SCG i can be ON;
R: Reserved bit, set to “0”.

In FIG. 11C, in another example of ON/OFF MAC control element, the ON/OFF MAC control element has a fixed size and consists of a single octet containing two F-fields, five D-fields and one R-field. The ON/OFF MAC control element is defined as follows.
Dᵢ^{k}: if there is a Scell configured with SCellIndex i or SCell candidate index i on carrier frequency k, this field indicates the ON/OFF status of the SCell with SCellIndex i or SCell candidate index i on carrier frequency k, else the UE shall ignore the Dᵢ^{k} field. The Dᵢ^{k} field is set to “1” to indicate that the SCell with SCellIndex i or SCell candidate index i on carrier frequency k is or shall be ON. The Dᵢ^{k} field is set to “0” to indicate that the SCell with SCellIndex i or SCell candidate index i is or shall be OFF;
R: Reserved bit, set to “0”.

To reduce signalling overhead, SCell activation MAC control element for a cell can also be used to indicate that the cell is ON or shall be turned on. However, SCell deactivation MAC control element for a cell does not imply that the cell is OFF or shall be turned off.

The ON/OFF MAC control element is signalled using dedicated (or UE-specific) signalling. However, broadcast signalling is also possible. To support broadcast signalling of the ON/OFF MAC control element, the broadcast MAC control element can be scheduled by PDCCH that is addressed to a new common RNTI can be defined, called “O-RNTI” (the CRC of the PDCCH is scrambled by O-RNTI). The UE is configured to monitor O-RNTI in order to be notified the ON/OFF status of cells. Since SCellIndex configuration is UE-specific but the cell index indicated in the ON/OFF MAC control element needs to be commonly understood by all UEs, there can be a separate SCell ON/OFF index defined and configured for each SCell configured to the UE. For a given cell, the same SCell ON/OFF index is configured for all UEs.

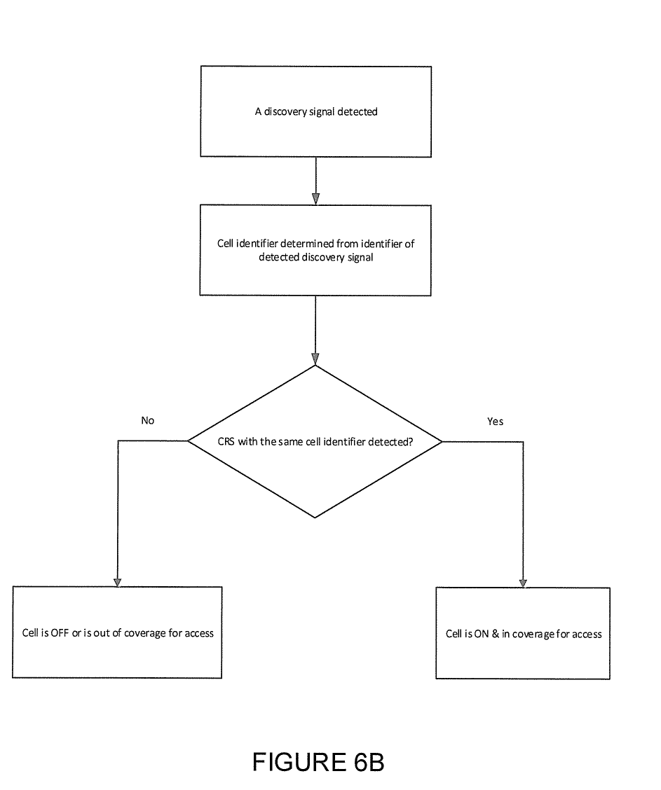

FIG. 12 illustrates SCell activation/deactivation on ON/OFF MAC control elements in accordance with an embodiment of this disclosure. In another method of cell ON/OFF signaling, the ON/OFF MAC signaling can be combined with SCell activation/deactivation MAC control element.

The combined Activation/Deactivation and ON/OFF MAC control element has a fixed size and consists of two octets, each containing seven C-fields and one R-field. The combined Activation/Deactivation and ON/OFF MAC control element is defined as follows.
Cᵢ: if there is a Scell configured with SCellIndex i as specified in [REF8], this field indicates the activation/deactivation status of the SCell with SCellIndex i, else the UE shall ignore the Cᵢ field. The Cᵢ field is set to “1” to indicate that the SCell with SCellIndex i shall be activated. The C, field is set to “0” to indicate that the SCell with SCellIndex i shall be deactivated;
Dᵢ: if there is a Scell configured with SCellIndex i as specified in [REF8], this field indicates the ON/OFF status of the SCell with SCellIndex i, else the UE shall ignore the Dᵢ field. The Dᵢ field is set to “1” to indicate that the SCell with SCellIndex i is or shall be ON. The Dᵢ field is set to “0” to indicate that the SCell with SCellIndex i is or shall be OFF;
R: Reserved bit, set to “0”.

As an activated cell means that the cell is ON, if Cᵢ is set to “1”, it is expected that Dᵢ is also set to “1”.

In another method of cell ON/OFF signaling, the signaling of cell ON/OFF is indicated via PDCCH or EPDCCH, which is transmitted by a serving cell on the same or a different frequency (e.g. PCell or a Scell of a SCG), and the UE is required to monitor a new DCI format or a new DCI format that is based on an existing DCI format. To distinguish the PDCCH/EPDCCH, it is addressed to a new RNTI, called “O-RNTI” (the CRC of the PDCCH is scrambled by O-RNTI). Multiple UEs can monitor the same RNTI, i.e. the PDCCH/EPDCCH is to be received by multiple UEs. The behaviour of monitoring O-RNTI can be configurable by the network. Since ON/OFF status of a cell may not change frequently, the UE may also be configured to monitor O-RNTI for a periodically occurring time-window, where the length of the time window and the period between time window can both be configurable by the network.

In one example of this method, the new DCI format can have the same size as DCI format 1C, therefore the number of PDCCH/EPDCCH blind decodes are not increased. Furthermore, DCI format 1C has relatively low overhead but contain sufficient number of bits for the purpose of cell ON/OFF signaling. An example design is given below where x number of bits is used for cell ON/OFF notification for x cells. x can be predefined (e.g. 5 or 8 bits) or can be configurable by the network by higher layer signaling to allow scalability and network flexibility. Which of the x cells are indicated by the PDCCH/EPDCCH is configurable by higher layer signaling. The x cells can be on the same carrier frequency, or different frequency (i.e. different cell is on different carrier frequency), or a combination of cells on the same and different carrier frequencies.
—start DCI format example—

DCI format 1C is used for very compact scheduling of one PDSCH codeword, indicating cell ON/OFF (or cell non-DTX monitoring) and notifying MCCH change [3GPP TS 36.331].

The following information is transmitted by means of the DCI format 1C:

If the format 1C is used for very compact scheduling of one PDSCH codeword:
1 bit indicates the gap value, where value 0 indicates N_{gap}=N_{gap,1} and value 1 indicates N_{gap}=N_{gap,2}
For N_{RB}^{DL}<50, there is no bit for gap indication
Resource block assignment—┌log₂(└N_{VRB,gap1}^{DL}/N_{RB}^{step}┘·(└N_{VRB,gap1}^{DL}/N_{RB}^{step}┘+1)/2)┐ bits as defined in 7.1.6.3 of [REF3] where N_{VRB,gap1}^{DL} is defined in [REF2] and N_{RB}^{step} is defined in [REF3]
Modulation and coding scheme—5 bits as defined in section 7.1.7 of [3GPP TS 36.213]

Else if the format 1C is used to indicate cell ON/OFF (or cell non-DTX monitoring):
Cell ON/OFF (or cell non-DTX monitoring) notification—x bits (e.g. x=5 or 8 or 10 or configurable)
Reserved information bits are added until the size is equal to that of format 1C used for very compact scheduling of one PDSCH codewode

Else:
Information for MCCH change notification—8 bits as defined in section 5.8.1.3 of [3GPP TS 36.331]
Reserved information bits are added until the size is equal to that of format 1C used for very compact scheduling of one PDSCH codeword
—end DCI format example—

An advantage of this method over the previous methods in this embodiment is that idle mode can also be supported.

The value for O-RNTI can be either predefined or configurable by the network. If the O-RNTI is configured by the network, the network can partition UEs in multiple groups and each group of UEs can be configured with a unique O-RNTI value. The advantage of network configured UE-group O-RNTI is that when there is a large number of cells or carriers, not all cells or carriers are relevant or applicable to a UE, e.g. due to UE location/measurement and coverage differences of the cells or carriers. Each O-RNTI can be configured to address different set or number of cells (by higher layer signaling such as RRC).

In one example, the DCI signaling can be applied to LTE cells or carriers on unlicensed band. The network can configure the UE with a set of SCells on unlicensed band. The set can be potentially large (e.g. 5 or 10 or greater) since there can be a large number of carriers available on unlicensed band. The network can further activate a subset of SCells on unlicensed band using MAC CE. The DCI signaling (e.g. from another serving cell on licensed band or PCell) can indicate the ON/OFF states of a subset of configured or/and activated SCells (or which SCells are DTX-ed and which are not) or can indicate a subset of configured or/and activated SCells that the UE has to monitor for non-DTX (DTX-to-non-DTX detection). The DCI signaling can also be considered L1 activation or deactivation command if the MAC CE based activation/deactivation is not applicable to SCells on unlicensed band. If a unlicensed carrier or cell is activated and is indicated ON, the UE monitors the PDCCH/EPDCCH for the unlicensed carrier. The PDCCH/EPDCCH for the unlicensed carrier can be transmitted on the unlicensed carrier itself or from another serving cell as cross carrier scheduling using CIF in the DCI formats for DL assignment or UL grant (PDCCH with CRC scrambled with C-RNTI). The indication of ON/OFF state by the DCI signaling can be used to indicate the SCells addressed by the CIF. The described mechanism allows the network to perform fast and dynamic carrier selection for scheduling from potentially large number of SCells.

For instance, if there are 10 SCells RRC-configured (and activated if MAC activation procedure is applicable) to the UE, the DCI signaling can consist of 10-bit bitmap that indicates up to a maximum number of SCells (e.g. 4 or 5 or 7 or 8) that can be indicated by the 3-bit CIF. If the bitmap indicates 0011010100, the 3^{rd}, the 4^{th}, the 6^{th} and the 8^{th} secondary carriers are ON/non-DTX-ed/potentially non-DTX-ed and the rest are OFF/DTX-ed. After a UE has received the DCI signaling in a subframe, the UE shall assume that the CIF of DCI formats received in the same subframe as the DCI signaling or in a subsequent subframe shall indicate one of the scheduling carrier, the 3^{rd}, the 4^{th}, the 6^{th}, the 8^{th} secondary carrier, e.g. CIF of 000 indicates the scheduling carrier, CIF of 001 indicates the 3^{rd} secondary carrier, CIF of 010 indicates the 4^{th} secondary carrier, CIF of 011 indicates the 6^{th} secondary carrier, CIF of 100 indicates the 8^{th} secondary carrier. This is illustrated by Table 9. In another example, if the bitmap indicates 1001000000, then CIF of 000 indicates the scheduling carrier, CIF of 001 indicates the 1^{st} secondary carrier and CIF of 010 indicates the 4^{th} secondary carrier.

TABLE 9
Example of CIF mapping according to DCI-based ON/OFF signaling

| | | SCell indicated ON or | |
|---|---|---|---|
| SCell | | non-DTX monitoring | |
| configured | SCell activated by | by PDCCH with CRC | CIF mapping to |
| by RRC | MAC CE (0 = | scrambled with O- | SCell |
| (SCell | deactivated, 1 = | RNTI (0 = DTX, | (note: CIF 000 for |
| index) | activated)* | 1 = non-DTX) | scheduling cell) |
| 1 | 1 | 0 | N/A |
| 2 | 1 | 0 | N/A |
| 3 | 1 | 1 | 001 |
| 4 | 1 | 1 | 010 |
| 5 | 0 | 0 | N/A |
| 6 | 1 | 1 | 011 |
| 7 | 0 | 0 | N/A |
| 8 | 1 | 1 | 100 |
| 9 | 0 | 0 | N/A |
| 10 | 1 | 0 | N/A |

MAC CE activation/deactivation may not be needed if it is not applicable to SCells on unlicensed band. In this embodiment, PDCCH indicated ON/OFF can be seen as L1 controlled activation/deactivation.

TABLE 10
Example of CIF mapping according to DCI-based ON/OFF signaling

| SCell | | SCell indicated ON or | |
|---|---|---|---|
| configured | SCell activated by | non-DTX by PDCCH | CIF mapping to |
| by RRC | MAC CE (0 = | with CRC scrambled | SCell |
| (SCell | deactivated, 1 = | with O-RNTI (0 = | (note: CIF 000 for |
| index) | activated)* | DTX, 1 = non-DTX) | scheduling cell) |
| 1 | 1 | 1 | 001 |
| 2 | 1 | 0 | N/A |
| 3 | 1 | 0 | N/A |
| 4 | 1 | 1 | 010 |
| 5 | 0 | 0 | N/A |
| 6 | 1 | 0 | N/A |
| 7 | 0 | 0 | N/A |
| 8 | 1 | 0 | N/A |
| 9 | 0 | 0 | N/A |
| 10 | 1 | 0 | N/A |

MAC CE activation/deactivation may not be needed if it is not applicable to SCells on unlicensed band. In this embodiment, PDCCH indicated ON/OFF can be seen as L1 controlled activation/deactivation.

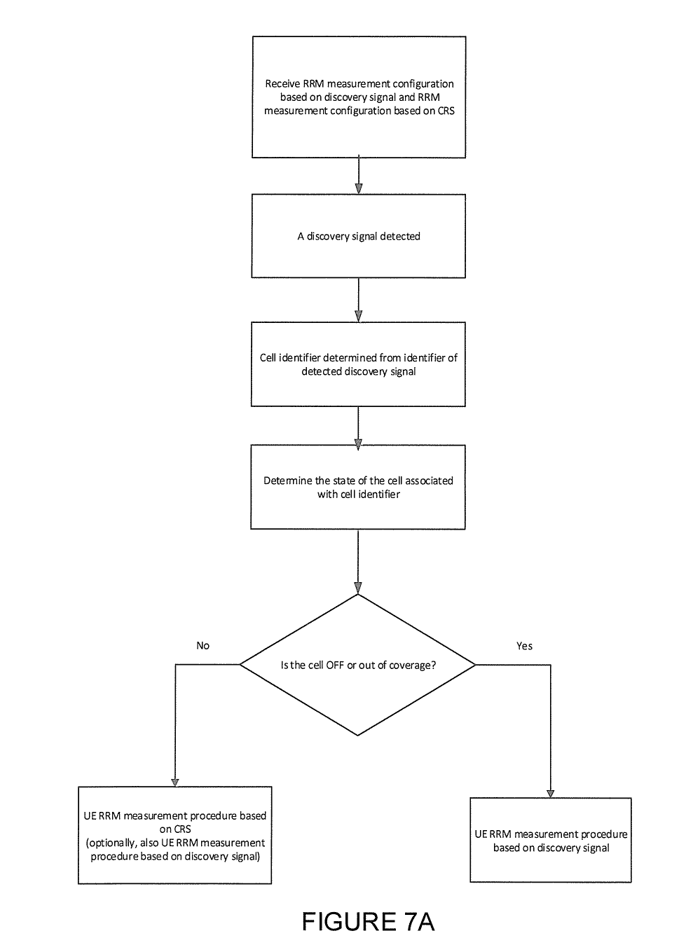

FIG. 13 illustrates a process showing the procedure associated with the UE group-common signaling in accordance with an embodiment of this disclosure.

The DCI signaling indicating ON/OFF state of cells or carriers can also include other information such as the duration of ON (or potential non-DTX) period of each cells or carriers indicated to be ‘ON’. The number of information bits that indicate the duration can be log 2 of the possible number of durations, rounded up to the nearest integer. For example, if duration from 1 ms to 10 ms or 4 ms is possible, the number of bits can be 4 or 2, respectively. This enables the UE to stop receiving from the cells concerned after the end of the duration indicated in order to save UE power. This also avoids the need for the UE to perform blind detection of whether a cell stops transmission before the end of the maximum ‘ON’ duration. To save signaling overhead, all cells or a group of cells indicated in the same DCI can share the same ON duration indication. In one option, the common duration signaling may not preclude the network from stopping transmission on a particular carrier earlier and the UE can still perform blind detection to detect earlier termination of the ON period.

The DCI signaling indicating ON/OFF state of cells or carriers can also include other information such as the presence of a certain reference signals (e.g. discovery signals, synchronization signals, such as PSS, SSS, CRS, CSI-RS, or a certain preamble), its transmission duration, or its location during the ON period of the cell. For example, if the DCI signaling indicates the presence of a discovery signal, the UE may assume that the first ON subframe contains the discovery signal.

As mentioned previously, this method can be beneficial as a means to trigger detection of cell(s) transmissions on unlicensed band. An example flowchart illustrating the procedure is given in FIG. 13.

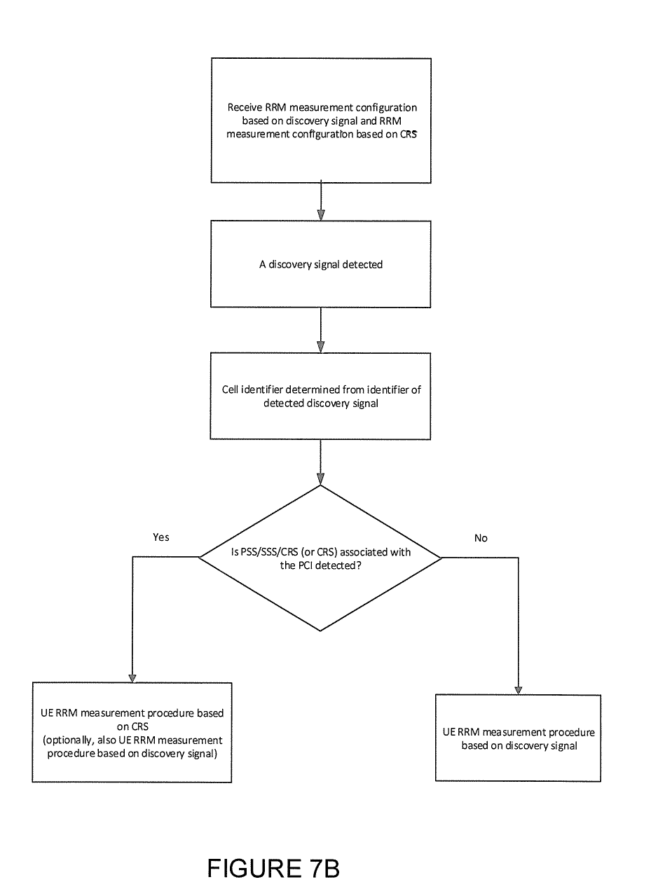

FIG. 14 illustrates an example UE procedure upon detecting discovery signal and cell ON/OFF signaling in accordance with an embodiment of this disclosure.

In a method of cell ON/OFF signaling, the ON/OFF signaling can be detected jointly with the discovery signal, i.e. the discovery signal also contains information about the ON/OFF state of the cell.

In an alternative of this method, assume the discovery signal's scrambling sequence is initialized by the discovery cell identifier N_{ID}^{DS} when it is ON, N_{ID}^{DS} is offset by the maximum value of N_{ID}^{DS}+1 when it is OFF. In one example of this alternative of this method, if CSI-RS is used as the discovery signal, a cell is determined to be ON if its scrambling sequence is initialized with Eq(1); and the cell is determined to be OFF if its scrambling sequence is initialized with Eq(2) below. This method can be applied to discovery signal based on other physical signals as well.

cᵢₙᵢₜ=2¹⁰·(7·(nₛ+1)+l+1)·(2(N_{ID}^{DS}+504)+1)+2·(N_{ID}^{DS}+504)+N_{CP} (EQ2)

Another way to view this method is that the range of N_{ID}^{DS} is increased to be 0 to 1006. If a cell's discovery signal identifier is N_{ID}^{DS} in Eq(1) when it is ON, then the cell's discovery signal identifier is N_{ID}^{DS}+504 in Eq(1) when the cell is OFF. This method can also be used to enable eNB-to-eNB listening of the cell ON/OFF status; an eNB can determine the ON/OFF state of another eNB through detecting the discovery signal of the eNodeB.

Similar to an embodiment above, the UE procedure for RRM measurement and QCL depends on the result of discovery signal detection and the ON/OFF signaling. An example of the overall UE procedure is illustrated in FIG. 14. Change of cell ON/OFF state can be indicated by the network and it triggers the appropriate UE procedures (e.g. RRM, synchronization and QCL) as indicated in FIG. 14.

In an alternative of this method, the location of discovery signal resource elements can be used to differentiate the ON/OFF state of a cell. In one example of this method, if CSI-RS is used as the discovery signal, a first CSI-RS configuration [REF1] is used to indicate that the cell is ON and a second CSI-RS configuration is used to indicate that the cell is OFF. The CSI-RS sequence for both configurations is the same. The mapping of CSI-RS configuration to ON/OFF state is predefined or configured by RRC.

In an alternative of this method, assuming time-domain orthogonal cover code (OCC) is applied to the discovery signal. For example, when CSI-RS is used as the discovery signal, then the time-domain orthogonal cover code applied to the discovery signal can be used to indicate the ON or OFF state of a cell. For example, OCC of [1, 1] (CSI-RS port 15 or 17 or 19 or 21) can be used to indicate ON state while OCC of [1, −1] (CSI-RS port 16 or 18 or 20 or 22) can be used to indicate OFF state. If a CSI-RS port used for cell discovery is also used for CSI measurement is used to generate RI, PMI and CQI, then if CSI-RS port with OCC of [1, 1] (port 15 or 17 or 19 or 21) and [1, −1] (port 16 or 18 or 20 or 22) are both detected, the cell is determined to be ON. In other words, a cell is determined to be OFF, if CSI-RS with OCC of [1, −1] is detected but not OCC of [1, 1]. An advantage of this alternative over the first alternative is that the range of N_{ID}^{DS} is not increased, which reduces false alarm rate. If the OCC (or port) detected is included in the measurement report, the UE can inform the serving cell the on/off state of the cell as seen by the UE. If OCC (or port) is used to derive a CSI-RS index [REF9], then reporting the CSI-RS index can also be used to inform the network about the on/off state of the cell measured. If a pair of CSI-RS indices corresponding on or off is mapped to a PCI, and the PCI is included in the measurement report, then one bit can be included in addition in the measurement report to indicate the on/off state of the cell measured.

In an alternative of this method, a discovery signal sequence for ON can be the algebraic opposite of a sequence for OFF in order to maximize differentiation between ON/OFF states. For example, if the discovery signal's sequence for ON is defined as r(k) where k is sequence index in the frequency domain, then the discovery signal's sequence for OFF is defined as −r(k).

In an alternative of this method, the ON/OFF signaling is implied by the presence of the discovery signal, i.e. if the discovery signal of a cell is detected to be present by the UE, the cell is assumed by the UE to be OFF; otherwise if the discovery signal of a cell that is previously detected is determined to be not present in the resource elements expected by the UE, then the cell is assumed by the UE to be ON. For this alternative, the cell only transmits discovery signal if it is OFF.

In an alternative of this method, the ON/OFF signaling is implied by the bandwidth of the discovery signal, i.e. if the discovery signal of a cell is detected to be X MHz (e.g. 1.4 MHz) by the UE, the cell is assumed by the UE to be OFF; otherwise if the discovery signal of a cell is determined to be Y MHz (e.g. full bandwidth) by the UE, then the cell is assumed by the UE to be ON. This alternative of this method is also applicable if the discovery signal is the CRS.

Specific UE behaviours in DRX and IDLE mode can be specified if the UE is capable of maintaining RRC connection or camping in IDLE mode on a cell that is performing ON/OFF.

For a UE configured with DRX, if it can know about dynamic ON/OFF pattern of a cell, it may help UE reduce unnecessary monitoring for control/data on subframes which are OFF. The signaling for ON/OFF indication can be the same for an active UE. If the UE is not sure about current ON/OFF pattern because DRX sleep time is longer than the time duration for ON/OFF pattern change, the UE regards the ON/OFF pattern obsolete. It then tries to get the new ON/OFF pattern when or immediately after it wakes up.

For a UE in RRC_IDLE, the subframes for paging can be always ON for semi-static or dynamic ON/OFF, then the UE does not need to know the ON/OFF pattern. If the subframes for paging can also be OFF, it may have advantage for a UE to know such when or immediately after it wakes up to monitor paging, so that the UE can avoid monitoring the OFF subframe which is supposed to be for paging.

An Embodiment of this Disclosure Provides an Enhanced Cell Association Method:

Methods to determine the ON/OFF state of a cell can be used to enhance cell association by the UE. Discovery signal SINR (DSSINR) for cell 1 can be constructed by the UE as follows:

$${DSSINR}_{1} = \frac{{DSRSRP}_{1}}{{\sum }_{k ∈ A} {DSRSRP}_{k}} ,$$

where DSRSRPₖ is the RSRP measured based on discovery signal of cell k and A is a set of cells that are determined by the UE to be ON.

The UE can determine the cell association preference by favoring cell with the highest DSSINR. In another example, DSSINR can be compared between cells across different frequency and the UE can determine frequency preference by favoring frequency that contain cell with the highest DSSINR.

The UE can also report DSSINR to a cell or multiple cells.

An Embodiment of this Disclosure Provides a DS RRM Procedure:

As mentioned above, there are potential benefits for a UE to distinguish between ON/OFF states of cells in the corresponding reports based on the DS. Furthermore different priorities may be considered for different cells and RRM configurations. In one example for the purpose of power saving, a UE may not frequently perform DS measurements. With an especially strong cell, faster measurement reporting may be beneficial even for reporting on OFF state cells to activate a fast wake-up procedure in the future if the cell is currently in an OFF state.

Two alternatives for reporting configuration may be considered:

In one alternative a first measurement and/or reporting periodicity and a second measurement and/or reporting periodicity for a DS RRM configuration are respectively associated with cells below and above a preconfigured or RRC configured DS RSRP/RSRQ threshold. For example a UE monitors the DS of cell A with periodicity T1, but switches to periodicity T2 if the RSRP of the DS measurement of cell A rises above a threshold X (e.g. −100 dBm) for N consecutive measurements, where N≧1.

As an illustration, the IE MeasPeriodConfig defined below contains one or more configured periodDuration values which are specific to individual or a subset of cells listed in the measurement object conditioned on the DS RSRP/RSRQ threshold measThresholdDs and measurement counter measCounterDs.

| | |
|---|---|
| MeasPeriodConfig ::=SEQUENCE { | |
| periodDuration | CHOICE { |

| | |
|---|---|
| mp0 | INTEGER (1.. maxPeriodDuration), |
| mp1 | INTEGER (1.. maxPeriodDuration), |
| ... | |
| } | |

| | |
|---|---|
| measThresholdDs | INTEGER (1..maxMeasThreshDs), |
| measCounterDs | INTEGER (1..maxMeasCounterDs), |
| ... | |
| } | |

In another alternative, a first measurement and/or reporting periodicity and a second measurement and/or reporting periodicity for a DS RRM configuration may be associated with a certain ON/OFF state; however specific cells may continue to utilize one measurement and/or reporting configuration regardless of the ON/OFF state. For example, a configured Scell acting as the serving cell may be transitioning between ON and OFF frequently depending on variable traffic load. The UE may be configured with a faster measurement and/or reporting periodicity for the cell when the cell as ON rather than when the cell is in the OFF state. However to reduce potential connection latency and improve measurement accuracy (especially for non-CA UEs) it may be beneficial to configure the UE to monitor the cell with the ON-state periodicity regardless of what state the cell currently is in. Once the UE is no longer configured with the SCell (or SeNB) it may revert to the normal RRM procedure which differentiates reporting periodicity based on cell ON/OFF state.

It can be further noted that the above alternative may be extended to a set of candidate SCells instead of a single “serving” cell.

Another aspect of DS-related RRM procedures regards the differentiation of monitoring procedure depending on whether the UE is RRC Connected or RRC_Idle. In order to optimize fast ON/OFF transition and UE connection setup procedures with reduced latency it may be beneficial for a UE entering RRC_Idle state to continue monitoring the DS with the configuration provided by the network while in a connected state. This may include measurement period indication as well as specific cell IDs/DS patterns for monitoring.

To improve UE power-efficient operation, a separate DS RRM configuration may be applied by the UE in RRC_Idle state. In one example the cell IDs/DS patterns may stay the same but the reporting periodicity is reduced with respect to the configuration applied in RRC_Connected state. Alternatively a different set of cell IDs and/or discovery patterns may be indicated to the UE for RRC_Idle RRM measurement and reporting. For example a UE in idle may be monitoring DS on multiple carrier frequencies which are in fact maintained by the same eNB. In this embodiment, the UE may save power by not monitoring all the DS carrier frequencies and cells but only a subset maintained by the eNB to just allow the UE to determine if it is still in vicinity of the eNB, but not for example the load or ON/OFF situation across the multiple cells, which would be of more interest if the UE is actively sending/receiving traffic.

There is a benefit to define criteria for a UE to determine the validity of a given DS RRM configuration. For example, the DS patterns may correspond to small cells in a cluster within the coverage of a macro eNB and if a UE moves out of the cluster, the configuration is most likely no-longer valid and there is no need for the UE to attempt to detect cells associated with the DS RRM configuration.

Two alternatives for configuration validity criteria may be considered:

In one alternative, criterion for a UE to maintain a DS RRM configuration is associated with a preconfigured or RRC configured DS RSRP/RSRQ threshold. For example, a UE monitors the DS of cell A if the RSRP of the DS measurement of at least on cell in the configuration set is above a threshold X (e.g. −127 dBm) for N consecutive measurements, where N≧1. Otherwise the configuration is released.

In another alternative, criterion for a UE to maintain a DS RRM configuration is associated with a preconfigured or RRC configured DS RSRP/RSRQ threshold of a primary serving cell measurement (e.g. based on macro cell or small cell cluster coordinating cell CRS or DS). For example, the PSS/SSS or DS of the macro/main serving cell quality may be maintained with higher priority and frequency than the PSS/SSS or DS associated with SCells (or candidate Scells). As a result the DS configuration associated with the SCells may be released or suspended upon the primary cell falling below a threshold and is reactivated when the measurement rises above the threshold X (e.g. −127 dBm) for N consecutive measurements, where N≧1. This is beneficial when the small cell cluster is located near the center of a macro eNB's coverage and while at the UE is at the cell edge the DS configuration associated with the small cell cluster does not need to be applied since it is unlikely the UE will have sufficient signal strength to be associated with any of those Scells. However as the UE moves back towards the center of the cell the DS measurements may resume.

As an illustration, the IE MeasPeriodConfig defined below contains one or more configured periodDuration values which are specific to individual or a subset of cells listed in the measurement object (mpCellMapping) as well as an associated primary cell ID (primaryCellID) and threshold (measThresholdPrimaryDs) to determine whether the measurement configuration is currently valid for the UE.

| | |
|---|---|
| MeasPeriodConfig ::=SEQUENCE { | |
| periodDuration | CHOICE { |

| | |
|---|---|
| mp0 | INTEGER (1.. maxPeriodDuration), |
| mp1 | INTEGER (1.. maxPeriodDuration), |
| ... | |
| } | |

| | |
|---|---|
| mpCellMapping | BIT STRING(SIZE (maxCellMeas)) |
| primaryCellID | INTEGER (1..maxCellMeas) |

| | |
|---|---|
| measThresholdPrimaryDs | INTEGER (1..maxMeasThreshPrimaryDs), |
| ... | |
| } | |

Measurement events for discovery signal can be similar to that described in [REF13], where CSI-RS is used as the discovery signal.

An Embodiment of this Disclosure Provides Configuration of SCell Candidates:

In certain scenarios the network may desire to switch the serving SCell (possibly corresponding to different eNBs on the same or different carrier frequency) of a UE frequently. This may be due to UE mobility within a cluster of small cells or due to ongoing ON/OFF adaptation of different eNBs of which the UE is within coverage. As a result, it may be beneficial to provide the necessary configuration information at the UE for one or more Scell candidates in order to reduce RRC signaling overhead and connection latency. An example where configuration of multiple SCell candidates may be beneficial is illustrated below.

In one example, a set of candidate SCells are indicated to the UE via RRC signaling and identified by SCellCandidateIndex. The necessary configuration may be provided by IEs including RadioResourceConfigCommonSCell, RadioResourceConfigDedicatedSCell, and physicalConfigDedicatedSCell [REF8]. However the configurations provided by those IEs are not indexed by SCellIndex and are instead indexed by SCellCandidateIndex:

| | |
|---|---|
| -- ASN1START | |
| SCellCandiateIndex-rX ::= | INTEGER (1..15) |
| -- ASN1STOP | |

Additionally the configurations are provided by the IE SCellCandidateToAddMod may be introduced:

| | |
|---|---|
| SCellCandidateToAddMod-rX ::= | SEQUENCE { |

| | |
|---|---|
| sCellCandidateIndex-rX | SCellCandidateIndex-rX, |

| | |
|---|---|
| cellIdentification-r10 | SEQUENCE { |

| | |
|---|---|
| physCellId-r10 | PhysCellId, |
| dl-CarrierFreq-r10 | ARFCN-ValueEUTRA |

| | |
|---|---|
| } | OPTIONAL, --Cond |

| | |
|---|---|
| SCellAdd | |
| radioResourceConfigCommonSCell-r10 | RadioResourceConfigCommonSCell-r10 |
| OPTIONAL, -- Cond SCellAdd | |

| | |
|---|---|
| radioResourceConfigDedicatedSCell-r10 | RadioResourceConfigDedicatedSCell-r10 |
| OPTIONAL -- Cond SCellAdd2 | |
| ..., | |

| | |
|---|---|
| [[ dl-CarrierFreq-v1090 | ARFCN-ValueEUTRA-v9e0 OPTIONAL -- |
| Cond EARFCN-max | |
| ]] | |
| } | |

Once a UE is configured with candidate SCells, a mapping and activation mechanism is needed to convert a candidate index into an “active” SCell index. For example in the previous embodiments signaling associated with ON/OFF state and/or measurement procedure adaptation potentially include an index D which may correspond to a SCellIndex or ScellCandidateIndex. Additionally, periodic signaling may be provided to a UE to “promote” a ScellCandidateIndex to a SCellIndex:

| | |
|---|---|
| SCellCandidateToAddMod-rX ::= | SEQUENCE { |
| sCellIndex-r10 | SCellIndex-r10, |
| sCellCandidateIndex-rX | SCellCandidateIndex-rX, |
| } | |

Since providing configuration information for multiple candidate SCells may incur increased overhead differential signaling may be introduced to reduce to the total amount of information messages that are needed. A general configuration may be provided which is applied to all or a subset of SCells while additional messages are provided for SCell candidate(s) to set parameters which are different than provided by the general configuration. For example an IE that provides common configuration information for a group of SCell candidates (e.g. called the RadioResourceConfigGeneralSCellCandidate) may provide characteristics like carrier frequency, DL bandwidth, UL bandwidth, and antenna info. The SCell candidate specific configuration information (e.g. called RadioResourceConfigDeltaSCellCandidate) may provide characteristics like TDD configuration, MBSFN subframe configuration, CSI-RS configuration, DS pattern and measurement procedure, and SRS parameters.

An Embodiment of this Disclosure Provides Procedures to Enable Cell ON-OFF:

As mentioned, SeNBs can be turned on or off. In addition, it should be possible to reconfigure/switch SeNB for a UE as a result of SeNBs' ON/OFF decisions.

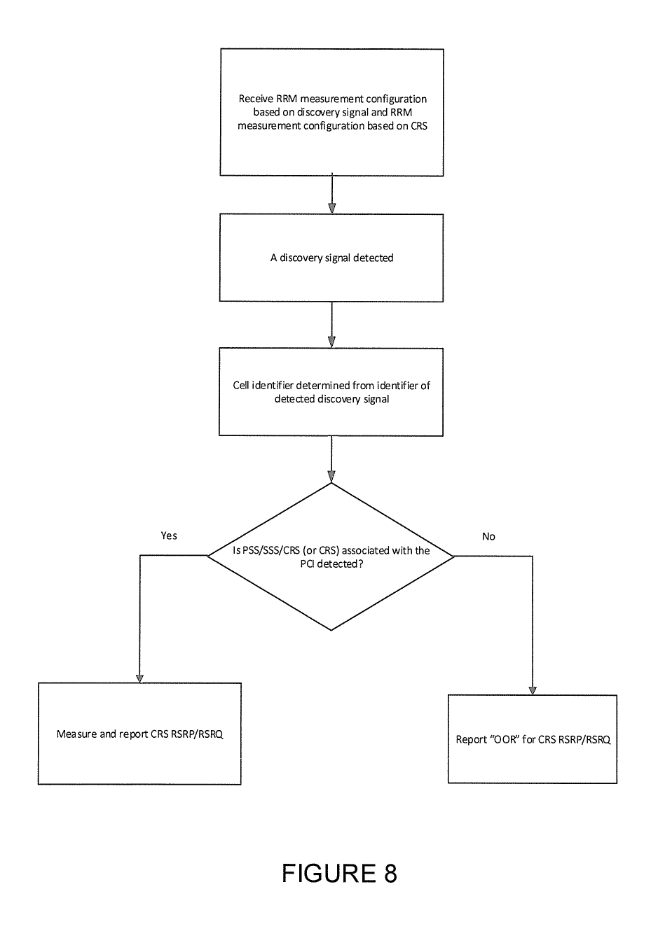

FIGS. 15A-E illustrate an example ON/OFF procedures in accordance with an embodiment of this disclosure.

In FIG. 15A, to connect to a new SeNB, the existing SeNB configuration (if any) is RRC released before the new SeNB is RRC added. SeNB PCell (the SeNB cell with PUCCH defined) is activated by default upon RRC configuration (i.e. SeNB should be ON), to reduce latency. During connection with the SeNB, SeNB can be turned off and on. Before the SeNB is turned off, SeNB is RRC released. After the SeNB is turned on again, SeNB is RRC configured. SeNB PCell can be assumed always activated. It should be noted that in this approach, the SeNB's on/off status should be communicated to the MeNB via the backhaul. The MeNB can also be the entity controlling the on/off decision of SeNB.

In FIG. 15B, to connect to a new SeNB, the existing SeNB configuration (if any) is RRC released before the new SeNB is RRC added. SeNB PCell is activated by default upon RRC configuration (i.e. SeNB should be ON), to reduce latency. During connection with the SeNB, SeNB can be turned off and on. Before the SeNB is turned off, SeNB PCell is deactivated, but may not need to be RRC released. After the SeNB is turned on again, the cell (including SeNB PCell) can be re-activated. If there is uplink data arrival, the UE can transmit scheduling request to the MeNB, indicating the need to turn on the SeNB for uplink data transmission. The scheduling request can be a separate PUCCH format 1 resource to differentiate scheduling request for MeNB itself. If PUCCH resource is not available, PRACH can be transmitted. In a first option, PRACH can be transmitted to the MeNB, e.g. using a dedicated preamble that indicates resource request for the SeNB. In a second option, PRACH can be transmitted by the UE to a preconfigured PRACH resource of SeNB (SeNB is expected to wake up to listen to PRACH in this preconfigured resource). The reference timing for PRACH/PUCCH transmission can be the discovery signal received timing from the SeNB. It should be noted that in this approach, the SeNB's on/off status should be communicated to the MeNB via the backhaul because MeNB is responsible for turning on SeNB. The MeNB can also be the entity controlling the on/off decision of SeNB.

In FIG. 15C, multiple SeNB candidates on the same carrier frequency can be RRC configured to the UE. Only one of the SeNB candidates can be activated at a given time. After a SeNB is turned on, the corresponding cell can be activated. Before a SeNB is turned off, the corresponding cell is deactivated, but need not be RRC released. No RRC reconfiguration is involved in SeNB switching. Resource coordination among multiple SeNBs and MeNB is used. UE behavior when there is UL data arrival can be similar to that described for FIG. 15B. It should be noted that in this approach, the SeNB's on/off status should be communicated to the MeNB via the backhaul because MeNB is responsible for turning on SeNB. The MeNB can also be the entity controlling the on/off decision of SeNB.

In FIG. 15D, it is also possible to provide a new signaling mechanism to manage ON/OFF status of SeNBs without relying on SCell activation/deactivation. An advantage is that ON/OFF decision making of SeNB and the corresponding signaling may not need to involve MeNB, thereby avoiding delay over backhaul. Furthermore, the radio bearer set up for the small cell can be maintained even when the cell is off. The RRC configuration for the small cell also need not be changed. FIG. 15D shows an example flowchart of cell on/off procedure using on/off signalling from the cell performing on/off. The ON/OFF signalling indicated in the figure can be according to the method of ON/OFF signalling as described before or it can be determined by the UE according to an embodiment of this disclosure as shown above, whereby the ON/OFF signalling essentially originates from the SeNB. ON/OFF signalling originating from another cell or MeNB is also possible with the different methods of ON/OFF signalling as described above. Random access procedure to achieve UL synchronization may not need to be performed for the time scale of on/off is short and if the same UL timing used for previous ON period can still be applied for the new ON period. If there is uplink data arrival, the UE can transmit scheduling request to the SeNB. The scheduling request can be a preconfigured PUCCH format 1 resource (SeNB is expected to wake up to listen to PUCCH in this preconfigured resource). If PUCCH resource is not available or configured, PRACH can be transmitted to the SeNB using a preconfigured PRACH resource of SeNB (SeNB is expected to wake up to listen to PRACH in this preconfigured resource). The preconfigured PRACH resource of SeNB can be either the same resource as that when the SeNB is on or it can be a separate one; an advantage of the latter is that the PRACH resource for the off state can be more infrequent to allow more power saving for the SeNB. The reference timing for PRACH/PUCCH transmission can be the discovery signal received timing from the SeNB. The pathloss estimation for uplink power control can be based on estimate from the discovery signal. When the ON/OFF signaling is directly from the MeNB, PRACH/PUCCH for scheduling request can be transmitted to the MeNB, e.g. using a dedicated preamble or separate PUCCH format 1 resource, respectively, that indicates resource request for the SeNB.

In one embodiment, the procedures from FIGS. 15C and 15D can be combined in a following way:
ON signaling of FIG. 15D is also interpreted as cell activation and is sent from the small cell that is turned on.
OFF state can be indicated using MAC deactivation control element of FIG. 15C and is sent from the small cell that is to be turned off. OFF signaling of FIG. 15D can also be used in addition, in this embodiment, OFF signaling can also be interpreted as cell deactivation.

In FIG. 15E, a handover procedure can be used by the network for operating small cell on/off. UEs can be handed over to, or from, a cell that is just turned on, or about to be turned off, respectively.

An Embodiment of this Disclosure Provides DL Signaling for Adapting ON/OFF of a Cell:

Higher-layer signaling, using (for example) an information element ConfigureONOFF-Adapt, can inform a UE of a periodicity for an adaptation of ON/OFF (number of TTIs for assuming ON/OFF configuration as valid) and a configuration of a UE-common DL signaling informing of an adaptation of ON/OFF configuration. For brevity, this UE-common DL control signaling (PDCCH) is referred to as ONOFF-Adapt. The configuration of ONOFF-Adapt can include a DCI format conveyed by ONOFF-Adapt (if it is not uniquely determined by the specification of the ON/OFF adaptation operation) and an ONOFF-RNTI used to scramble the CRC of the DCI format.

With UE-common control signaling (for all UEs or for a group of UEs), a configuration of ONOFF-Adapt can also optionally include a configuration of a PUCCH resource for a UE to transmit HARQ-ACK information (DTX or ACK) regarding a detection of ONOFF-Adapt. For example, a PUCCH transmission can be in a first possible fixed UL TTI after a DL TTI of ONOFF-Adapt transmission. The transmission of HARQ-ACK information may not be in response to a reception of a data TB, but rather it is in response to an actual or missed detection of ONOFF-Adapt.

A periodicity for an ON/OFF configuration in a number of TTIs can also be expressed in a number of frames where, for example, a frame includes 10 TTIs and a periodicity is defined relative to a System Frame Number (SFN). For example, for a periodicity of an adaptation for an ON/OFF configuration of 40 TTIs or 4 frames, an adaptation can occur at frame 0, frame 4, frame 8, and so on (unless an effective timing is also applied as further discussed below).

In an approach, ConfigureONOFF-Adapt also configures to a UE a transmission of UE-common or UE-group-common DL signaling for adapting an ON/OFF configuration (ONOFF-Adapt) by providing one or more of the following parameters:
A periodicity of ONOFF-Adapt that can be defined as a number of TTIs or frames between successive transmissions of ONOFF-Adapt.
A number of transmissions for ONOFF-Adapt within one period (number of TTIs) of an ONOFF configuration. For example, within a period of a 40 TTIs where an ONOFF configuration remains the same, ONOFF-Adapt can be transmitted one time at a 31st TTI, two times at a 21st TTI and a 31st TTI, and so on.
A resource allocation for an ONOFF-Adapt transmission including a number and location of CCEs in a UE-CSS. For example, the ONOFF-Adapt can be transmitted using the first 8 CCEs (in a logical domain prior to interleaving) of a UE-CSS.
A type of DCI format used to transmit ONOFF-Adapt, such as a DCI format with size equal to DCI format 1C or to DCI format 3/3A/0/1A.
An effective timing of new ON/OFF configuration.
An ONOFF-RNTI used to scramble the CRC of a respective DCI format conveyed by the ONOFF-Adapt control signaling.
A length of an information field to indicate adapted ON/OFF configuration in a DCI format Throughout this disclosure, unless otherwise explicitly mentioned, a DCI format for transmitting ONOFF-Adapt and having a size equal to DCI format 1C or either of DCI formats 3/3A/0/1A is respectively referred to for brevity as DCI format 1C or DCI format 3/3A/0/1A. It should be understood that this is not a respective conventional DCI format 1C or any of the conventional DCI formats 3/3A/0/1A.

Some of the above parameters can be defined in a system operation and need not be included in a ConfigureONOFF-Adapt information element. For example, a DCI format with a size equal to DCI format 1C and with CRC scrambled with an ONOFF-RNTI can be a default choice for transmitting ONOFF-Adapt. As another example, as previously discussed, a UE can be configured to monitor a DCI format with a size equal to either DCI format 1C or DCI format 3/3A/0/1A. As yet another example, a UE can decode in every applicable DL TTI both DCI formats with a size equal to DCI format 1C and DCI format 3/3A/0/1A and select one having a successful CRC check, assuming the CRC is scrambled with a configured ONOFF-RNTI. An effective timing of an adapted ON/OFF configuration can be predefined to be the first TTI after a number of TTIs where an ON/OFF configuration is same, or an effective timing of an adapted ON/OFF configuration can also be provided by ONOFF-Adapt and can be for a current period of ONOFF-Adapt or for a next period of ONOFF-Adapt as it is subsequently described. A number of transmissions for ONOFF-Adapt can always be one or be undefined, and the UE can decode a respective DCI format in every applicable DL TTI. Also, a resource allocation for an ONOFF-Adapt transmission may not be defined, and a UE can perform a conventional decoding process to detect ONOFF-Adapt.

A starting DL TTI for ONOFF-Adapt can be implicitly determined by a UE from the periodicity of ONOFF-Adapt transmissions and from the number of ONOFF-Adapt transmissions. For example, for a periodicity of P frames and a number of ONOFF-Adapt transmissions N, a starting DL TTI can be determined as the first TTI in the P-N frame (where P frames are indexed as 0, 1, . . . , P−1). Alternatively, a starting DL TTI for an ONOFF-Adapt transmission may not be defined, and a UE can attempt detection of a respective DCI format with CRC scrambled with a UE-configured ONOFF-RNTI in any DL TTI.

As an extension of the approach above, a number of TTIs between two consecutive transmissions of ONOFF-Adapt for the same adaptation of an ON/OFF configuration can be signaled in ConfigureONOFF-Adapt to a UE and is denoted as B. The number B can be 0, 5, or 10, or other multiples of 5 and can be signaled or specified. When B=0, if there are multiple PDCCH transmissions, they can all in one TTI. If B>0, a starting TTI for the ONOFF-Adapt transmissions can be determined as the TTI index within a period: (10*P−B*N)+F, where the TTIs are indexed within a period as 1, 2, . . . , 10*P, and F can be 1 or 2 (for example). For instance, within a period of a 40 TTIs where an ON/OFF configuration remains the same, ONOFF-Adapt can be transmitted two times at a 31st TTI and a 36th TTI (with P=4, N=2, B=5, F=1), two times at a 21st TTI and a 31st TTI (with P=4, N=2, B=10, F=1), and so on. As a further extension, a starting TTI for the ONOFF-Adapt transmissions can be determined as the TTI index within a period: (10*P−B*N)+F-T, where T can be an offset relative to the last TTI of the period of adaptation, and T can be multiples of 5. When B=0, T could be a number no less than 5.

In another approach, a starting DL TTI for an ONOFF-Adapt transmission and a number of respective repetitions can be explicitly specified. For example, for a given periodicity of an adaptation of an ON/OFF configuration, a starting DL TTI can be a first TTI in a last frame of an ON/OFF configuration before adaptation and, when there are repetitions, they can be in a second TTI, a sixth TTI, or a seventh TTI of a last frame. Therefore, for a periodicity of 40 TTIs, a starting DL TTI for the ONOFF-Adapt transmission can be the first TTI in the fourth frame (31st TTI) and, if repetitions are also specified, they can occur at either the 32nd TTI, the 36th TTI, or the 37th TTI. For example, a starting DL TTI can be a first DL TTI of an ON/OFF configuration before adaptation.

In another approach, all TTIs of an ONOFF-Adapt transmission can be explicitly signaled by ConfigureONOFF-Adapt. For example, consider only TTIs indicated as having a DL direction in a SIB1 signaled TDD UL-DL configuration (as subsequently described) and consider that there is a maximum of four such TTIs common to all ON/OFF configurations (first/second/sixth/seventh DL TTIs as in Table 1 if TDD UL-DL configuration 0 is included) or five such TTIs common to all ON/OFF configurations excluding TDD UL-DL configuration 0. In this embodiment, for a periodicity of P frames, a bitmap of 10P/4 or 10P/5 bits, respectively, can indicate the DL TTIs where ONOFF-Adapt is transmitted in each period of P frames.

In another approach, the same ONOFF-Adapt can be transmitted in the same DL TTI more than once. For example, a first transmission can be done using a first eight CCEs in a UE-CSS, and a second transmission can be done using a second eight CCEs in the same UE-CSS. The DL TTI can be determined as in any of the previous three approaches.

In another approach, an ONOFF-Adapt can be transmitted in any DL TTI of a current ON/OFF configuration (indicated by SIB1). A UE detecting an ONOFF-Adapt assumes a respective signaled ON/OFF configuration applies as determined by the configured periodicity for an adaptation of an ON/OFF configuration.

An effective timing of an adapted ON/OFF configuration can also be a timer with a value indicating an additional number of TTIs after which an adaptation of an ON/OFF configuration becomes effective. In that sense, an effective timing for an adapted ON/OFF configuration is an offset relative to a higher layer configured periodicity of an adaptation for an ON/OFF configuration. The effective timing can also be implicitly determined based on a DL TTI a UE detects an ONOFF-Adapt. For example, if the DL TTI is the first DL TTI in a period of P frames, ONOFF-Adapt is applicable for the same period of P frames; otherwise, it is applicable for a next period of P frames.

ConfigureONOFF-Adapt may include a configuration of information field to indicate adapted ON/OFF configuration in a DCI format. Such configuration can indicate one configuration out of a set of possible configurations. For example, there can be three possible configurations for an information field to indicate adapted ON/OFF configuration in a DCI format. A first configuration can be that ON/OFF configuration is indicated by a bitmap of length equal to a number of ON/OFF eligible DL subframes in a periodicity of ONOFF-adapt. This may be further conditioned on whether this number is not larger than a predefined threshold. A second configuration can be that ON/OFF configuration is a bitmap with size 1, where the single bit indicates ON/OFF status of one period, for example, ON is indicated by value ‘0’ and OFF is indicated by value ‘1’. A third configuration can be that ON/OFF configuration is an indication, with size of ceiling(log 2M), to indicate up to M ON/OFF patterns, where M can be a predefined value and function ceiling(x) is of a least integer value greater than or equal to x. If configurations for an information field to indicate adapted ON/OFF configuration in a DCI format is predefined, it does not need to be included in ConfigureONOFF-Adapt.

After a UE receives a higher-layer signaling for an information element ConfigureONOFF-Adapt, the UE can decode ONOFF-Adapt. If multiple transmissions of ONOFF-Adapt exist within a period of an adaptation of an ON/OFF configuration and a first detection of ONOFF-Adapt fails, a UE can choose to perform soft combining among all respective received ONOFF-Adapt if they are transmitted in resources already informed to the UE from ConfigureONOFF-Adapt. For example, ConfigureONOFF-Adapt can inform a UE of a 40 TTIs periodicity for an ON/OFF configuration, of a twenty-first TTI in the 40 TTIs for an initial transmission of an ONOFF-Adapt, and of a 10 msec transmission periodicity for the PDCCH of ONOFF-Adapt. Assuming use of predetermined CCEs for each such ONOFF-Adapt transmission, a UE that does not detect the ONOFF-Adapt in the twenty-first TTI can perform soft combining of that ONOFF-Adapt with the same ONOFF-Adapt in the thirty-first TTI before attempting another detection. Alternatively, if a UE detects multiple ONOFF-Adapt in the same adaptation period of an ON/OFF configuration, the UE can consider as valid only the last ONOFF-Adapt (if respective contents of the multiple ONOFF-Adapt are different).

Table 11 lists a set of example parameters included in a ConfigureONOFF-Adapt information element.

TABLE 11
Example parameters for a Configure ONOFF-Adapt information element

| | Size | |
|---|---|---|
| | (bits) | Information |
| Periodicity of ONOFF-Adapt | 2 | ‘00’: 10 TTIs, starting with a frame with SystemFrameNumber |
| | | mod 10 = 0 |
| | | ‘01’: 20 TTIs, starting with a frame with SystemFrameNumber |
| | | mod 20 = 0 |
| | | ‘10’: 40 TTIs, starting with a frame with SystemFrameNumber |
| | | mod 40 = 0 |
| | | ‘11’: reserved |
| Number of transmissions of | 2 | ‘00’: 1 |
| ONOFF-Adapt | | ‘01’: 2 |
| | | ‘10’: 4 |
| | | ‘11’: 8 |
| CCEs for PDCCH conveying | 1 | ‘0’: First 4 CCEs in UE-common search space |
| DCI format for ONOFF- | | ‘1’: First 8 CCEs in UE-common search space |
| Adapt | | |
| Timer for effective timing of | 2 | ‘00’: timer value 0 |
| new ON/OFF configuration | | ‘01’: timer value is 5 TTIs |
| | | ‘10’: timer value is 10 TTIs |
| | | ‘11’: timer value is 15 TTIs |
| Configuration of information | 2 | ‘00’: bitmap of length of number of ON/OFF eligible DL |
| field to indicate adapted | | subframes in a periodicity of ONOFF-adapt if such number of no |
| ON/OFF configuration in a | | greater than a predefined threshold |
| DCI format | | ‘01’: bitmap with size 1, where the bit indicates ON/OFF status of |
| | | one period |
| | | ‘10’: indication with size of ceiling (log₂M), to indicate up to M |
| | | ON/OFF patterns, where M can be a predefined value |
| | | ‘11’: reserved |

As previously mentioned, it is also possible for the ConfigureONOFF-Adapt information element to include only a subset of the parameters in Table 11, such as only the “Periodicity of ONOFF-Adapt” parameter (which is equivalent to a periodicity of an adaptation for an ON/OFF configuration), or additionally of DL TTIs for ONOFF-Adapt transmission. In that embodiment, a UE can decode an ONOFF-Adapt in every DL TTI of an adaptation period or at one or more of the DL TTIs informed by ConfigureONOFF-Adapt (assuming that a respective DCI format can have a size of DCI format 1C or DCI format 0/1A/3/3A and is transmitted in a CSS) and determine an effective timing for a new ON/OFF configuration based on a DL TTI where the DCI format is detected.

For a UE configured with CA operation in a set of cells and for adaptive ON/OFF configuration in a subset of the set of cells, the signaling (for example, a DCI format) that conveys an ON/OFF configuration adaptation information can be for one or multiple cells. In this disclosure, the term “ONOFF-Cell” refers only to a cell where a UE is configured operation with an adaptive ON/OFF configuration (in addition to being configured CA operation). Some information fields in Table 11 can be for each ONOFF-Cell if different ONOFF-Cells may have different configurations.

Information fields in signaling (for example, a DCI format) conveying an ON/OFF configuration adaptation can include at least one of:
An adapted ON/OFF configuration indicating a new ON/OFF configuration, for each respective ONOFF-Cell
Effective timing of adapted ON/OFF configuration, which can be for each ONOFF-Cell. This field can be optional.

Table 12 lists indicative example information fields in a DCI format conveying ON/OFF configuration adaptation.

TABLE 12
Information fields in a DCI format adapting an ON/OFF configuration

| | Size (bits) | Information |
|---|---|---|
| ON/OFF configuration | Zᵢ for each | Adapted ON/OFF configuration for |
| of ONOFF-Cells | cell i | each ON/OFF-Cell |

The ON/OFF configuration of ONOFF-Cell in Table 12 can depend on the configuration of information field to indicate adapted ON/OFF configuration in a DCI format as indicated in Table 11. For example, ON/OFF configuration can be a bitmap of a length equal to a number of ON/OFF eligible DL subframes in a periodicity of ONOFF-adapt. Alternatively, ON/OFF configuration can be a bitmap with the size of a single bit, where the bit indicates ON/OFF status of one period, such as ON is indicated by value ‘0’ and OFF is indicated by value ‘1’. Alternatively, ON/OFF configuration can be an indication to indicate an ON/OFF pattern.

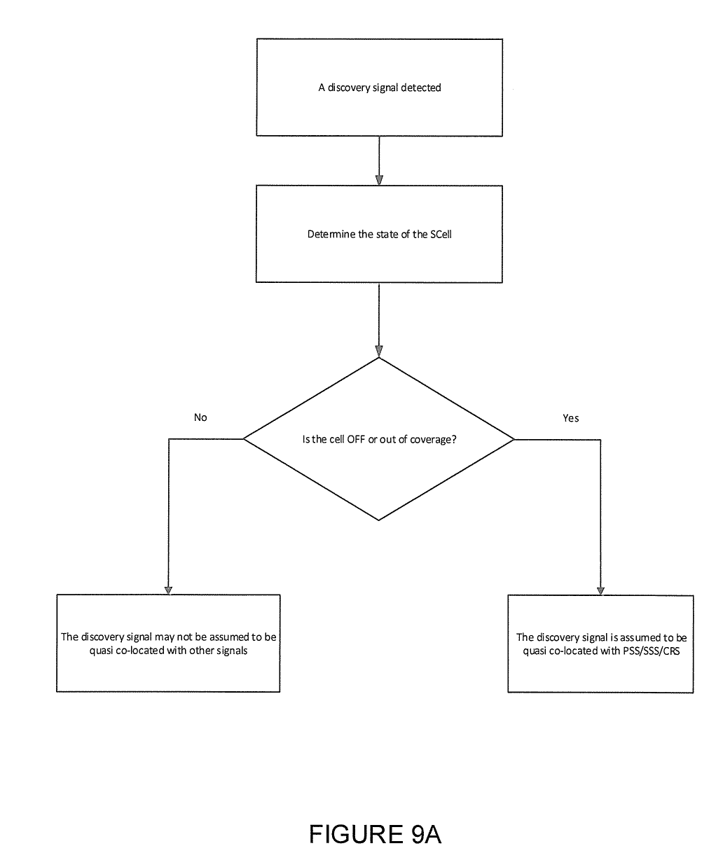

FIG. 16 illustrates a configuration for transmitting ONOFF-Adapt and an effective timing for an adapted ON/OFF configuration in accordance with an embodiment of this disclosure.

Referring to FIG. 16, a periodicity for an ON/OFF configuration is 10 TTIs, starting at the beginning of each frame. An ONOFF-Adapt is transmitted one time at the 1st TTI (TTI #0) in a period of 10 TTIs. An adapted ON/OFF configuration is effective immediately after the first TTI in a period of 10 TTIs. The field in the DCI format can be a bitmap with a length of nine bits (for FDD systems, while the bitmap length can be counted according to the DL subframes for TDD systems), with each bit indicating an ON or OFF status in a respective TTI from TTI#1 to TTI#9 in the period of 10 TTIs.

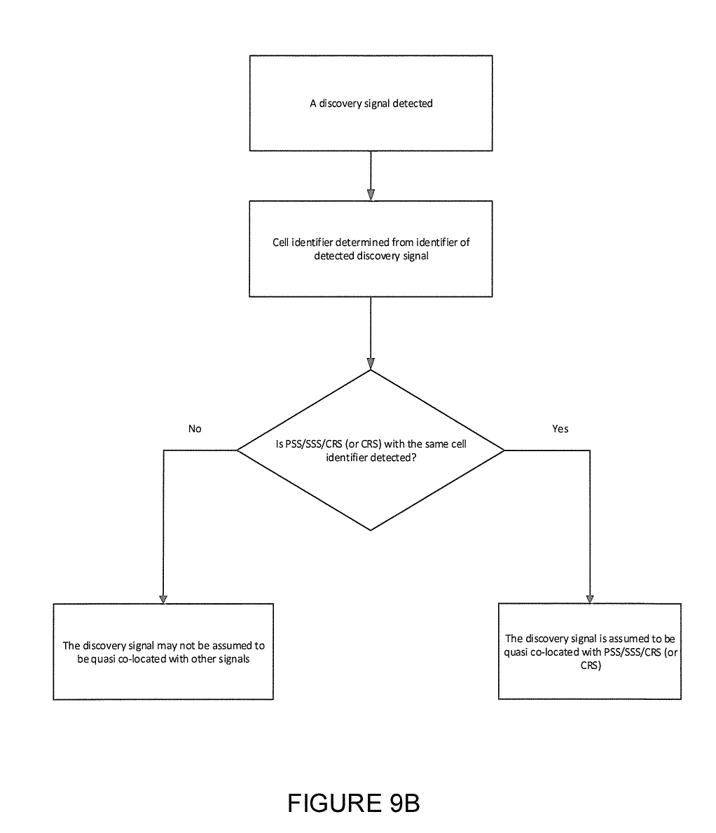

FIG. 17 illustrates a configuration for transmitting ONOFF-Adapt and an effective timing for an adapted ON/OFF configuration in accordance with an embodiment of this disclosure.

Referring to FIG. 17, a periodicity for an ON/OFF configuration is 10 TTIs, from SF#5 to SF#4 in next frame. An ONOFF-Adapt is transmitted two times in a period of 10 TTIs, where the first transmission is on SF#5 and the second transmission is on SF#0. An adapted ON/OFF configuration is effective right after the second transmission of the ONOFF-Adapt.

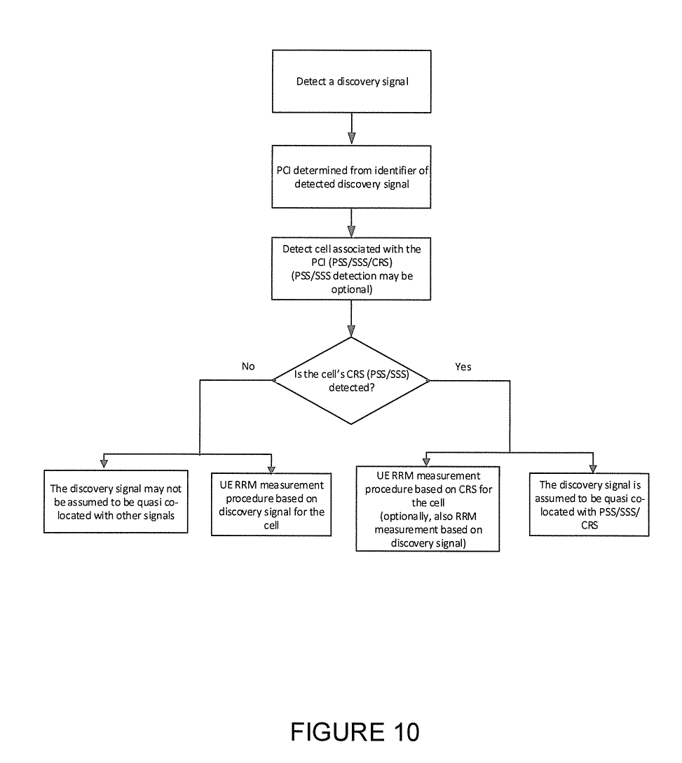

FIG. 18 illustrates a configuration for transmitting ONOFF-Adapt and an effective timing for an adapted ON/OFF configuration in accordance with an embodiment of this disclosure.

Referring to FIG. 18, a periodicity for an ON/OFF configuration is 10 TTIs, starting at the beginning of each frame. An ONOFF-Adapt is transmitted two times in a period of 10 TTIs, where the first transmission is on SF#8 and the second transmission is on SF#9. An adapted ON/OFF configuration is effective on SF#0 after the second transmission of the ONOFF-Adapt.

Although in FIGS. 16-18, the periodicity is 10 TTIs, as it was previously described, the periodicity may be different in other embodiments of this disclosure.

It is noted that the aforementioned aspects for a PDCCH signaling can be extended to other signaling, such as RRC signaling, MAC signaling, and the like. Unlike PDCCH signaling, when the ON/OFF configuration or adaptation is indicated by RRC signaling or MAC signaling, a timing for such signaling may not need to be predefined or may not need to be transmitted according to a predefined periodicity, and the current ON/OFF configuration can be effective until a next adapted ON/OFF configuration or reconfiguration is signaled.

As previously described, an ON/OFF configuration can be, for example, a bitmap of length of number of ON/OFF eligible DL subframes in a periodicity of ONOFF-adapt, bitmap with size 1 where the bit indicates ON/OFF status of one period, or an indication of one of predefined ON/OFF patterns. The ON/OFF configuration can be included in other signaling, such as RRC signaling, MAC signaling, and the like.

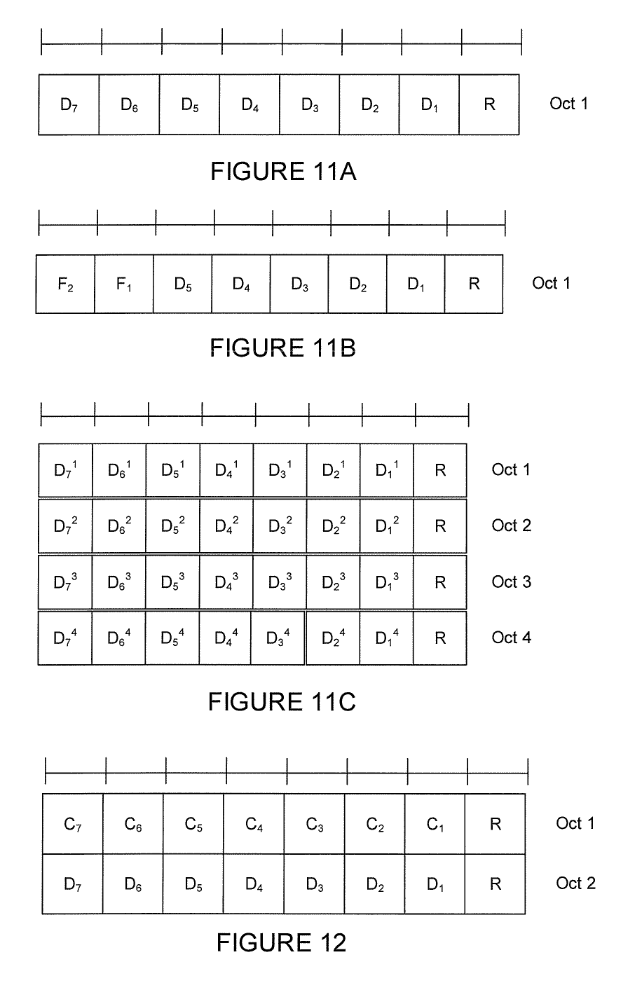

FIG. 19 illustrates an example for signaling of an adapted ON/OFF configuration in accordance with an embodiment of this disclosure. The signaling can be for example, L1 signaling, RRC signaling or MAC signaling.

Referring to FIG. 19, possible transition points for ON/OFF are defined (for example, by a signaling similar to ConfigureONOFF-Adapt), such as 1910, 1920, 1930, and 1940. At each transition point, an adapted ON/OFF configuration, which can be a 1-bit indication indicating ON/OFF status until the next transition point is signaled. For example, at transition points 1910, 1920, 1930, 1940, ON/OFF configuration ON 1915, ON 1925, OFF 1935, ON 1945 are signaled, respectively.

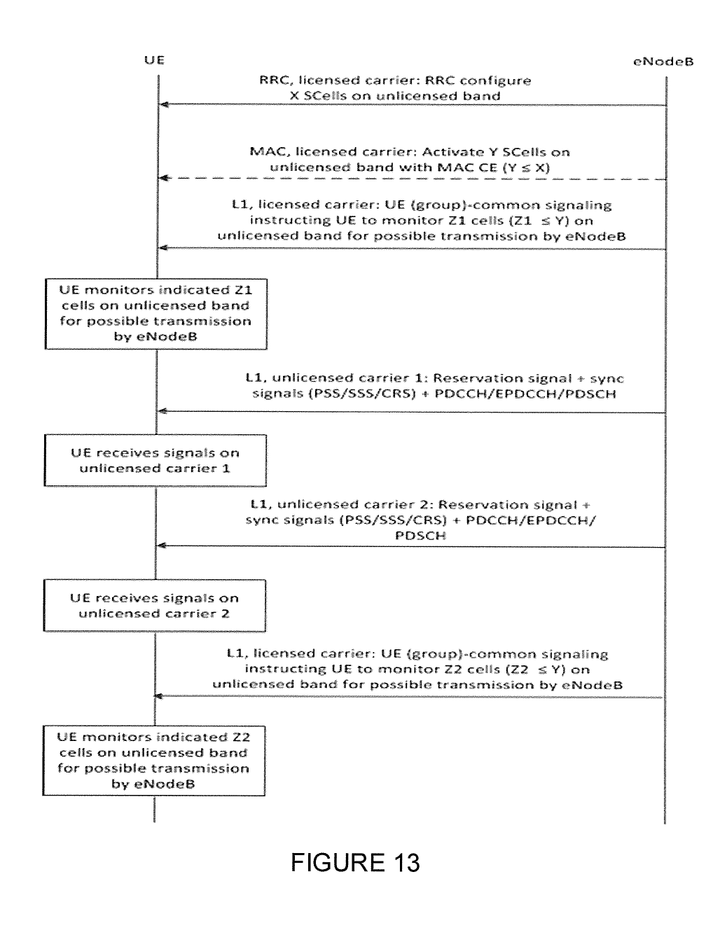

FIG. 20 illustrates an example for signaling of an adapted ON/OFF configuration in accordance with an embodiment of this disclosure. The signaling can be for example, L1 signaling, RRC signaling, or MAC signaling.

Referring to FIG. 20, transition points for ON/OFF are 2010, 2020, 2030, and 2040. At each transition point, an adapted ON/OFF configuration, which can be an indication indicating ON/OFF pattern until the next transition point is signaled. For example, at transition points 2010, 2020, 2030, 2040, ON/OFF configuration of indicated ON/OFF pattern 2015, 2025, 2035, 2045 are signaled, respectively. It is noted that the duration of ON/OFF pattern 2015, 2025, 2035, 2045 may not need to be the same.

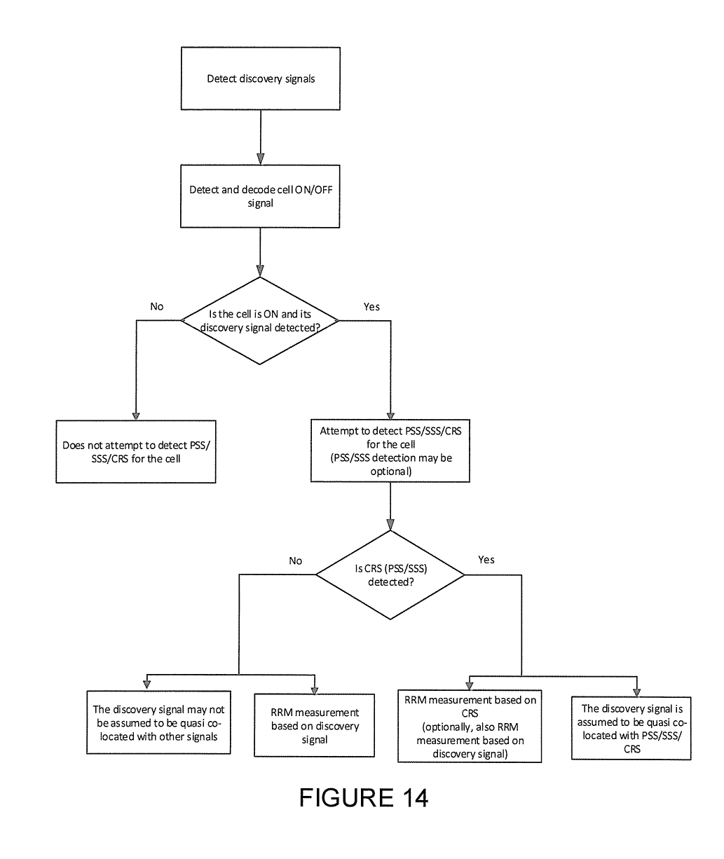

FIG. 21 illustrates an example for signaling of an adapted ON/OFF configuration in accordance with an embodiment of this disclosure. The signaling can be for example, L1 signaling, RRC signaling, or MAC signaling.

Referring to FIG. 21, transition points for ON/OFF are at 2120 and 2140. Prior to each transition point, an adapted ON/OFF configuration, which can be an indication indicating ON/OFF pattern effective starting from the first next transition point until the second next transition point is signaled, and the subframe in which such signaling for adapted ON/OFF configuration is transmitted can be also defined (for example, by a signaling similar to ConfigureONOFF-Adapt), and such subframe can be made ON. For example, prior to transition point 2120, ON/OFF configuration of indicated ON/OFF pattern 2115 is signaled. The signaling for adaption of ON/OFF configuration 2110 can be transmitted in a subframe that can be ON as indicated in ON/OFF pattern 2105. The duration of the ON/OFF pattern 2105 and the duration of the ON/OFF pattern 2115 can be different or same.

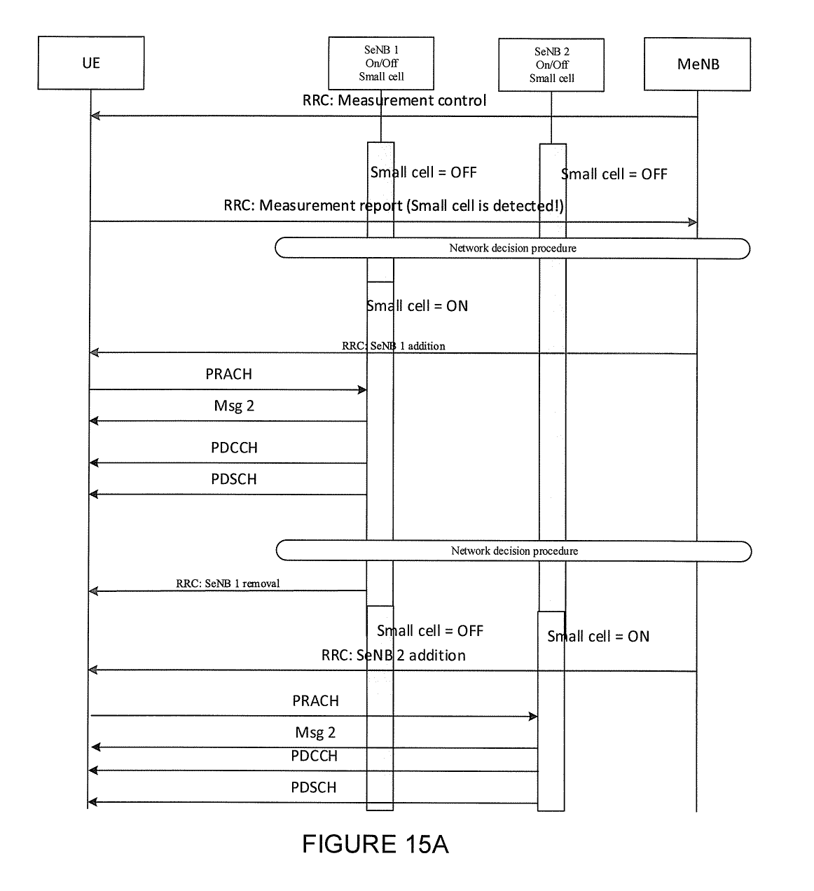

FIG. 22 illustrates example UE operations to acquire ONOFF-Adapt in accordance with an embodiment of this disclosure.

Referring to FIG. 22, a UE receives higher-layer signaling ConfigureONOFF-Adapt. The UE determines the timing (TTIs) and resources (CCEs) for monitoring the transmission of ONOFF-Adapt, such as based on the received higher-layer signaling or based on the DL SF of an ONOFF-Adapt. The UE receives the transmissions of ONOFF-Adapt at determined timing and resources. For example, determined resources can be predefined and UE-common or can depend on a respective DL SF and be UE-specific (for example, determined from a C-RNTI configured to a UE).

Depending on whether a subframe is OFF or ON or a set of subframes is OFF or ON, a UE can operate differently. For example, if a UE knows a subframe is OFF, it can skip monitoring PDCCH or performing CRS-based measurements, but it may receive discovery signal if any and if necessary. If a UE knows a subframe is ON, it can have a regular operation, including a DRX if the subframe is configured as a DRX one. If a UE knows a set of subframes are OFF, the UE may need to apply an algorithm or mapping to determine a rescheduled subframe for certain DL signaling that is scheduled to be transmitted in one or more subframe(s) that are configured as OFF subframes.

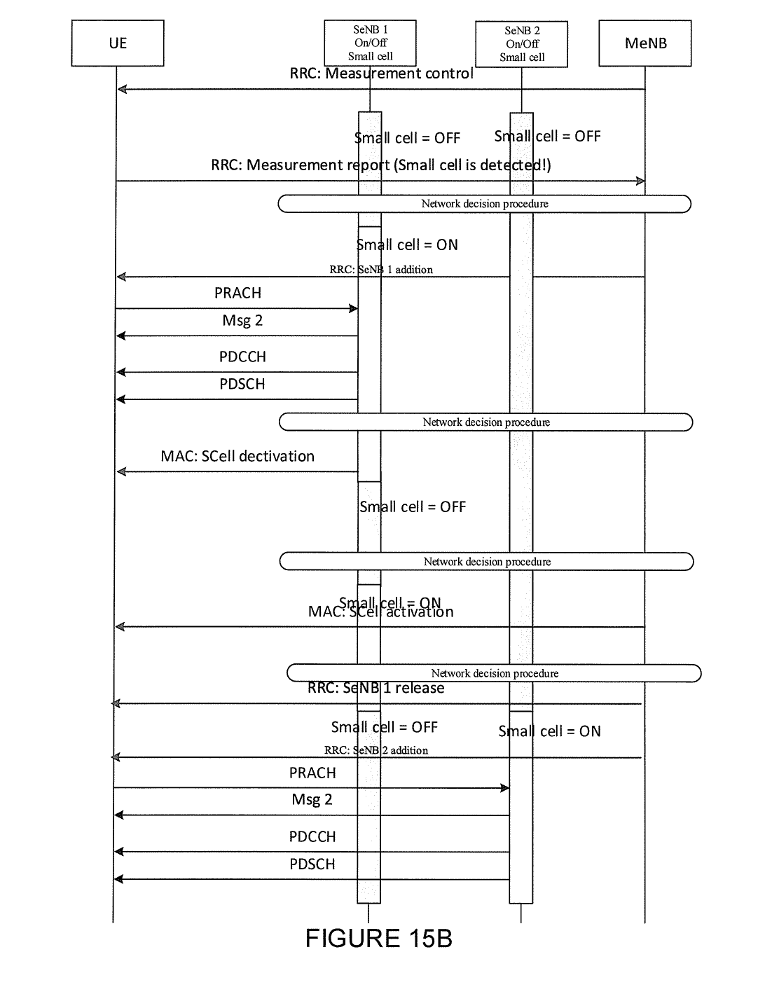

FIG. 23 illustrates example UE operations according to the knowledge ON/OFF state in accordance with an embodiment of this disclosure.

Referring to FIG. 23, a UE determines a new ON/OFF configuration of a cell 2310. Depending on whether a subframe is OFF or ON or a set of subframes is OFF or ON 2320, a UE can operate differently. For example, if a UE knows a subframe is OFF, it can skip monitoring the subframe 2330, but it may receive discovery signal if any and if necessary. If a UE knows a subframe is ON, it can have regular operation 2340.

A UE can be activated or deactivated with an adaptation of an ON/OFF configuration in a UE-specific manner by higher-layer signaling. For example, a UE that has no data to transmit or receive can be deactivated by an adaptation of an ON/OFF configuration and go in a “sleep” mode (also referred to as DRX, such as when a UE is in the RRC_IDLE mode or DRX in RRC_CONNECTED mode).

Instead of a UE-specific configuration, an eNB can indicate whether it applies an adaptation of an ON/OFF configuration of subframes by transmitting a respective indication (such as by using 1 bit) in a broadcast channel conveying system information. For example, this broadcast channel can be a primary broadcast channel a UE detects after synchronizing to an eNB or a channel providing a system information block associated with communication parameters a UE needs to know in order to continue communicating with an eNB. It is noted that only UEs capable of supporting an adaptation of an ON/OFF configuration may be able to identify this indication (the one additional bit).

A paging signal can also be sent to a UE to indicate that there is an adaptation of an ON/OFF configuration. A UE receiving such a paging signal can begin to monitor the PDCCHs conveying a DCI format providing ONOFF-Adapt.

An Embodiment of this Disclosure Provides DCI Format Detection:

A UE-common DCI format for providing block information elements for adapting an ON/OFF configuration (referred to as ONOFF-Adapt) can be, for example, either DCI format 1C or DCI format 0/1A/3/3A. A CRC field included in the DCI format can be scrambled with a new RNTI type, ONOFF-RNTI, which can be used to indicate to a UE that the DCI format provides an adaptation of an ON/OFF configuration and is not intended for a respective conventional functionality. The use of an ONOFF-RNTI also prevents UEs not capable of operating with an adapted ON/OFF configuration from detecting the DCI format (as they are assumed to not descramble the CRC field of the DCI format using the ONOFF-RNTI and therefore they are not able to detect the DCI format).

DCI format 1C can be the smallest DCI format decoded by a UE, and it can be transmitted in a CSS with one of the largest CCE aggregation levels (4 or 8 CCEs) and therefore can have a highest detection reliability. Therefore, DCI format 1C can be appropriate to also convey an adaptation of an ON/OFF configuration through the information fields in Table 12. When a DCI format with a size equal to DCI format 1C conveys an adaptation of an ON/OFF configuration, by scrambling a CRC with an ONOFF-RNTI, the DCI format conveys the information elements in Table 12 and the remaining bits, if any, can be set to a predetermined value (such as ‘0’), which can be exploited by a UE to further reduce a probability of an inappropriate DCI format detection due to a false CRC check. The same functionality applies when a DCI format with a size equal to DCI format 0/1A/3/3A is used to convey an adaptation of an ON/OFF configuration. DCI format 0/1A/3/3A has a larger size than DCI format 1C and therefore can convey more information related to an adaptation of an ON/OFF configuration but at a cost of somewhat reduced reliability or higher control overhead. DCI format 0/1A has the same size as DCI format 3/3A and can be transmitted either in a CSS or in a UE-DSS.

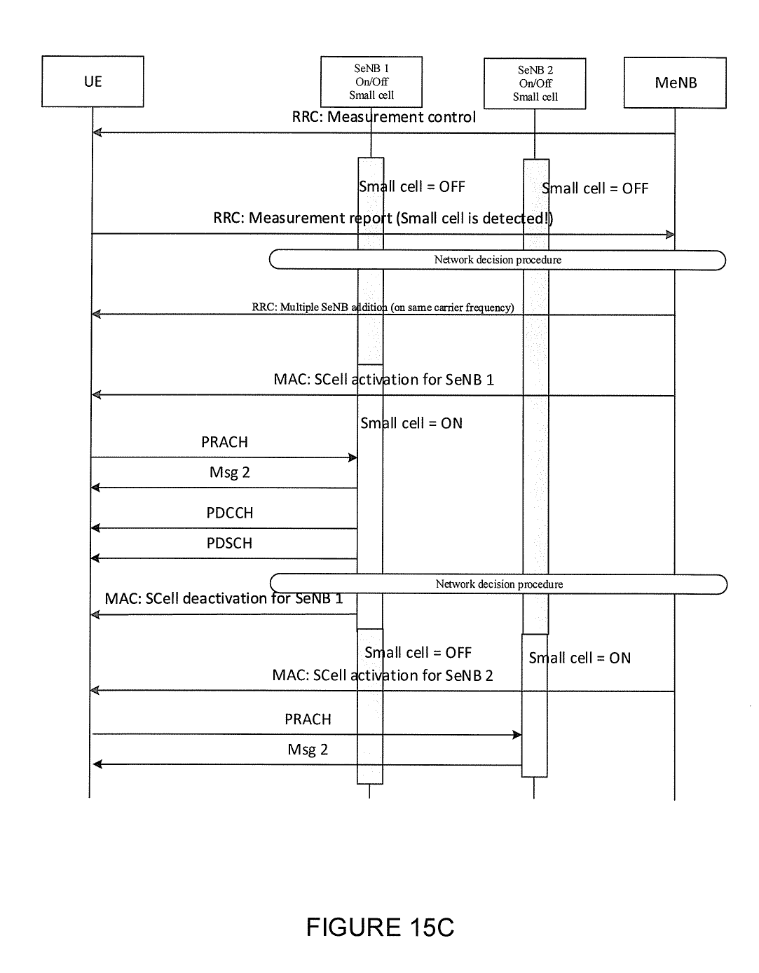

FIG. 24 illustrates operations at the UE for detecting a DCI format providing an adaptation of an ON/OFF configuration in accordance with an embodiment of this disclosure.

Referring to FIG. 24, a received control signal 2405 is demodulated, and the resulting bits are de-interleaved at operation 2410. A rate matching applied at an eNB transmitter is restored through operation 2415, and data is decoded at operation 2425 after being combined 2420 with soft values of previous receptions of control signals conveying the same information as it was previously described. If there is only one transmission, if ONOFF-Adapt is not transmitted at predetermined CCEs, or if a UE detects a previous ONOFF-Adapt transmission, the soft combining 2420 can be omitted, and in general it can be a UE receiver implementation choice. DCI format information bits 2435 and CRC bits 2440 are separated 2430, and CRC bits are de-masked 2445 by applying an XOR operation with an ONOFF-RNTI 2450. Further, a UE performs a CRC test 2455. The UE determines 2460 whether it passes the CRC test. If the CRC test does not pass, a UE disregards 2465 the presumed DCI format 2435. If the CRC test passes, a UE determines 2475 whether the presumed DCI format is valid. For example, if in the DCI format some of the bits are predefined as ‘0’ but in the presumed DCI format 2435 some of these bits are not ‘0’, the UE determines the presumed DCI format 2435 is not valid.

If all these bits are ‘0’ (the same as the predefined value), the UE determines the presumed DCI format 2435 is valid. If a UE determines the presumed DCI format 2435 corresponding to the received control signal 2405 to be valid, the UE determines 2480 new ON/OFF configuration. If the UE is configured a PUCCH resource for transmitting HARQ-ACK information (DTX or ACK) regarding a detection of ONOFF-Adapt, the UE can either transmit a respective HARQ-signal to indicate an ACK (detection of ONOFF-Adapt) or not transmit an HARQ-ACK signal and implicitly indicate to the eNB a DTX value (no actual HARQ-ACK signal transmission from the UE). Moreover, if the PUCCH resource is UE-specific, the UE can transmit a HARQ-ACK signal with a NACK value if it fails to detect ONOFF-Adapt in any of the DL subframes where ONOFF-Adapt can be transmitted within a last ON/OFF adaptation period.

ONOFF-RNTI can be a reserved or a predefined value. Alternatively, it can be a cell-specific value. Alternatively, it can be configured to a UE by higher-layer signaling in association with a configuration for operation with an adaptive ON/OFF configuration. An ONOFF-RNTI can be UE-specific, and different ONOFF-RNTIs can be used for different UEs. For example, ONOFF-RNTI#1 can be used for a first group of UEs, and ONOFF-RNTI#2 can be used for a second group of UEs, where a group of UEs includes one or more UEs.

In general, if a UE does not detect within an ON/OFF configuration period an ONOFF-Adapt, either because it failed to detect an ONOFF-Adapt or because it was on DRX, the UE can assume a previous ON/OFF configuration, or it can be assume the configuration is ON within the ON/OFF configuration period.

An Embodiment of this Disclosure Provides Signaling Considering CA Operation and Signaling Considering Dual Connectivity:

For a UE configured with CA operation in a set of cells and for adaptive ON/OFF configuration in a subset of the set of cells, and for signaling (such as a DCI format) that conveys an ON/OFF configuration adaptation information for multiple cells, the UE is also configured for each cell in the subset of cells a location in the signaling (such as the DCI format) for a respective indicator of ON/OFF reconfiguration. Such configuration can be, for example, by RRC signaling or MAC signaling.

Operation with an adaptive ON/OFF configuration can be supported in all cells or in a subset of cells configured for CA to a UE. It can also be supported with dual connectivity through an ONOFF-Adapt transmission in an eNB for a respective cell.

In the following, a DCI format that conveys an ON/OFF configuration adaptation is used as an example of the signaling for ON/OFF configuration adaptation. It is understood that other signaling (such as RRC signaling or MAC signaling) may be used to convey ON/OFF configuration adaptation.

Assuming that a DCI format conveys X indicators of respective ON/OFF reconfigurations for X ONOFF-Cells, a UE configured for operation with an adaptive ON/OFF configuration in Num_Cells ONOFF-Cells can also be configured, for each of the Num_Cells ONOFF-Cells, respective locations in the DCI format for indicators of ON/OFF reconfigurations. An ONOFF-Cell can be identified, for example, by its carrier, physical cell ID (PCID), its locations, or its global identifier. For example, for two ONOFF-Cells, if they have the same carrier but different PCIDs, they can be treated as different ONOFF-Cells. In some of the examples in this disclosure, different ONOFF-Cells may have different carriers, but this disclosure is not limited to such.

A UE can be signaled a location for a respective indicator in a DCI format for ON/OFF reconfigurations for each of its ONOFF-Cells. Alternatively, a UE can be signaled an ordered list of its Num_Cells of ONOFF-Cells where an ordering is according to an order of ONOFF-Cells with ON/OFF reconfigurations indicated in the DCI format, and an X-bit bitmap that contains Num_Cells bits each having value ‘1’ indicating respective positions for indicators of ON/OFF reconfigurations for Num_Cells ON/OFF-Cells within the X indicators in the DCI format and all remaining bits in the bitmap can have value ‘0’. The bitmap can serve as a mask to mark the positions of Num_Cells ONOFF-Cells in the X indicators for ON/OFF reconfiguration.

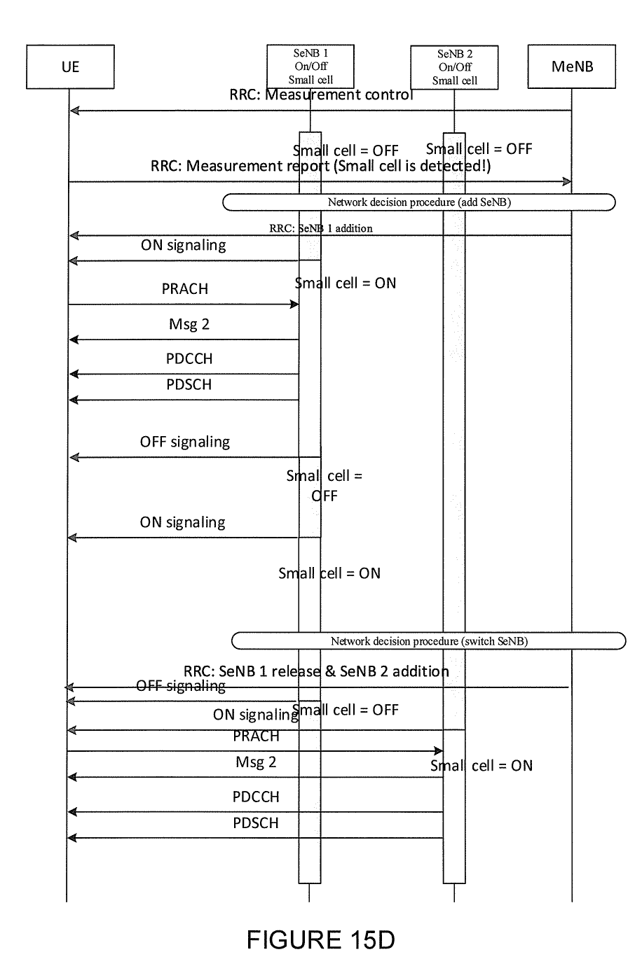

FIG. 25 illustrates example locations in a DCI format indicating an ON/OFF reconfiguration where each location corresponds to an ONOFF-Cell in accordance with an embodiment of this disclosure.

Referring to FIG. 25, in a DCI format providing X indicators of ON/OFF reconfigurations for respective X ONOFF-Cells 2510, UE-j 2560 is configured to monitor a first location 2530 and an i-th location 2540 for first and i-th indicators for ON/OFF reconfigurations, respectively. Also, UE-k 2570 is configured to monitor a first location 2530 and an X-th location 2550 for first and X-th indicators for ON/OFF reconfigurations, respectively.

If a DCI format has limited size such that it cannot indicate all of the X indicators of ON/OFF reconfigurations, a set of DCI formats can be used. DCI formats for ON/OFF reconfigurations for ONOFF-Cells can be partitioned into S DCI formats (or as an extension, to S subset of DCI formats). Each DCI format s (for s=1, 2, . . . , S) can have a DCI_Format_Indicator s. The partition can be based on, as described later, different time-domain resources used for a DCI format, different ONOFF-RNTI used to scramble the CRC for a DCI format, different subsets of ONOFF-Cells whose indicators of ON/OFF reconfiguration are included in a DCI format, different sizes of DCI formats, or their combinations. The signaling to a UE can include, for each DCI format s, a DCI_Format_Indicator and respective location indications for the indicator of an ONOFF reconfiguration within a respective DCI format. The signaling can be an extension of the aforementioned signaling from one DCI format to S DCI formats.

Different approaches are subsequently described for partitioning DCI formats, performing ON/OFF reconfigurations for ONOFF-Cells, to S DCI formats. Combinations can also be supported. In an approach, a partitioning of DCI formats for ON/OFF reconfigurations to S DCI formats is based on different time-domain resources used to transmit a DCI format. A transmission of each s-th DCI format (s=1, . . . , S) is associated with a set of time-domain resources (such as subframes) that are orthogonal with resources associated with a transmission of any other s′ DCI format (s′=1, . . . , s−1, s+1 . . . , S), where s is different than s′. A configuration of time-domain resources for each DCI format can be included, for example, in ConfigureONOFF-Adapt as shown in the embodiment above. For example, for a first DCI format, a first set of subframes (such as some or all of subframes with TTI index #0) can be configured to transmit the first DCI format. For a second DCI format, a second set of subframes (such as some or all of subframes with TTI index #5) can be configured to transmit the second DCI format.

In another approach, a different ONOFF-RNTI can be used to scramble the CRC for each of the multiple DCI formats conveying ON/OFF reconfigurations for ONOFF-Cells associated with the PCell. In ConfigureONOFF-Adapt, a set of subframes can be configured for each configured ONOFF-RNTI where a respective DCI format is transmitted. For example, a first ONOFF-RNTI is used for a first DCI format, and a second ONOFF-RNTI is used for a second DCI format. A UE can be configured locations for indicators of ON/OFF reconfiguration for its ONOFF-Cells where a configuration of locations can also include an indicator of an ONOFF-RNTI used to scramble the CRC of a respective DCI format, or the DCI_Format_Indicator can be the indicator of an ONOFF-RNTI.

In another approach, a partitioning of DCI formats for ON/OFF reconfigurations to S DCI formats is based on different respective ONOFF-Cells. An indicator of the subset of ONOFF-Cells can be included in a DCI format, such as a field in the DCI format. A set of all ONOFF-Cells of a group of UEs can be partitioned into subsets of ONOFF-Cells where indicators for ONOFF UL-DL reconfigurations of ONOFF-cells corresponding to each subset of ONOFF-Cells can be also indicated in a respective DCI format. The DCI_Format_Indicator can be the indicator of a subset of ONOFF-Cells.

In another approach, a partitioning DCI formats for ON/OFF reconfigurations to S DCI formats is based on a different respective size for each DCI format. Different DCI formats can have different sizes. The DCI_Format_Indicator can be the indicator of a size of a DCI format. For example, two DCI formats can be used, where one DCI format can have a size equal to DCI Format 1C and the other can have a size equal to DCI Format 3/3A. The size of the DCI format can be configured, for example, by including it in ConfigureONOFF-Adapt.

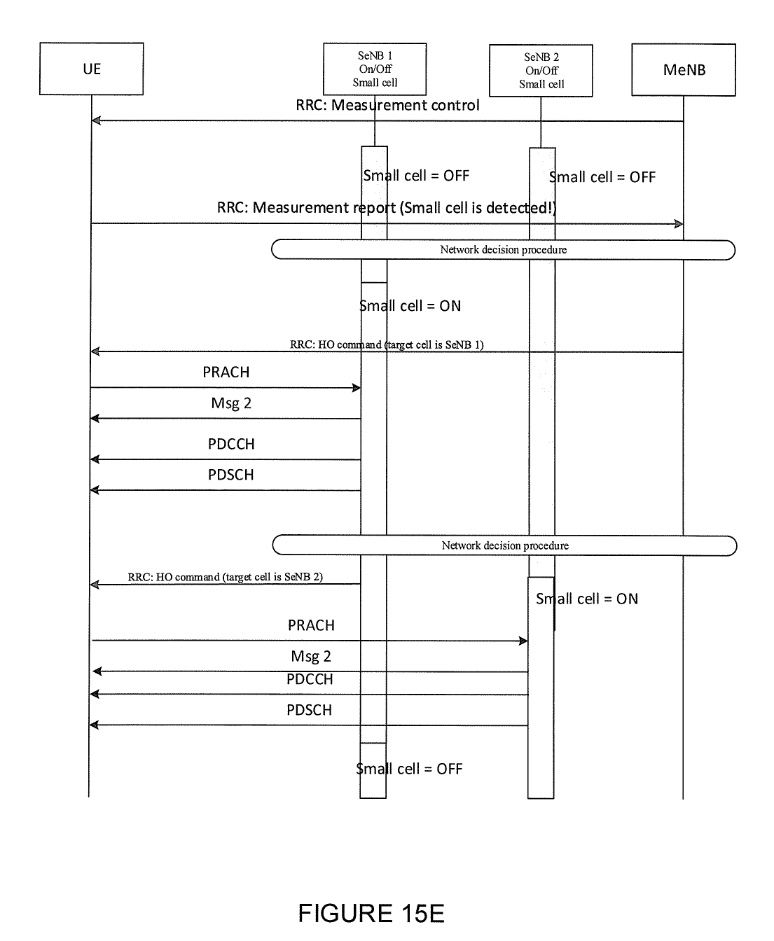

FIG. 26 illustrates example operations for a UE to determine locations for indicators of ON/OFF reconfigurations for its ONOFF-Cells that are provided by two DCI formats in accordance with an embodiment of this disclosure.

Referring to FIG. 26, a UE receives configuration of locations in a DCI format for indicators of ON/OFF reconfigurations in ONOFF-Cells and determines DCI format indicator 2610 for two DCI formats. The UE determines whether the DCI format is a first one 2620. If it is, the UE determines locations in the first DCI formats for indicators of ON/OFF reconfiguration in respective ONOFF-Cells 2630. Otherwise, the UE determines locations in a second DCI format for indicators of ON/OFF reconfiguration in respective ONOFF-Cells 2640.

Instead of the DCI formats conveying indicators of ON/OFF reconfiguration for ONOFF-Cells being all transmitted in a CSS of a PCell, a UE can be configured to receive one or more such DCI formats in respective CSS of one or more of its SCells (such as in an ONOFF-Cell that is a Scell).

In dual connectivity, a PCell in an SeNB can transmit DCI formats conveying indicators of ON/OFF reconfiguration for ONOFF-Cells associated with the SeNB. A PCell in an MeNB can transmit DCI formats conveying indicators of ON/OFF reconfiguration for ONOFF-Cells associated with the MeNB. A PCell in an SeNB can transmit DCI formats conveying indicators of TDD UL-DL reconfiguration for ONOFF-Cells associated with the SeNB. A PCell in an MeNB can transmit DCI formats conveying indicators of TDD UL-DL reconfiguration for ONOFF-Cells associated with the MeNB. A cell can be a PCell in an SeNB of a first UE and a PCell in an MeNB of a second UE.

An Embodiment of this Disclosure Provides an ON/OFF Configuration Interacting with TDD and UL-DL Reconfiguration:

As L1 signaling for TDD UL-DL reconfiguration can be transmitted in a set of subframes, L1 signaling for ON/OFF configuration adaptation can interact with L1 signaling for TDD UL-DL reconfiguration. In an another approach, if a subframe is configured as OFF where the subframe is scheduled for L1 signaling for TDD UL-DL reconfiguration, the L1 signaling for TDD UL-DL reconfiguration can be transmitted as an exception in the subframe even though the subframe is configured as an OFF one. In other words, at least some of the subframes where L1 signaling for TDD UL-DL reconfiguration can be transmitted can be ON despite an opposite indication by ON/OFF configuration adaptation signaling. A UE can monitor the L1 signaling for TDD UL-DL reconfiguration even if the L1 signaling is in an SF that is configured as OFF.

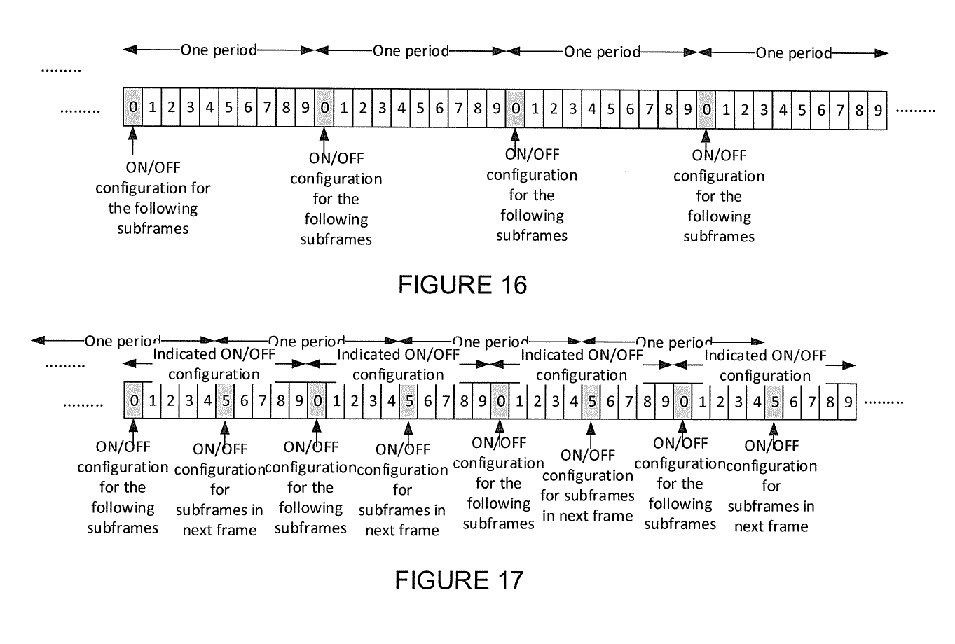

FIG. 27 illustrates an example for a set of subframes that are configured as OFF and having an exception for transmission of L1 signaling for adaptation of a TDD UL-DL configuration in accordance with an embodiment of this disclosure.

Referring to FIG. 27, when a cell is configured with TDD UL-DL Configuration 1 2730, a signaling for cell ON/OFF configuration is transmitted in SF#0 2710, and it indicates an ON/OFF pattern of ON/OFF alternating in every other frame. An L1 signaling for adaptation of TDD UL-DL configuration is scheduled in SF#5 2740 prior to an adaptation of TDD UL-DL configuration from TDD UL-DL Configuration 1 2730 to TDD UL-DL configuration 2 2750. However, the scheduled timing happens to fall in an SF 2740 that is configured to be OFF 2720. The SF for L1 signaling for adaptation of UL-DL configuration can be an exception from being OFF even if it is configured as OFF by L1 signaling for ON/OFF configuration.

In another approach, if a subframe is configured as OFF where the subframe is scheduled for L1 signaling for TDD UL-DL reconfiguration, the L1 signaling for TDD UL-DL reconfiguration can be omitted. For example, there can be multiple occasions scheduled for the same L1 signaling for a TDD UL-DL reconfiguration. If some of them are scheduled in subframes that are configured as OFF, they can be omitted, while others scheduled in subframes that are configured as ON can be transmitted. A UE can skip monitoring the L1 TDD UL-DL reconfiguration that is scheduled in a subframe configured as OFF.

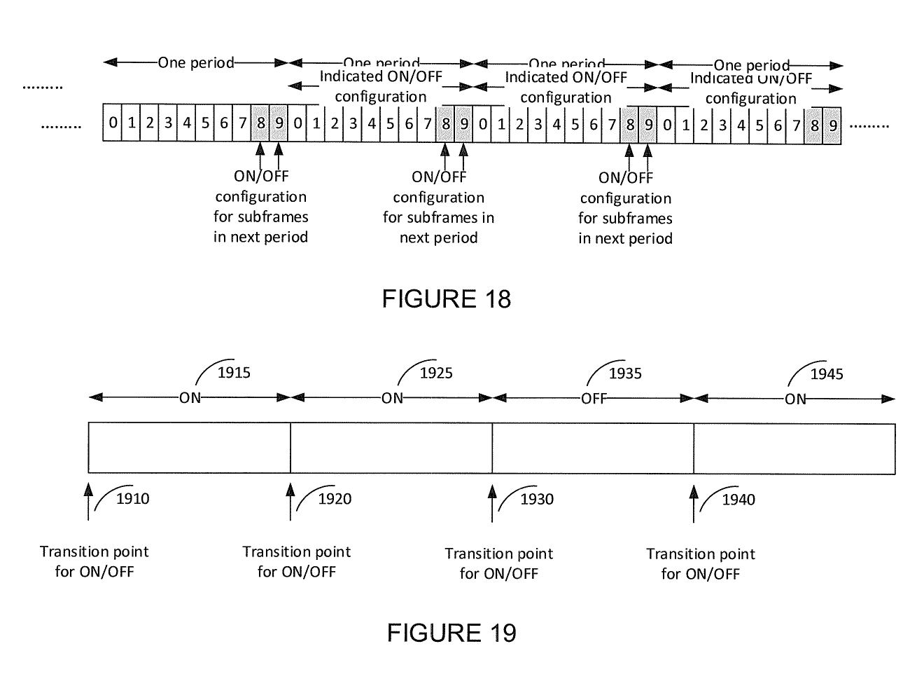

FIG. 28 illustrates an example that a set of subframes can be configured as OFF and certain transmission of L1 signaling for TDD UL-DL adaptation in a subframe configured as OFF can be omitted in accordance with an embodiment of this disclosure.

Referring to FIG. 28, when a cell is configured with TDD UL-DL Configuration 1 2830, a signaling for cell ON/OFF configuration is transmitted in SF#0 2810, and it indicates an ON/OFF pattern of ON/OFF alternating in every other frame. A first L1 signaling for adaptation of TDD UL-DL configuration is scheduled in SF#5 2840 prior to an adaptation of TDD UL-DL configuration from TDD UL-DL Configuration 1 2830 to TDD UL-DL Configuration 2 2850. However, the scheduled timing happens to fall in an SF 2840 that is configured to be OFF 2820. A second L1 signaling for adaptation of UL-DL configuration is scheduled in SF#0 2860 at the beginning of the new TDD UL-DL Configuration 2 2850, and the SF 2860 is configured as ON 2825 according to the L1 signaling for ON/OFF configuration 2810. The first L1 signaling 2840 is not transmitted by the cell, and the second L1 signaling 2860 is transmitted. A UE can omit monitoring or receiving the first L1 signaling 2840, and it monitors the second L1 signaling 2860.

In another approach, if a subframe is configured as OFF where the subframe can convey L1 signaling for TDD UL-DL reconfiguration, the L1 signaling for TDD UL-DL reconfiguration can be transmitted in another subframe that is configured as ON. A predefined algorithm or mapping function can be used to determine the latter subframe. For example, the latter subframe can be a nearest subframe (immediately prior to or immediately after the initial subframe) that is configured as ON. Both a cell and a UE can use the same algorithm to determine a subframe for transmission of the L1 signaling for TDD UL-DL reconfiguration.

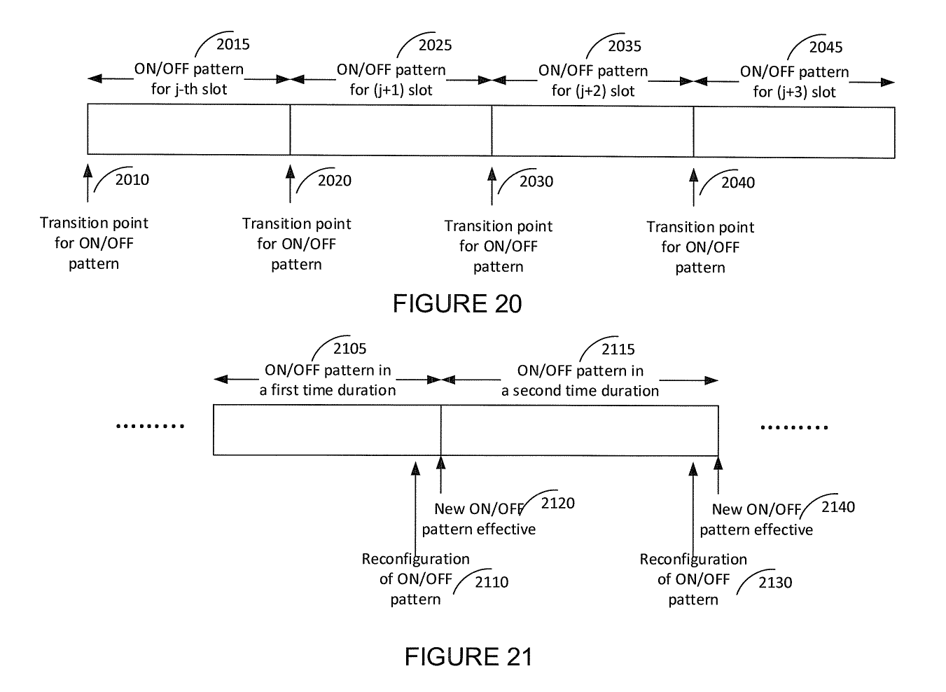

FIG. 29 illustrates an example that a set of subframes can be configured as OFF and certain transmission of L1 signaling for TDD UL-DL adaptation in a subframe configured as OFF can be omitted, and rescheduled to other SF which is configured as ON in accordance with an embodiment of this disclosure.

Referring to FIG. 29, when a cell is configured with TDD UL-DL Configuration 1 2930, a signaling for cell ON/OFF configuration is transmitted in SF#0 2910, and it indicates an ON/OFF pattern of ON/OFF alternating in every other frame. An L1 signaling for adaptation of TDD UL-DL configuration is scheduled in SF#5 2940 prior to an adaptation of TDD UL-DL configuration from TDD UL-DL Configuration 1 2930 to TDD UL-DL Configuration 2 2950. However, the scheduled timing happens to fall in an SF 2940 that is configured to be OFF 2920. The L1 signaling 2940 is not transmitted by the cell, and it is rescheduled to and transmitted in another SF that is configured as ON by using some predefined algorithm, such as the nearest DL SF 2955 that is configured as ON prior to the scheduled L1 signaling 2940 the second L1 signaling 2960 or the nearest DL SF 2960 that is configured as ON in a later time than the scheduled L1 signaling 2940. A UE can use the same algorithm to determine the SF in which it monitors the L1 signaling.

In another approach, if L1 signaling is used to inform a UE of adaptation of ON/OFF configuration, it can be transmitted in the same subframe where L1 signaling to inform a UE of TDD UL-DL adaptation is transmitted, or they can be combined. For example, the L1 signaling to inform a UE of TDD UL-DL adaptation can include an information field in DCI format to indicate ON/OFF configuration for the cells that need to have ON/OFF reconfigured. A cell having a TDD UL-DL configuration adaptation and a cell having ON/OFF configuration adaptation can be the same or different. The ON/OFF configuration can be for a TDD UL-DL reconfiguration, if any.

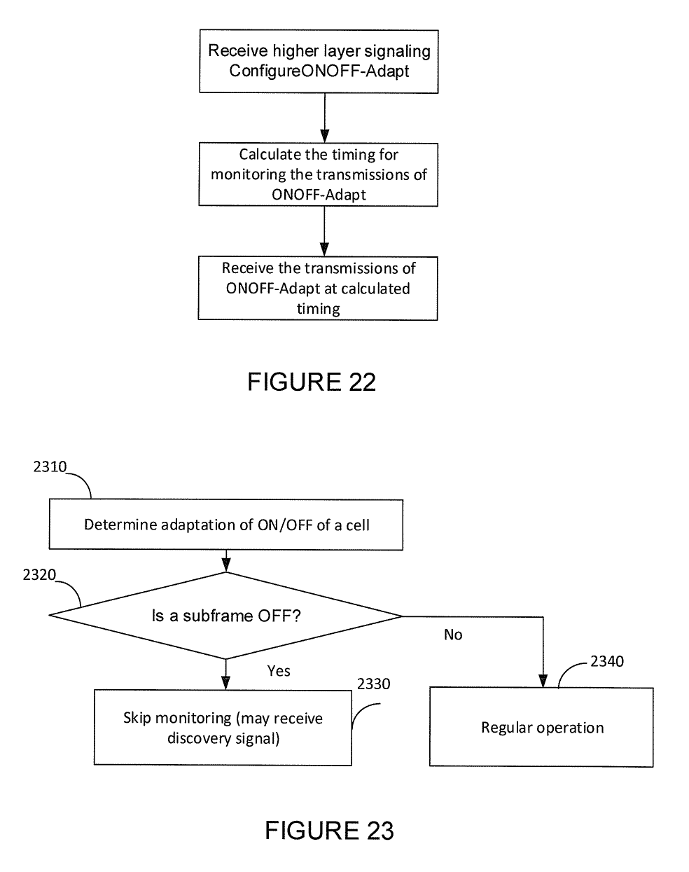

FIG. 30 illustrates an example of L1 signaling informing of an ON/OFF configuration and of L1 signaling informing of a TDD UL-DL reconfiguration being transmitted in the same subframe or being provided by the same DCI format in accordance with an embodiment of this disclosure.

Referring to FIG. 30, when a cell needs to adapt TDD UL-DL Configuration 1 3030 to TDD UL-DL Configuration 2 3050 for a UE, L1 signaling for cell ON/OFF configuration and L1 signaling to inform a UE of TDD UL-DL adaptation is transmitted in SF#0 3040. These two L1 signaling can be merged as one L1 signaling, or they can be separately transmitted.

In another approach, as an extension of the previous approach, if L1 signaling is used to inform a UE of adaptation of ON/OFF configuration, it can be transmitted in a first set of subframes, and L1 signaling to inform a UE of TDD UL-DL adaptation can be transmitted in a second set of subframes. The first set of subframes can be a subset of the second set of subframes, or the two subframe sets can be disjoint or partially overlapped.

If the aforementioned first set of subframes (including transmissions of adaptation of ON/OFF configuration) is a subset of the second set of subframes (including transmissions of adaptation of TDD UL-DL configuration), the L1 signaling for TDD UL-DL reconfiguration can be transmitted more frequently or with shorter periodicity than when only DCI conveying a TDD UL-DL reconfiguration is transmitted (no DCI conveying ON/OFF reconfiguration is transmitted). Higher-layer signaling for configuration of subframes for transmission of L1 signaling for ON/OFF configuration adaptation can be the same as higher-layer signaling for configuration of subframes for TDD UL-DL configuration adaptation. Alternatively, the former and latter subframes can be separately configured. It is also possible for the signaling for ON/OFF configuration adaptation to reuse the L1 signaling for TDD UL-DL configuration adaptation.

TDD UL-DL configuration adaptation and ON/OFF configuration adaptation can also use the same DCI format. For example, a three-bit field indicating a TDD UL-DL reconfiguration or an ON/OFF configuration adaptation can be included in the same DCI format using the same RNTI. For TDD UL-DL configuration adaptation, the three-bit new configuration indicated in DCI format can be based on Table 1 and Table 2 where only the UL indicated in SI can be allowed to be adapted to DL, but the DL indicated in SI may not be allowed to be adapted to UL. For example, if in the SI the reference configuration is TDD UL-DL Configuration 1 (indicator with value ‘001’), it can be adapted to TDD UL-DL Configuration 2 according to Table 2 by adapting UL in SF#3 and SF#9 to DL, and the DCI format conveying TDD UL-DL reconfiguration can include indicator with value ‘010’ to indicate TDD UL-DL Configuration 2. TDD UL-DL Configuration 1 may not be adapted to TDD UL-DL Configuration 0 (indicator with value ‘000’) for TDD UL-DL adaptation since such adaptation may not be allowed according to Table 2. The DCI format can also convey information for an adapted ON/OFF configuration by implicitly indicating a new ON/OFF configuration using a three-bit indicator that indicates one of the TDD UL-DL configurations (or can be one of the seven TDD UL-DL configurations plus an additionally defined TDD-OFF configuration), where a DL subframe can be changed to a UL subframe. For example, TDD UL-DL Configuration 1 (indicated in SI) can be adapted to TDD UL-DL Configuration 0 (indicator with value ‘000’ in DCI format) where DL SF#4 and DL SF#9 are changed to UL, and it can be interpreted as DL SF#4 and DL SF#9 are DTX or being OFF. The UE may not disregard a detected DCI with TDD UL-DL reconfiguration indicator with value ‘000’ even though it is not allowed for TDD UL-DL adaptation. Instead, the UE can derive the new ON/OFF configuration by interpreting the TDD UL-DL reconfiguration indicator with value ‘000’ in the DCI as SF#4, #9 being configured TX OFF (cell DTX).

For indicating an adapted ON/OFF configuration, if a three-bit indicator is used, the indicated configuration that is used to derive the adapted ON/OFF configuration can include seven TDD UL-DL configurations as in Table 1 and an additional defined TDD-OFF configuration. For example, the TDD-OFF configuration can be indicated as 111, and it can be a configuration with SF#0, SF#5 being DL while all the other SFs in a frame being UL, a configuration with SF#0 being DL while all the other SFs in a frame being UL, a configuration with SF#0 in a frame with SFN mod 2=0 being DL while all the other SFs in two consecutive frames being UL, and so on. Table 13 provides an example TDD-OFF configuration where configuration 7 can be additionally defined beyond the seven conventional configurations. It is noted that a TDD-OFF configuration may not be an actual TDD UL-DL configuration and serve only to indicate an adapted ON/OFF configuration. Configuration 7 in Table 13 can be fixed, or alternatively it can be configured by signaling such as higher-layer signaling or system information. Table 14 provides example TDD-OFF configurations. For example, configuration 7 in Table 13 can be configured as one of the configuration in Table 14 via higher-layer signaling or system information.

TABLE 13
Example TDD UL-DL configurations

| TDD | DL-to-UL | | | | | | | | | | |
|---|---|---|---|---|---|---|---|---|---|---|---|
| UL-DL | Switch- | | | | | | | | | | |
| Config- | point | TTI number | | | | | | | | | |
| uration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |
| 7 | n.a. | D | U | U | U | U | D | U | U | U | U |
| | (for DTX | | | | | | | | | | |
| | adaptation) | | | | | | | | | | |

TABLE 14
Example TDD-OFF configurations

| TDD-OFF | | TTI number | | | | | | | | | |
|---|---|---|---|---|---|---|---|---|---|---|---|
| Configuration | Number of frames | 0 | 1 | 2 | 3 | 4 | 5 | 6 | 7 | 8 | 9 |
| 0 | 1 | D | U | U | U | U | D | U | U | U | U |
| 1 | 1 | D | U | U | U | U | U | U | U | U | U |
| 2 | 2 (TTIs in the table only | D | U | U | U | U | U | U | U | U | U |
| | indicates TTIs in frame with | | | | | | | | | | |
| | even SFN, Frame with odd | | | | | | | | | | |
| | SFN has subframes all UL | | | | | | | | | | |

As an alternative, more than three bits can be used for the indication of new configuration in a DCI format conveying ON/OFF adaptation. In this way, multiple ones of the configurations for TDD-OFF can be used (different from the previously described operation where only one of the TDD-OFF configurations can be signaled via the three-bit indication in the DCI format and which TDD-OFF configuration to be used is signaled via higher-layer signaling or system information). It makes the DCI format conveying ON/OFF adaptation different than the DCI format conveying TDD UL-DL reconfiguration.

TDD UL-DL configuration adaptation and ON/OFF configuration adaptation can also use the same DCI format. For example, a three-bit field indicating a TDD UL-DL reconfiguration or an ON/OFF configuration adaptation can be included in the same DCI format using the same RNTI. If the CRC test using an associated RNTI for a DCI format conveying an adaptation of a TDD UL-DL configuration passes and the indicator value is a reserved value (such as value ‘111’) corresponding to adaptation of an ON/OFF configuration, the UE considers the DCI format as conveying an adaptation for the ON/OFF configuration. Additionally, it is also possible to consider an indicator for an adapted TDD UL-DL configuration that is not a valid one as indicating an adaptation of an ON/OFF configuration; however, this can also be an outcome of an incorrect CRC test and can be regarded as an erroneous detection.

An ONOFF-RNTI can be used to scramble the CRC of a respective DCI format conveyed by the ONOFF-Adapt control signaling. ONOFF-RNTI can be the same as the RNTI used to scramble the CRC of a respective DCI format used to convey an adapted TDD UL-DL configuration for TDD UL-DL adaptation purpose. Alternatively, the two respective RNTIs can be different. When these two RNTIs are different, if the indicated reconfiguration in the received DCI format does not match the respective RNTI, the UE can disregard the DCI. For example, if a UE-detected indicated TDD configuration in the receive DCI format implies UL adapted to DL in some subframe comparing to the reference configuration in SI but the RNTI is for ON/OFF adaptation purpose, or if a UE-detected indicated TDD configuration implies DL adapted to UL in some subframe comparing to the reference configuration in SI but the RNTI is for TDD UL-DL adaptation purpose, it can disregard the DCI.

A DCI format conveying information for ON/OFF reconfiguration and a DCI format conveying information for TDD UL-DL reconfiguration can be differentiated by, for example, respective different RNTIs, whether the indicated TDD UL-DL configuration in the receive DCI format implies DL adapted to UL in every adapted subframe or UL adapted to DL comparing to the reference configuration in SI, by different time-domain or CCE resources for transmitting each DCI format, or different respective DCI format sizes, or by an explicit indicator in the same DCI format such as adapting an ON/OFF configuration using a reserved indicator that cannot be used for adapting a TDD UL-DL configuration or their combinations. For example, a UE can determine that a DCI format conveys information for an ON/OFF reconfiguration if the RNTI used to scramble the CRC is an ONOFF-RNTI), the indicated TDD configuration in the receive DCI format implies DL adapted to UL in every adapted subframe comparing to the reference configuration in SI, if a respective subframe is in a set of subframes exclusively for L1 signaling of ON/OFF reconfiguration (and not used for TDD UL-DL reconfiguration), a size of a DCI format for ON/OFF reconfiguration is different than a size of a DCI format for TDD UL-DL reconfiguration, via an explicit indicator in the DCI format indicating an ON/OFF reconfiguration instead of TDD UL-DL reconfiguration, or by predefined combination of the above.

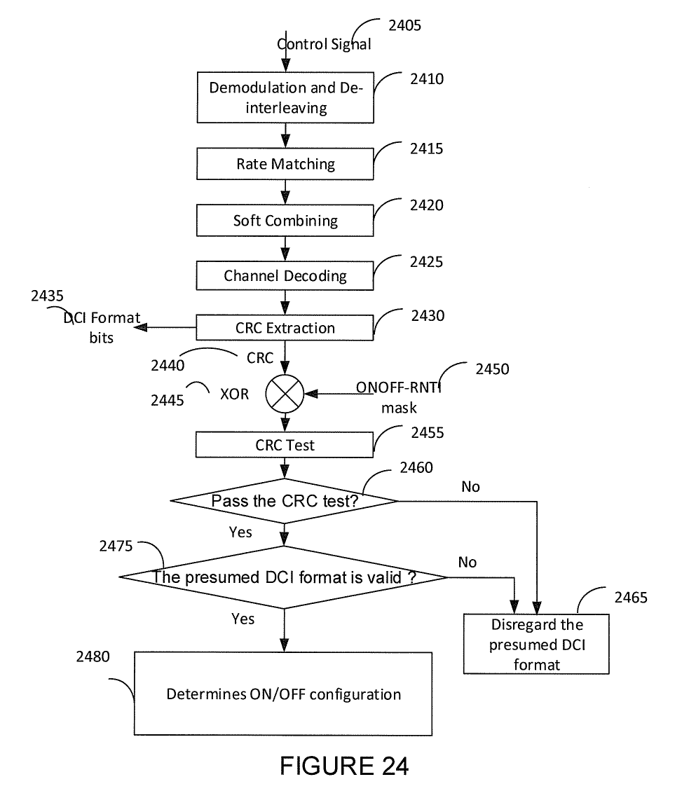

FIG. 31 illustrates an example for L1 signaling to inform a UE either of an ON/OFF reconfiguration or of a TDD UL-DL reconfiguration in accordance with an embodiment of this disclosure.

Referring to FIG. 31, when a cell needs to adapt TDD UL-DL Configuration 1 3130 to TDD UL-DL Configuration 2 3150, L1 signaling to inform a UE of a respective TDD UL-DL reconfiguration is transmitted in SF#0 3140. Conversely, if the cell needs to turn OFF (DTX) SF#3, 4, 8, 9 3170, the cell informs the UE of ON/OFF configuration adaptation using the same L1 signaling as for a TDD UL-DL reconfiguration and setting a respective indicator field to a value ‘000’ 3160. In the same frame where signaling 3160 is transmitted, SF#3, 4, 8, 9 3170 can be OFF. If the indicator field has value ‘111’ 3160, SF#1, 3, 4, 6, 8, 9 are all OFF. If in a next frame L1 signaling 3140 is again transmitted, the TDD UL-DL configuration can be indicated as TDD UL-DL Configuration 2.

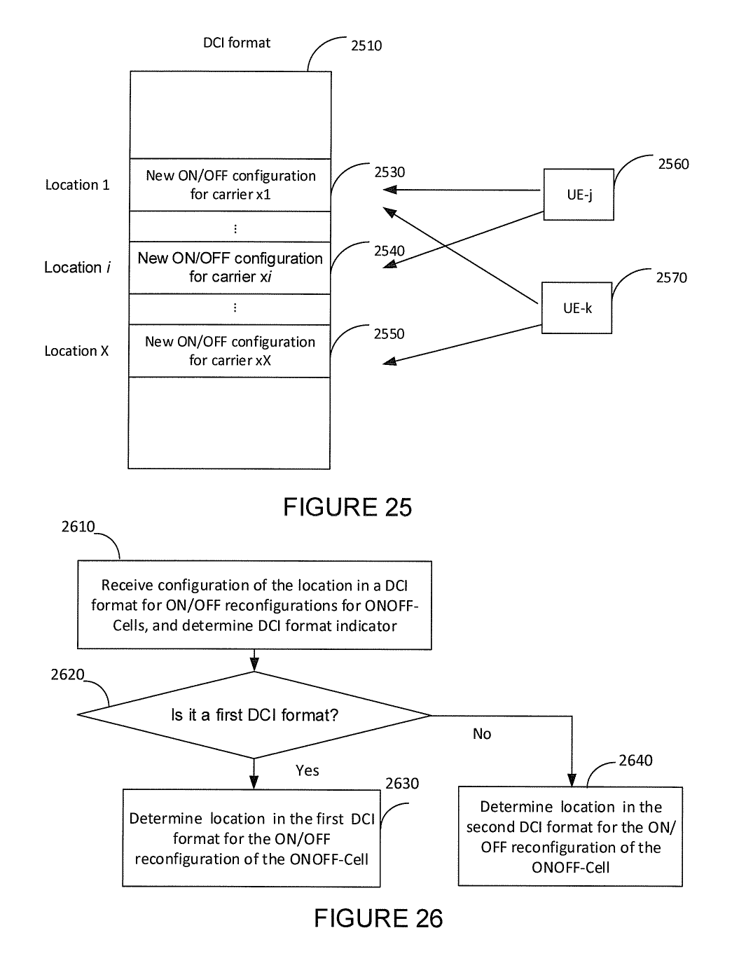

FIG. 32 illustrates an example UE operation for L1 signaling to inform a UE of ON/OFF reconfiguration by including a field in a DCI format that indicates a new TDD UL-DL configuration.

Referring to FIG. 32, a UE receives L1 signaling (DCI format) either for TDD UL-DL reconfiguration or for ON/OFF reconfiguration 3210 at a certain subframe that is included in a set of subframes informed to the UE by higher-layer signaling. The UE determines whether the DCI format conveys information for ON/OFF reconfiguration or for TDD UL-DL reconfiguration 3220. Accordingly, the UE determines either an ON/OFF reconfiguration for an ONOFF-Cell 3230 or a TDD UL-DL reconfiguration for a respective cell 3240. The UE determination can be based on one of the previously described approaches. For the operation in box 3230, the UE may need to derive which subframes are configured to be OFF (DTX), where such subframes are those UL subframes with respect to a new TDD UL-DL configuration indicated in the DCI format.

To support a UE in an idle state to receive paging information, if a cell would use an ON/OFF configuration (such as in Table 14) that may have ON-subframes or DL-subframes fewer than the set of subframes that the UE should monitor for paging, the cell's ON/OFF configuration should be signaled to the UE. For example, an ON/OFF configuration with minimum ON subframes can be signaled to the UE if the minimum ON subframes are fewer than a set of subframes that the UE should monitor for paging. The UE can use a predefined mapping function to determine the subframes to monitor for paging. The mapping function can map subframes that the UE is supposed to monitor (assume all DL SFs are ON) to an actual ON-subframe indicated in the received ON/OFF configuration. For example, if a UE needs to monitor SF#0, 1, 5, 6 for paging assume DL SFs are ON, however, the UE also receives a signaling indicating that an ON/OFF configuration with minimum ON subframes of a cell is TDD-configuration 0 as in Table 14, which has SF#0, 5 on. A mapping function can be mapping SF#0, 1 to SF#0, and mapping SF#5, 6 to SF#5. The UE can monitor SF#0 for the paging that may be scheduled in SF#0, 1, and monitor SF#5 for the paging which may be scheduled in SF#5, 6.

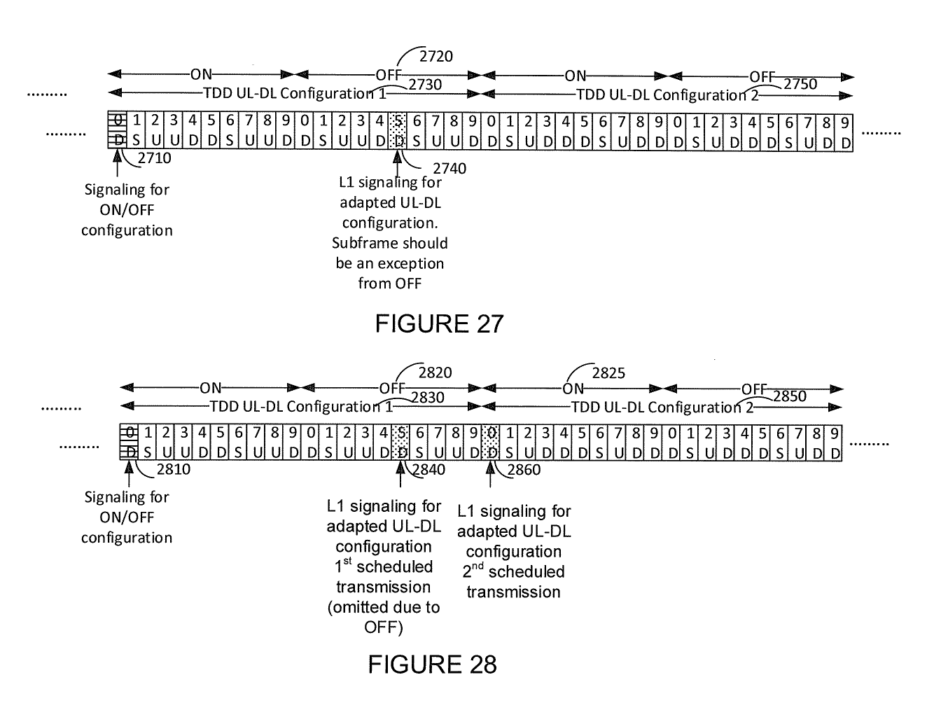

FIG. 33 illustrates example operations for a UE to determine subframes to monitor for paging in accordance with an embodiment of this disclosure.

Referring to FIG. 33, a UE receives an ON/OFF configuration, where the ON/OFF configuration can be the one with minimum ON subframes among all the possible configuration that the cell would have (for example, a TDD-OFF configuration) 3310. The UE determines whether ON-subframes are fewer than the subframes that the UE should monitor in idle mode 3320. If yes, the UE determines the subframes to monitor for paging 3330 via a mapping function which maps subframes that the UE is supposed to monitor (assume all SFs are ON) to an actual ON-subframe indicated in the received ON/OFF configuration in 3310. If not, the UE performs regular operations.

This embodiment can be extended from TDD to FDD. For example, in Table 13 and Table 14, all the UL can be OFF for FDD and DL and Special subframes can be ON for FDD, while the signaling for FDD can reuse the one for TDD.

An Embodiment of this Disclosure Provides Signaling ON/OFF Configuration Via PHICH:

When ON/OFF configuration is of 1-bit size, ON/OFF configuration can be signaled via PHICH. Each ON/OFF cell can signal its own ON/OFF configuration via PHICH. An eNB can configure resources for PHICH conveying adaptation of ON/OFF. The configuration of resources (for example, time (such as a set of subframes, symbols), frequency, PHICH group index/number, orthogonal sequence index within the PHICH group, and the like) for PHICH conveying adaptation of ON/OFF configuration can be per ON/OFF cell or alternatively can be common for all ON/OFF cells. The configuration of resources for PHICH conveying adaptation of ON/OFF configuration can be, for example, explicitly indicating the resources for PHICH conveying adaptation of ON/OFF configuration, or indicating some parameters that a UE can use to derive the resources for PHICH conveying adaptation of ON/OFF configuration.

The resources for PHICH conveying adaptation of ON/OFF configuration can be orthogonal to the resources for PHICH conveying HARQ acknowledgement. PHICH conveying adaptation of ON/OFF can be sent on the subframes that are ON.

A UE can be configured with PHICH resources for ON/OFF configuration. The resources, for example, can be predetermined or predefined or can be signaled (for example, via higher-layer signaling), or some parameters can be signaled and the resources can be derived. Multiple UEs can have the same configuration so that one PHICH is used, and multiple UEs can monitor the same resources and decode the PHICH.

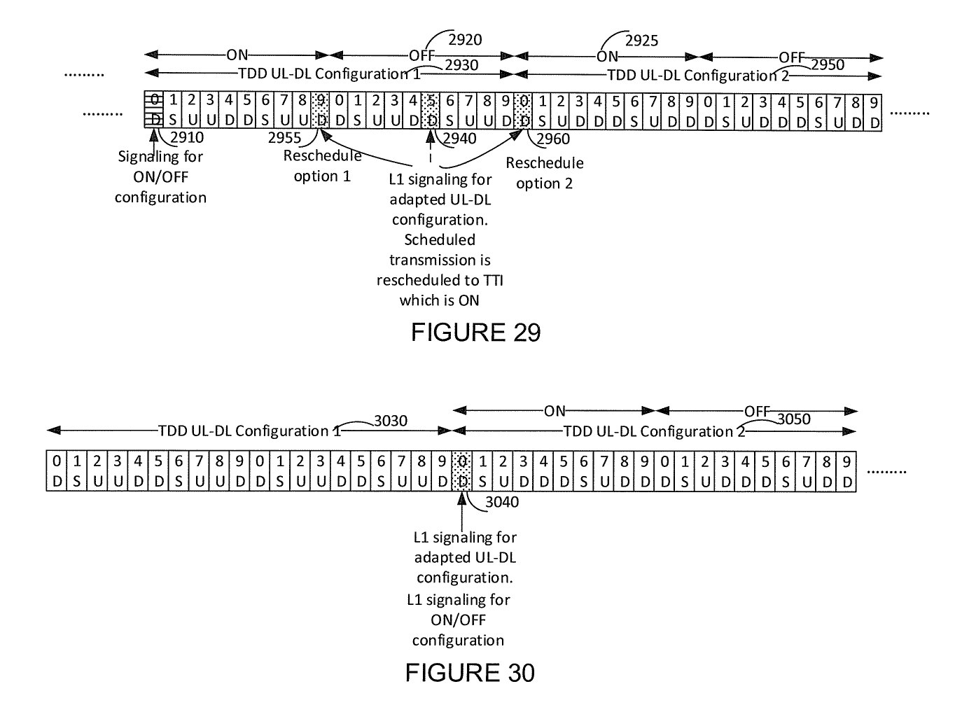

FIG. 34 illustrates example operation for a UE to receive PHICH conveying adaptation of ON/OFF configuration in accordance with an embodiment of this disclosure.

Referring to FIG. 34, a UE receives higher-layer signaling indicating configuration related to PHICH for adaptation of ON/OFF configuration. The UE determines the resources (such as time, frequency, PHICH group number, orthogonal sequence index within the group) for the PHICH for adaptation of ON/OFF configuration for respective ON/OFF cell. The UE receives the PHICH for adaptation of ON/OFF, and it determines ON/OFF configuration.

Various embodiments in this disclosure can be extended when a UE is signaled about a DRX configuration, where the DRX configuration has incorporated the cell's ON/OFF configuration. In principle, the set of subframes that a UE can be in sleep as in DRX can include (or can be expanded by including) the set of subframes that are configured as OFF.

If the signaling for cell ON/OFF configuration or for a UE's DRX configuration incorporating cell ON/OFF configuration is dynamic, the information can be relayed by the UE from a first eNB to a second eNB, in some situation such as if the backhaul of these two eNBs has relatively large latency, such as in dual connectivity.

Various embodiments in this disclosure can also be extended to situations where certain subframes in a frame can be pre-configured or pre-defined as ON, such as subframe#0 or subframe#5 or both.

In addition, various embodiments in this disclosure can be extended so that an adapted ON/OFF configuration can be included in existing signaling used for other purposes, such as by using some reserved bits in certain predetermined or predefined position(s). For example, the adapted ON/OFF configuration can be indicated in DCI 3/3A at a predetermined SF (such as SF#5) and reserve a certain number of bits in a predetermined position. As another example, the adapted ON/OFF configuration can be indicated in physical control format indicator channel (PCFICH) by using the reserved 4-th state.

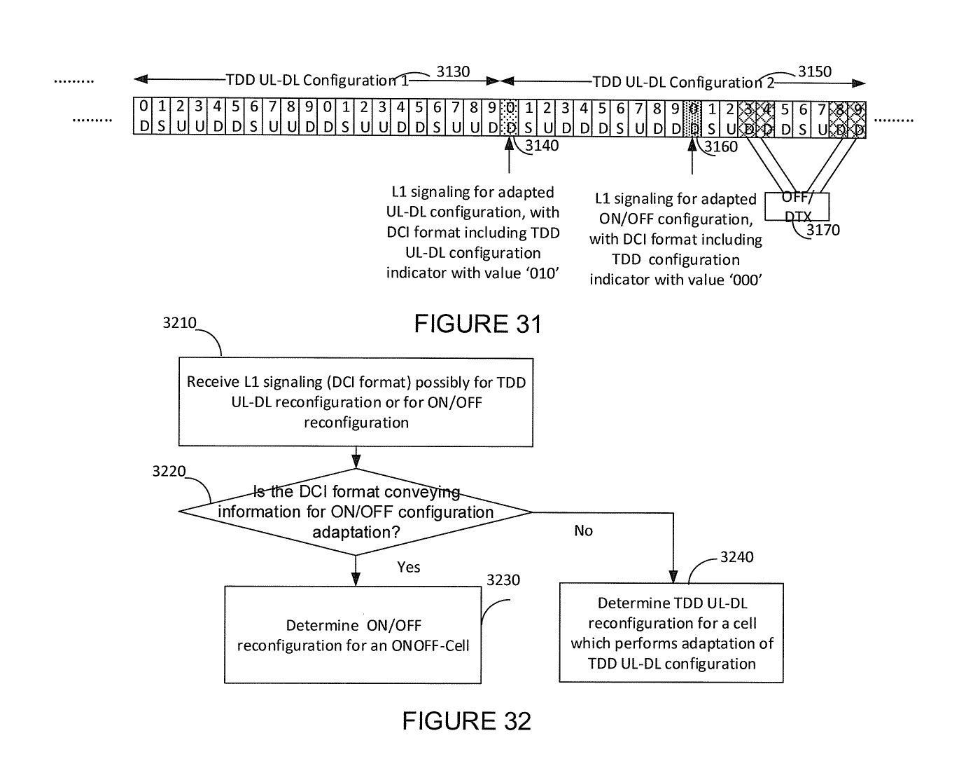

FIG. 35 illustrates an example of synchronized macro cell and small cell deployment, where synchronization at frame level shown in accordance with an embodiment of this disclosure.

Referring to FIG. 35, the macro cell is assumed to be a FDD cell and the small cell is assumed to be a TDD cell. Other combinations of duplexing schemes of the macro cell and the small cell are also possible. The start of a radio frame of the macro cell 3520 is approximately aligned with the start of a radio frame of the small cell 3540. The DL signal timing difference between the macro cell transmitter and the small cell transmitter can be of the order of mico seconds 3550 (e.g. <1.3 μs), whereas the DL timing difference between the macro cell signals and the small cell signals at the UE receiver can be up to the order of 10s of μs (e.g. ˜30 μs) due to the difference in signal propagation delay between the macro cell signals and the small cell signals. In general, the System Frame Number (SFN) of the macro cell 3510 may not be aligned with the SFN of the small cell 430, i.e. N≠M. When the SFNs are also aligned, then N=M. An example of SFN alignment is when the small cell can be configured as a Secondary Cell (SCell) to the macro cell's Primary Cell (PCell) in a carrier aggregation operation.

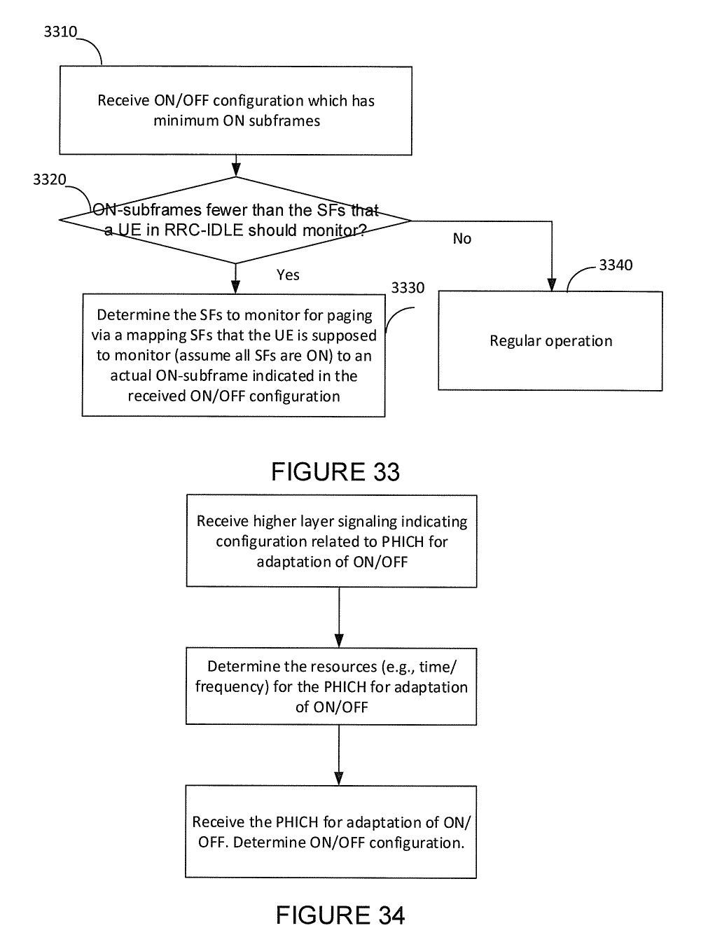

FIG. 36 illustrates an example of unsynchronized macro cell and small cell in accordance with an embodiment of this disclosure.

Referring to FIG. 36, the macro cell is assumed to be a FDD cell and the small cell is assumed to be a TDD cell. Other combinations of duplexing schemes of the macro cell and the small cell are also possible. The start of a radio frame of the macro cell 3620 may not be aligned with the start of a radio frame of the small cell 3630, where the maximum timing difference between two system frames can be 5 ms. The start of a subframe of the macro cell may not be aligned with the start of a subframe of the small cell, where the maximum absolute timing difference between two subframes can be 0.5 ms. In addition, the System Frame Number (SFN) of the macro cell 3610 may not be aligned with the SFN of the closest frame boundary of the small cell 3640, i.e. N≠M. Some examples of timing misalignment are shown as Case A, Case B and Case C in FIG. 36.

A UE may be configured to be connected in RRC connected mode to two eNodeBs in a dual connectivity operation (i.e. one Master eNodeB or MeNB and one Secondary eNodeB or SeNB). In a typical dual connectivity operation in a heterogenous network, the macro eNodeB is the MeNB and the small cell eNodeB is the SeNB. The UE may not assume that the MeNB is synchronized with the SeNB.

When the distances among many small cells are small, severe inter-small cell interference can occur. A consequence of the severe inter-cell interference is that the probability of a UE detecting individual cells in a cluster can be significantly reduced. As a result, discovery reference signal (DRS) that enables enhanced cell discovery capability can be transmitted by the small cells. A discovery reference signal can be a NZP CSI-RS, with possible modified resource element mapping and transmission periodicity compared to the NZP CSI-RS of the previous LTE releases. Other possible discovery reference signal includes PSS/SSS, enhanced PSS/SSS, or PRS. In this disclosure, we shall assume DRS in the form of NZP CSI-RS. To facilitate detection and measurement of DRS, the UE can be signaled by a serving cell network assistance information to facilitate DRS detection/measurement by the UE, which can include a DRS measurement timing configuration or a DRS subframeConfig similar to the NZP CSI-RS's subframeConfig, with possible different periodicity and offset configurations.

An example procedure for enhanced cell discovery comprises the following operations:

Operation 1: A UE is configured e.g. by the macro cell, with DRS detection/measurement configuration, including configuration of a DRS subframeConfig.

Operation 2: The UE detects a PSS and a SSS or a CRS of a first small cell.

Operation 3: Using the detected PSS/SSS/CRS as the coarse time/frequency synchronization reference, the UE detects the DRS of a second small cell on the same frequency as the first small cell according to the DRS subframeConfig.

Operation 4: UE measures and reports the detected DRS of the second small cell if a reporting criterion is satisfied.

If the macro cell and the small cells are asynchronous, there is a need to specify how the macro cell can determine the proper subframe configuration for detecting the DRS of small cells of a UE. There is also a need to specify how the UE should determine the DRS subframe given the DRS subframe configuration by the macro cell.

The disclosure describes methods of coordination between a first and a second eNodeB that are not synchronized to determine a discovery reference signal timing configuration of the first eNodeB that can be signaled by the second eNodeB to a UE configured to detect or measure the discovery reference signal of the first eNodeB.

The disclosure also describes methods for a UE configured to detect or measure the discovery reference signal of the first eNodeB, to determine the discovery reference signal timing upon receiving the discovery reference signal timing configuration by the second eNodeB.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

An Embodiment of this Disclosure Provides an eNodeB Procedure of Determining DRS Subframe Configuration:

The SFN timing offset is defined as the difference between the start time of a SFN cycle of the MeNB and the start time of the nearest SFN cycle of the SeNB where it is assumed that the SFN cycle of SeNB always starts at the same time or later than the SFN cycle of the MeNB.

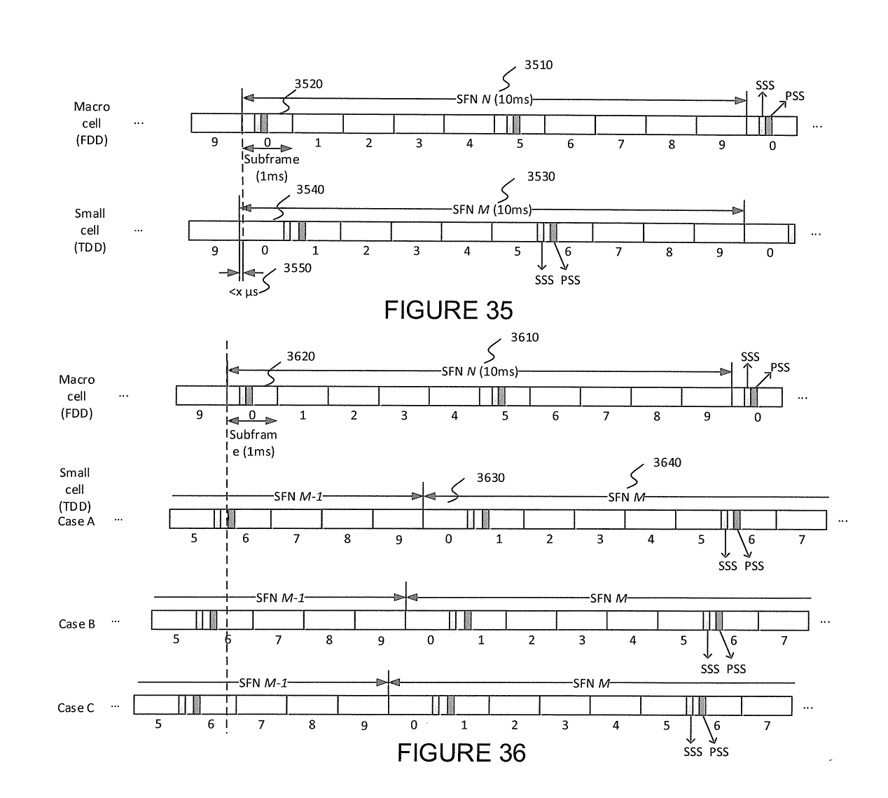

FIG. 37 illustrates an example of SFN timing offset between a MeNB and a SeNB in accordance with an embodiment of this disclosure.

Referring to FIG. 37, the SFN timing offset 3730 of a MeNB and a SeNB is calculated as the start time of a SFN cycle of the SeNB (B) 3720 minus the start time of the nearest earlier SFN cycle of the MeNB (A) 3710, i.e. SFN timing offset=B−A.

A UE can acquire the radio frame and the subframe/slot timing of a cell by detecting the PSS/SSS of each cell. The UE can also acquire the SFN of each cell from decoding the Master Information Block (MIB) of each cell. The UE may perform MIB decoding of a cell when the cell is a serving cell or when the cell is the target cell for handover. From the PSS/SSS and MIB detection, the UE is able to determine time B and A, hence able to determine the SFN timing offset between the MeNB and the SeNB. A UE may be configured to report the observed SFN timing offset to a serving cell. In this way, a serving cell is able to determine the SFN timing offset between itself and another cell. Furthermore, it is also possible for a MeNB and a SeNB to determine the SFN timing offset with respect to each other through an X2 interface procedure.

It is assumed that a first eNodeB (e.g. an SeNB) can select its own time and frequency resources for transmitting DRS. However, it can be the responsibility of a second eNodeB (e.g. an MeNB) to configure the DRS measurement configuration for a UE to measure the DRS of the first eNodeB. There is a need to specify an inter-eNodeB procedure (procedure between the first eNodeB and the second eNodeB) to enable the second eNodeB to determine the DRS measurement configuration for a UE to measure the DRS of the first eNodeB.

In a method of inter-eNodeB procedure, the second eNodeB sends a DRS configuration gap to the first eNodeB. The DRS configuration period is periodically occurring time gap wherein the first eNodeB can choose a time-frequency resource within the time gap to transmit its DRS. A DRS configuration gap can be based on a UE measurement gap pattern as defined in [REF6] or can be based on a new gap pattern for DRS configuration for UE measurement purpose. An alternative of this method is that the second eNodeB can send a request for DRS configuration by the first eNodeB without sending a DRS configuration gap. This is beneficial when UE measurement gap is not necessary or if configuration flexibility for the first eNodeB is desired.

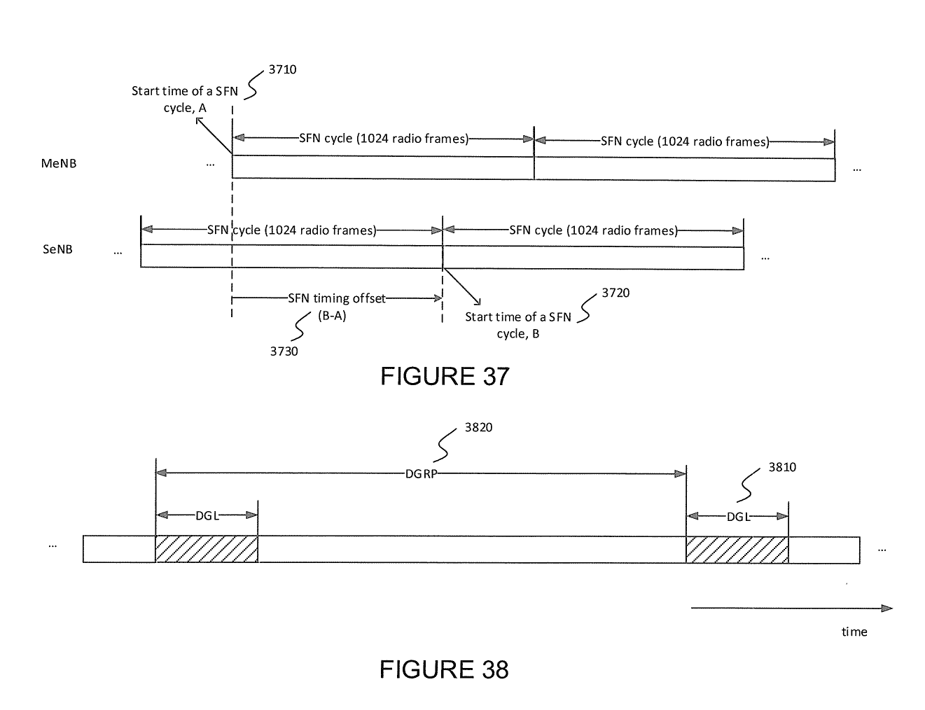

FIG. 38 illustrates an example of DRS configuration gap, defined by a DRS gap length (DGL) 3810 (e.g. 6 ms) and a DRS Gap Repeition Period (DGRP) 3820 (e.g. 40 ms) in accordance with an embodiment of this disclosure. The possible combinations of DGL and DGRP can be predefined where an example is as shown in Table 15.

TABLE 15
DRS gap pattern

| | | DRS Gap |
|---|---|---|
| | DRS Gap | Repetition |
| DRS Gap | Length (DGL, | Period |
| Pattern Id | ms) | (DGRP, ms) |
| 0 | 6 | 40 |
| 1 | 6 | 80 |
| 2 | 6 | 120 |
| 3 | 6 | 160 |

In one example of DRS configuration gap signaling, the second eNodeB can signal a parameter drsGapOffset to the first eNodeB. drsGapOffset indicates the first subframe of each gap occurs at an SFN and subframe meeting the following condition:

SFN mod T=FLOOR(drsGapOffset/10);

subframe=drsgapOffset mod 10;

with T=DGRP/10. The SFN reference for determining the gap can be the SFN of the second eNodeB and the first eNodeB shall determine the set of resources that can be used for DRS transmission from drsGapOffset as well as the SFN timing offset between the first eNodeB and the second eNodeB, assumed known at least at the first eNodeB. If the DRS configuration gap also corresponds to a measurement gap of the UE, time for the UE to prepare the RF front end to perform DRS measurement needs to be taken into account when the first eNodeB determines its DRS resource. Additional guard period may also be needed to account for potential inaccuracy of SFN timing offset information at the eNodeBs. Therefore the choice of DRS configuration can be a subset of the DRS configuration gap indicated by the second eNodeB, which shall be referred to as the effective DRS configuration gap. For example, the guard period can be e.g. 0.5 ms at each end of the DRS configuration gap, resulting in a total guard period of 1 ms and an effective DRS configuration gap of 5 ms.

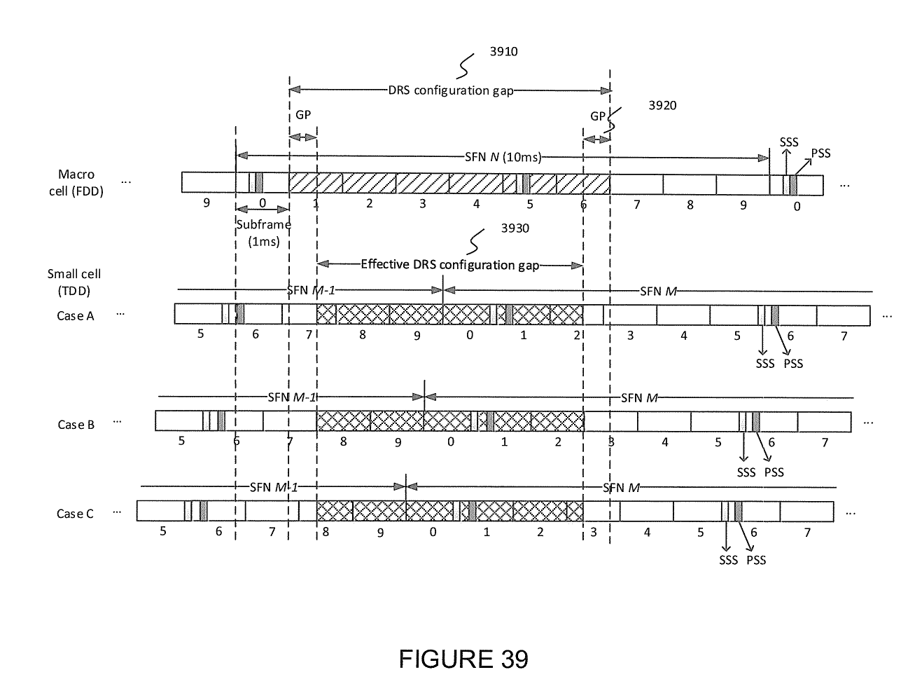

FIG. 39 illustrates determination of the effective DRS configuration gap 3930 for a small cell (which is the first eNodeB) based on the DRS gap configuration 3910 as signaled by a macro cell (which is the second eNodeB) in accordance with an embodiment of this disclosure. The effective DRS configuration gap excludes guard periods 3920. Case A, Case B and Case C illustrates different examples of a small cell timing. They can also be used to illustrate the timings of different small cells clusters under the coverage of the macro cell, which are not synchronized.

After the first eNodeB determines a configuration for its DRS transmission, it then signals the corresponding DRS configuration to the second eNodeB, e.g. as a DRS subframeConfig. For example, if the DRS is a NZP CSI-RS the DRS subframe configuration signaled by the first eNodeB indicates T_{CSI-RS} and Δ_{CSI-RS}, the subframes containing NZP CSI-RS as DRS shall satisfy (10n_{f}+└nₛ/2┘−Δ_{CSI-RS})mod T_{CSI-RS}=0, where n_{f} is the System Frame Number of the second eNodeB and nₛ is the slot number within a radio frame (range from 0 to 19) of the second eNodeB. After receiving the DRS configuration signaling from the first eNodeB, the second eNodeB can signal the same DRS subframeConfig to a UE. The UE can then determine the subframes containing DRS according to methods described in Embodiment 2.

The DRS subframe configuration as determined by the first eNodeB according to the method above may be random within the effective DRS configuration gap. If there are many cells transmitting DRS on a frequency, the DRS configurations of different cells would be spread over the effective DRS configuration gap. Aggregating the DRS configurations of different cells in the same subframe has the benefit of allowing more cells to be discovered or measured by a UE within a shorter time period. It also allows the UE to measure on more frequencies within the same DRS gap. In order to achieve this, in addition to the DRS gap configuration, the second eNodeB can also signal a recommended subframe(s), or more generally, a set of time-frequency resources, that the first eNodeB can use for determining its initial DRS configuration or reconfiguring its DRS configuration. The method of signaling a recommended subframe(s) by the second eNodeB and determination of the recommended DRS subframe by the first eNodeB according to the signaling can be similar to the method of inter-eNodeB coordination, which is described next.

In another method of inter-eNodeB coordination procedure, the second eNodeB sends a specific DRS subframe configuration to the first eNodeB. The DRS subframe configuration shall indicate the specific subframe or specific set of subframes that the first eNodeB shall use for DRS transmission. The second eNodeB sends a DRS subframe configuration with reference to its own timing to neighboring eNodeBs which include the first eNodeB. The DRS subframe configuration can be common for all neighboring cells/eNodeBs or different depending on the specific neighboring cell/eNodeB. The first eNodeB shall then determine the subframe to transmit DRS based on the second eNodeB's DRS subframe configuration as well as its knowledge of SFN timing offset with respect to the second eNodeB. The subframe on the second eNodeB that corresponds to the DRS subframe configuration is referred to as the reference DRS subframe. In one instance, the DRS subframe can be the subframe with the maximum overlapping portion in time with the reference DRS subframe. Other criterion is also possible.

In an example of the method, we assume that the SFN timing offset is measured in a unit of Ts or an integer multiple of Ts (e.g. 2) where a Ts is the basic time unit of the LTE system (sampling period) defined as 1/(15000×2048) seconds [REF1]. An example rule for determining the DRS subframe at the first eNodeB can be:

```
  Operation 1: Set α = SFN timing offset [seconds] mod 1miliseconds ;
  Operation 2: if α <0.5ms,
• start of DRS subframe = start of reference DRS
        subframe + α;
• else
• start of DRS subframe = start of reference DRS
        subframe − (1ms − α);
• end
```

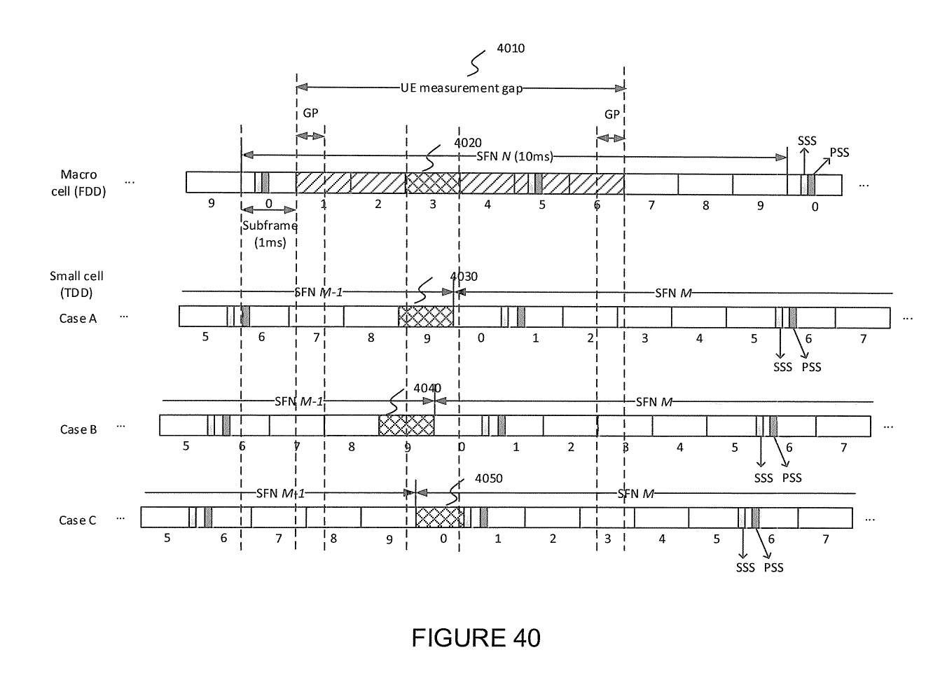

FIG. 40 illustrates an example how the DRS subframe of a small cell (the first eNodeB in this example) is determined based on the DRS subframe configuration of a macro cell (the second eNodeB in this example) and the SFN timing offset in accordance with an embodiment of this disclosure.

Referring to FIG. 40, the condition of α<0.5 ms is satisfied for Case C and the DRS subframe is determined accordingly as 4050. On the other hand, the condition of α≧0.5 ms is satisfied for Case A and Case B, and the DRS subframe is determined accordingly as 4030 and 4040, respectively. A different threshold for α is also possible.

In another example of the method, the DRS subframe configuration signaled by the second eNodeB indicates the absolute start and end time of time-frequency resources wherein the DRS resource that can be configured by the first eNodeB.

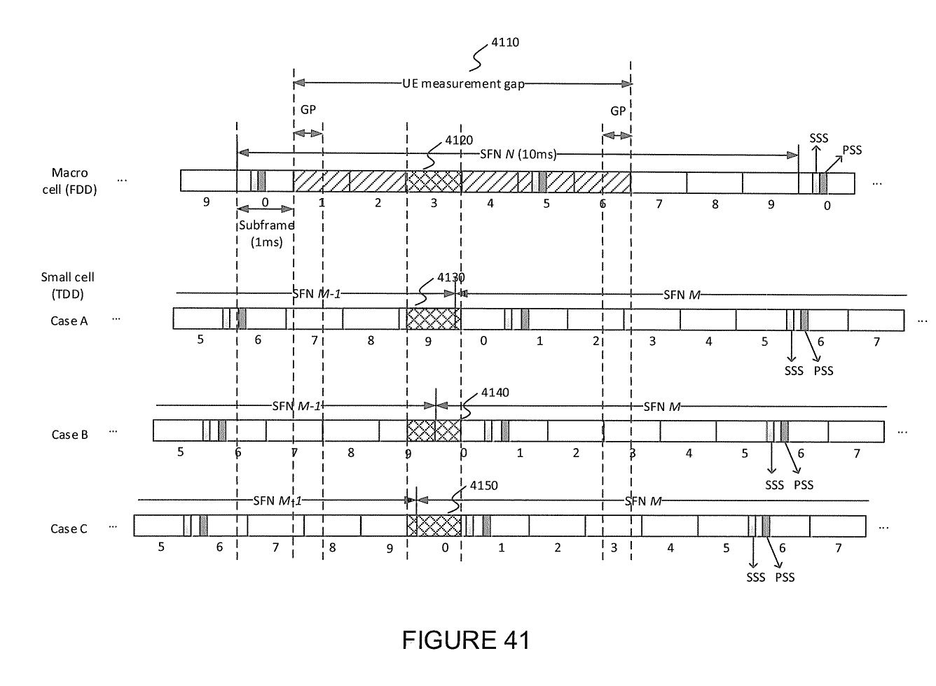

FIG. 41 illustrates another example of how the absolute start and end time of time-frequency resources of the first eNodeB (small cell) is determined based on the DRS subframe configuration of the second eNodeB (macro cell) and the SFN timing offset in accordance with an embodiment of this disclosure.

Referring to FIG. 41, the DRS subframe configuration of the second eNodeB 4120 indicates the absolute start and end time of time-frequency resources available for the first eNodeB to transmit DRS, which may span over resources of two subframes as indicated by 4130, 4140 and 4150. For example, if DRS is the NZP-CSI-RS, in Case B where α=0.5 ms, DRS can be transmitted by the first eNodeB in subframe 9 if the DRS is transmitted in resource 311 of FIG. 3B, or in subframe 0 if the DRS is transmitted by the first eNodeB in resources 312 or 313 of FIG. 3B.

PSS and SSS are shown in FIGS. 39, 40, and 41, however they may not be transmitted by the cell or expected by the UE, e.g. when the cell is in a dormant mode where only the discovery reference signals are transmitted.

It is noted that the methods described above can also be used by the second eNodeB (macro cell) to interpret the DRS resource configured by the first eNodeB (small cell).

It is also noted that although the inter-eNodeB coordination methods are described for a macro cell and a small cell, the methods are also applicable between two cells of any type combinations, e.g. between two macro cells, or between two small cells.

An Embodiment of this Disclosure Provides a UE Procedure of Determining DRS Subframe Configuration:

A first cell transmitting DRS may not be synchronized with a second cell which is a serving cell of a UE. To facilitate detection and measurement of the DRS of the first cell, the UE is signaled by the second cell network assistance information, which includes the DRS measurement timing configuration. The DRS measurement timing configuration is assumed signaled by the second cell in the form of DRS subframe configuration. There is a need to specify how the UE should determine the DRS measurement subframe(s) of the first cell given the DRS subframe configuration by the second cell. The subframe(s) corresponding to the DRS subframe configuration in the second cell is referred to as the reference DRS subframe(s). If the DRS is a NZP CSI-RS and the DRS subframe configuration signaled by the second cell indicates T_{CSI-RS} and Δ_{CSI-RS}, the reference DRS subframe(s) can be determined as subframes satisfying (10n_{f}+└nₛ/2 ┘−Δ_{CSI-RS})mod T_{CSI-RS}=0, where n_{f} is the System Frame Number of the second cell and nₛ is the slot number within a radio frame (range from 0 to 19) of the second cell.

In addition, it is assumed that a UE can detect the PSS/SSS/CRS of at least one of the cells on the same frequency or at least one of the cells belonging to a group of cells on the same frequency as that of the first cell to determine an approximate radio frame and subframe timing of the first cell. It is assumed here that cells transmitting DRS on the same frequency are aligned coarsely in time or frequency.

In a method, the DRS subframe(s) on the first cell assumed by the UE for detection and measurement can be the subframe with the maximum overlapping portion in time with the reference DRS subframe(s) on the second cell. Other criterion is also possible. An example of UE procedure to determine the DRS subframes on the first cell is described below, where it is assumed the second cell is a serving cell of the UE.

Operation 1: A UE is configured with a DRS measurement timing configuration for a frequency by the second cell in the form of DRS subframe configuration. The reference DRS subframe(s) can be determined by the UE.

Operation 2: The UE detects PSS/SSS/CRS of a cell on the same frequency as that of the first cell to determine an approximate radio frame and subframe timing of the first cell.

Operation 3: Set t1 (in seconds) to be the start of a subframe of the second cell and t2 (in seconds) to be the start of the nearest subframe of the first cell after t1.

```
  Operation 4: Set α = (t2 − t1) mod 1milisecond;
  Operation 5: if α <0.5ms,
• start of DRS subframe of the first cell = start of reference
        DRS subframe + α;
• else
• start of DRS subframe of the first cell = start of reference
  DRS subframe − (1ms − α);
• end
```

It is noted that the above procedure does not require the UE to know the SFN of the first cell. This is beneficial as the UE doesn not need to read the MIB of a cell, which saves UE processing and reduces UE complexity, in order to determine the DRS subframe(s) of the cell.

FIG. 40 also illustrates how the DRS subframe of a small cell (the first cell in this example) is determined based on the DRS subframe configuration of a macro cell (the second cell in this example) in accordance with an embodiment of this disclosure.

In another method, the DRS subframe configuration signaled by the second cell indicates the absolute start and end time of time-frequency resources wherein the DRS resource should be detected or measured by the UE. Case A, Case B and Case C may correspond to timings of different small cells clusters which are not synchronized. This method has the advantage of minimizing the DRS detection or measurement period on a frequency, regardless of the timings of the clusters. An example of UE procedure to determine the DRS subframes on the first cell is described below.

Operation 1: A UE is configured with a DRS measurement timing configuration for a frequency by the second cell in the form of DRS subframe configuration. The reference DRS subframe(s) can be determined by the UE.

Operation 2: The UE detects PSS/SSS/CRS of a cell on the same frequency as that of the first cell to determine an approximate radio frame and subframe timing of the first cell.

Operation 3: Set t1 (in seconds) to be the start of the reference DRS subframe of the second cell.

Operation 4: The UE detects and measures DRS on the first cell from t1 to t1+duration of DRS subframe (e.g. 1 ms)

FIG. 41 also illustrates how the absolute start and end time of DRS detection and measurement of the first cell (small cell) is determined based on the DRS subframe configuration of the second cell (macro cell) in accordance with an embodiment of this disclosure. If DRS is the NZP-CSI-RS, in Case B where α=0.5 ms, the UE detects and measures the DRS of the first cell in subframe 9 for the DRS transmitted using resource 311 or others in the same set of OFDM symbols in FIG. 3B, or in subframe 0 for DRS in resources 312 or 313 or others in the same set of OFDM symbols in FIG. 3B.

In another method, potential or candidate DRS subframe(s) on the first cell from the UE's perspective are any subframes that overlap with the reference DRS subframe of the second cell. This method has the advantage of being more robust to potential inaccuracy of SFN timing offset information at the eNodeBs. The UE shall first detect the presence of DRS in a candidate DRS subframe before performing measurement. As an alternative, the first eNodeB may also transmit DRS in more than one subframes belonging to the candidate DRS subframes determined by the UE, where there is an advantage of enhancing DRS measurement accuracy by the UE.

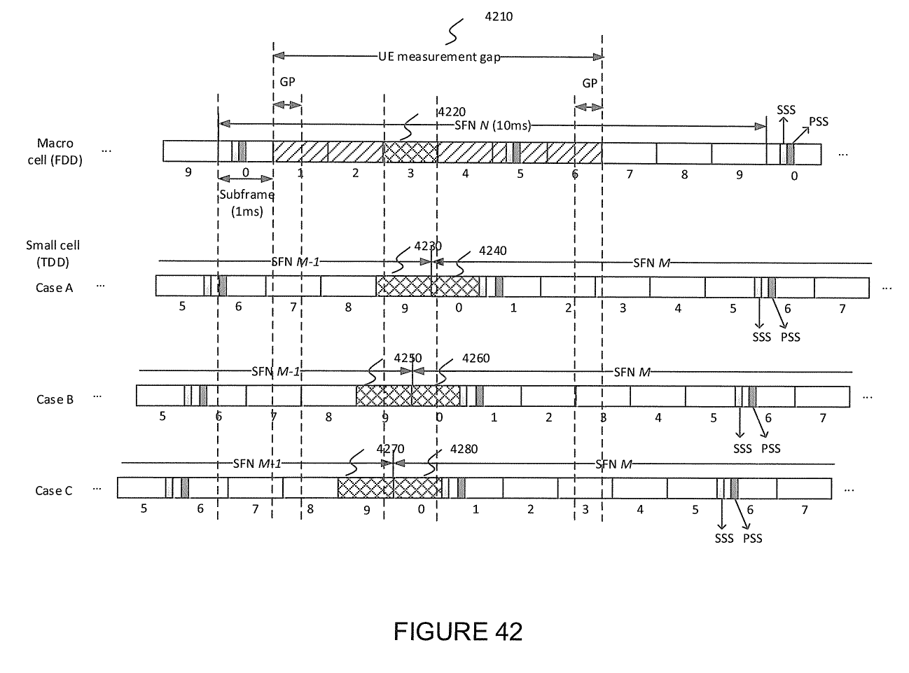

FIG. 42 illustrates a DRS measurement timing determination in accordance with an embodiment of this disclosure. Subframes 4230, 4240, 4250, 4260, 4270, 4280 are considered subframes for DRS detection and measurement the UE since they overlap with the reference DRS subframe 4220.

A variation of this method is to define a condition or conditions where a subframe can be included in DRS detection and measurement. For example, a subframe is included if the overlapping region in time is more than x ms, where an example of x can be 31.3 μs. Other values are possible.

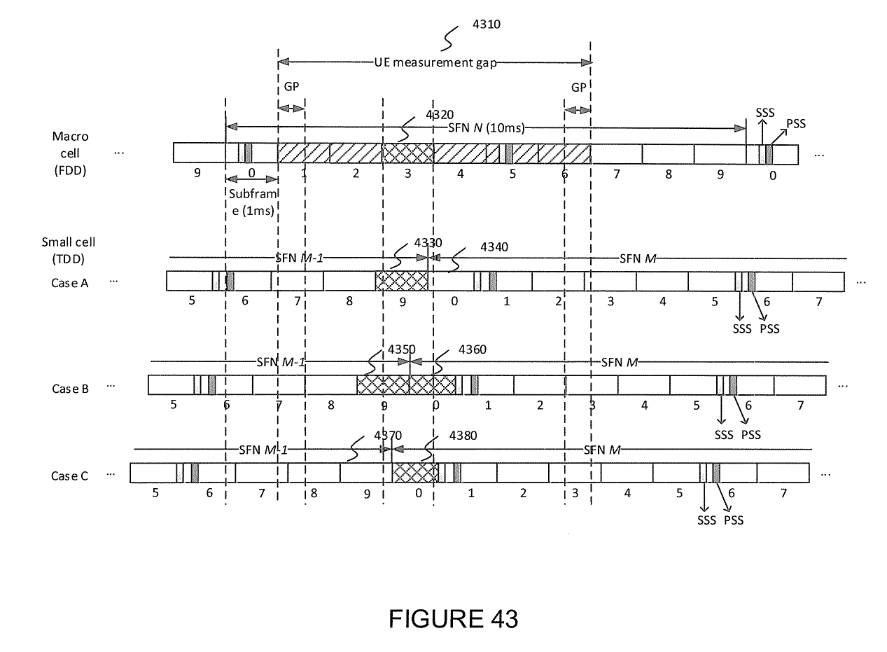

FIG. 43 illustrates another method for DRS measurement timing determination in accordance with an embodiment of this disclosure. In this embodiment, subframes 4330, 4350, 4360, 4380 are considered subframes for DRS detection and measurement as they meet the criterion of inclusion, whereas subframes 4340 and 4370 are excluded from DRS detection and measurement since they do not meet the criterion of inclusion.

PSS and SSS are shown in FIGS. 42 and 43, however they may not be transmitted by the cell or expected by the UE, e.g. when the cell is in a dormant mode where only the discovery reference signals are transmitted.

In another method, the DRS measurement timing configuration signaled by the second cell (the serving cell) in the form of DRS subframe configuration assumes the first cell's (cell transmitting DRS) SFN and subframe timing as the reference. For example, if the DRS is a NZP CSI-RS, the DRS subframe configuration signaled by the second cell indicates T_{CSI-RS} and Δ_{CSI-RS}, the DRS subframe(s) of the first cell can be determined directly as subframes satisfying (10n_{f}+└nₛ/2 ┘−Δ_{CSI-RS})mod T_{CSI-RS}=0, where n_{f} is the System Frame Number of the first cell and nₛ is the slot number within a radio frame (range from 0 to 19) of the first cell. This method uses the UE to know both the SFN and the subframe timing of the cells measured for DRS. Thus, upon configuration of DRS measurement, the UE is used to detect the PSS/SSS/CRS and read the MIB of a cell on the frequency concerned in order to acquire a SFN and a subframe timing. The UE then assumes this SFN and subframe timing in detecting and measuring the DRS of other cells on the same frequency. This assumption is beneficial for avoiding excessive MIB reading by the UE. An example of UE procedure to determine the DRS subframes on the first cell is described below.

Operation 1: A UE is configured with a DRS measurement timing configuration for a frequency by the second cell in the form of DRS subframe configuration.

Operation 2: The UE detects PSS/SSS/CRS of a cell on the same frequency as that of the first cell to determine an approximate radio frame and subframe timing of the first cell.

Operation 3: The UE detects and decodes the MIB of the cell detected to determine the SFN of the first cell.

Operation 4: The UE determines the DRS subframe(s) using the detected SFN and subframe timing.

It is also possible to configure between a method that does not require SFN acquisition by the UE, such as the methods above, and a method that uses SFN acquisition by the UE, such as another method above.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A user equipment for wireless communication over a wireless network with at least one base station comprising:
a transceiver operable to communicate with the at least one base station by transmitting radio frequency signals to the at least one base station and by receiving radio frequency signals from the at least one base station, the transceiver configured to:
receive a discovery signal from a base station of the at least one base station, the discovery signal comprising a discovery signal identifier; and
receive a synchronization signal or reference signal, the synchronization signal or the reference signal comprising a physical cell identifier; and
a processing circuitry configured to:
determine whether the discovery cell identifier matches the physical cell identifier; and
responsive to the discovery cell identifier matching the physical cell identifier, identify that the base station is active or in coverage.

2. The user equipment as set forth in claim 1, further comprising:
responsive to the discovery cell identifier not matching the physical cell identifier, identify that the base station is dormant or out of coverage.

3. The user equipment as set forth in claim 1, wherein the discovery signal comprises a low duty cycle reference signal.

4. The user equipment as set forth in claim 3, further comprising:
responsive to detecting the low duty cycle reference signal and the reference signal, identify that the base station is active and in coverage.

5. The user equipment as set forth in claim 3, further comprising:
responsive to detecting the low duty cycle reference signal and the reference signal, measure the reference signal received power using the low duty cycle reference signal.

6. A user equipment for wireless communication over a wireless network with at least one base station comprising:
a transceiver operable to communicate with the at least one base station by transmitting radio frequency signals to the at least one base station and by receiving radio frequency signals from the at least one base station, the transceiver configured to:
receive an indication of whether a base station is active or dormant via a physical downlink control channel (PDCCH) of a radio network temporary identifier (RNTI); and
a processing circuitry configured to:
monitor the PDCCH for the RNTI.

7. The user equipment as set forth in claim 6, wherein the RNTI is different from a cell RNTI for the base station.

8. The user equipment as set forth in claim 6, wherein a plurality of other user equipment monitor the RNTI.

9. The user equipment as set forth in claim 6, wherein the RNTI is configurable by the wireless network.

10. A base station for wireless communication over a wireless network, comprising:
a transceiver operable to communicate with the at least one user equipment by transmitting radio frequency signals to the at least one user equipment and by receiving radio frequency signals from the at least one user equipment, the transceiver configured to:
transmit a discovery signal to the at least one user equipment, the discovery signal comprising a discovery signal identifier; and
transmit a synchronization signal or reference signal, the synchronization signal or the reference signal comprising a physical cell identifier,
wherein, whether the discovery cell identifier matches the physical cell identifier identifies whether the base station is active or in coverage.

11. The base station as set forth in claim 10, wherein, when the discovery cell identifier does not match the physical cell identifier, the base station is dormant or out of coverage.

12. The base station as set forth in claim 10, wherein the discovery signal comprises a low duty cycle reference signal.

13. The base station as set forth in claim 12, wherein, when detecting the low duty cycle reference signal and the reference signal, the base station is active and in coverage.

14. The base station as set forth in claim 12, wherein, when detecting the low duty cycle reference signal and the reference signal, the reference signal received power using the low duty cycle reference signal.

15. A base station for communicating over a wireless network, comprising:
a transceiver operable to communicate with the at least one user equipment by transmitting radio frequency signals to the at least one user equipment and by receiving radio frequency signals from the at least one user equipment, the transceiver configured to:
transmit a physical downlink control channel (PDCCH) for a radio network temporary identifier (RNTI) indicating whether the base station is active or dormant.

16. The base station as set forth in claim 15, wherein the RNTI is different from a cell RNTI for the base station.

17. The base station as set forth in claim 15, wherein the at least one user equipment monitors the RNTI.

18. The base station as set forth in claim 15, wherein the RNTI is configurable by the wireless network.
